(19) United States
(12) Patent Application Publication
(10) Pub. No.: US 2012/0158589 A1
(43) Pub. Date: Jun. 21, 2012

(54) Social Media Payment Platform Apparatuses, Methods and Systems

(76) Inventors: Edward Katzin, San Francisco, CA (US); Julian Hua, San Francisco, CA (US)

(21) Appl. No.: 13/327,740

(22) Filed: Dec. 15, 2011

Related U.S. Application Data
(60) Provisional application No. 61/423,588, filed on Dec. 15, 2010.
(60) Provisional application No. 61/431,818, filed on Jan. 11, 2011.
(60) Provisional application No. 61/432,031, filed on Jan. 12, 2011.
(60) Provisional application No. 61/432,583, filed on Jan. 13, 2011.
(60) Provisional application No. 61/466,927, filed on Mar. 23, 2011.
(60) Provisional application No. 61/467,302, filed on Mar. 24, 2011.

(51) Int. Cl. G06Q 20/40; G06Q 20/36; G06Q 20/08

(52) U.S. Cl. 705/44

(57) ABSTRACT

The SOCIAL MEDIA PAYMENT PLATFORM APPARATUSES, METHODS AND SYSTEMS (“SocialPay”) transform message posts to social networks via SocialPay components into payment transaction receipts social merchant-consumer bridging offers. In one implementation, the SocialPay obtains a user social pay initiation trigger, and obtains user social data from a social networking site. The SocialPay identifies a social pay command within the user social data. In one implementation, the SocialPay, in identifying the social pay command within the user social data, parses the user social data, and extracts a social pay command string within the user social data. The SocialPay determines a payor identifier, a payee identifier, and a payment amount using the social pay command string. Based on the identified social pay command, the SocialPay initiates a funds payment transaction.

### PRIORITY CLAIM

This application claims priority under 35 U.S.C. §119 to: U.S. provisional patent application Ser. No. 61/423,588 filed Dec. 15, 2010, entitled “APPARATUSES, METHODS AND SYSTEMS FOR SECURE OFFERS, COMMERCE AND SERVICES ON SOCIAL NETWORKS,” attorney docket no. P-41928PRV|20270-087PV1, U.S. provisional patent application Ser. No. 61/431,818 filed Jan. 11, 2011, entitled “APPARATUSES, METHODS AND SYSTEMS FOR A SOCIAL MEDIA PAYMENT PLATFORM,” attorney docket no. P-41929PRV|20270-087PV2, U.S. provisional patent application Ser. No. 61/432,031 filed Jan. 12, 2011, entitled “APPARATUSES, METHODS AND SYSTEMS FOR A SOCIAL MEDIA PAYMENT PLATFORM,” attorney docket no. P-41930PRV|20270-087PV3, U.S. provisional patent application Ser. No. 61/432,583 filed Jan. 13, 2011, entitled “APPARATUSES, METHODS AND SYSTEMS FOR A SOCIAL MEDIA PAYMENT PLATFORM,” attorney docket no. P-41979PRV|20270-087PV4; U.S. provisional patent application Ser. No. 61/466,927 filed Mar. 23, 2011, entitled “APPARATUSES, METHODS AND SYSTEMS FOR A SOCIAL MEDIA PAYMENT PLATFORM,” attorney docket no. P-42156PRV|20270-087PV5; and U.S. provisional patent application Ser. No. 61/467,302 filed Mar. 24, 2011, entitled “APPARATUSES, METHODS AND SYSTEMS FOR A SOCIAL MEDIA PAYMENT PLATFORM,” attorney docket no. P-42161PRV|20270-087PV6. The entire contents of the aforementioned applications are expressly incorporated by reference herein.

This patent for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address apparatuses, methods, and systems for e-commerce, and more particularly, include SOCIAL MEDIA PAYMENT PLATFORM APPARATUSES, METHODS AND SYSTEMS (“SocialPay”).

### BACKGROUND

Consumer transactions typically require a customer to select a product from a store shelf or website, and then to check out at a checkout counter or webpage. Product information is typically selected from a webpage catalog or entered into a point-of-sale terminal device, or the information is automatically entered by scanning an item barcode with an integrated barcode scanner, and the customer is usually provided with a number of payment options, such as cash, check, credit card or debit card. Once payment is made and approved, the point-of-sale terminal memorializes the transaction in the merchant's computer system, and a receipt is generated indicating the satisfactory consummation of the transaction.

### BRIEF DESCRIPTION OF THE DRAWINGS

The accompanying appendices and/or drawings illustrate various non-limiting, example, inventive aspects in accordance with the present disclosure:

FIGS. 1A-B show block diagrams illustrating example aspects of payment transactions via social networks in some embodiments of the SocialPay;

FIG. 2 shows a data flow diagram illustrating an example social pay enrollment procedure in some embodiments of the SocialPay;

FIG. 3 shows a logic flow diagram illustrating example aspects of social pay enrollment in some embodiments of the SocialPay, e.g., a Social Pay Enrollment (“SPE”) component 300;

FIGS. 4A-C show data flow diagrams illustrating an example social payment triggering procedure in some embodiments of the SocialPay;

FIGS. 5A-C show logic flow diagrams illustrating example aspects of social payment triggering in some embodiments of the SocialPay, e.g., a Social Payment Triggering (“SPT”) component 500;

FIGS. 6A-B show logic flow diagrams illustrating example aspects of implementing wallet security and settings in some embodiments of the SocialPay, e.g., a Something (“WSS”) component 600;

FIG. 7 shows a data flow diagram illustrating an example social merchant consumer bridging procedure in some embodiments of the SocialPay;

FIG. 8 shows a logic flow diagram illustrating example aspects of social merchant consumer bridging in some embodiments of the SocialPay, e.g., a Social Merchant Consumer Bridging (“SMCB”) component 800;

FIG. 9 shows a logic flow diagram illustrating example aspects of transaction data aggregation in some embodiments of the SocialPay, e.g., a Transaction Data Aggregation (“TDA”) component goo;

FIG. 10 shows a logic flow diagram illustrating example aspects of transaction-based offer generation in some embodiments of the SocialPay, e.g., a Transaction-Based Offer Generation (“TBOG”) component woo;

FIG. 11 shows a data flow diagram illustrating an example user purchase checkout procedure in some embodiments of the SocialPay;

FIG. 12 shows a logic flow diagram illustrating example aspects of a user purchase checkout in some embodiments of the SocialPay, e.g., a User Purchase Checkout (“UPC”) component 1200;

FIGS. 13A-B show data flow diagrams illustrating an example purchase transaction authorization procedure in some embodiments of the SocialPay;

FIGS. 14A-B show logic flow diagrams illustrating example aspects of purchase transaction authorization in some embodiments of the SocialPay, e.g., a Purchase Transaction Authorization (“PTA”) component 1400;

FIGS. 15A-B show data flow diagrams illustrating an example purchase transaction clearance procedure in some embodiments of the SocialPay;

FIGS. 16A-B show logic flow diagrams illustrating example aspects of purchase transaction clearance in some embodiments of the SocialPay, e.g., a Purchase Transaction Clearance (“PTC”) component 1600;

FIG. 17 shows a user interface diagram illustrating an overview of example features of virtual wallet applications in some embodiments of the SocialPay;

FIGS. 18A-G show user interface diagrams illustrating example features of virtual wallet applications in a shopping mode, in some embodiments of the SocialPay;

FIGS. 19A-F show user interface diagrams illustrating example features of virtual wallet applications in a payment mode, in some embodiments of the SocialPay;

FIG. 20 shows a user interface diagram illustrating example features of virtual wallet applications, in a history mode, in some embodiments of the SocialPay;

FIGS. 21A-E show user interface diagrams illustrating example features of virtual wallet applications in a snap mode, in some embodiments of the SocialPay;

FIG. 22 shows a user interface diagram illustrating example features of virtual wallet applications, in an offers mode, in some embodiments of the SocialPay;

FIGS. 23A-B show user interface diagrams illustrating example features of virtual wallet applications, in a security and privacy mode, in some embodiments of the SocialPay; and

FIG. 24 shows a block diagram illustrating embodiments of a SocialPay controller.

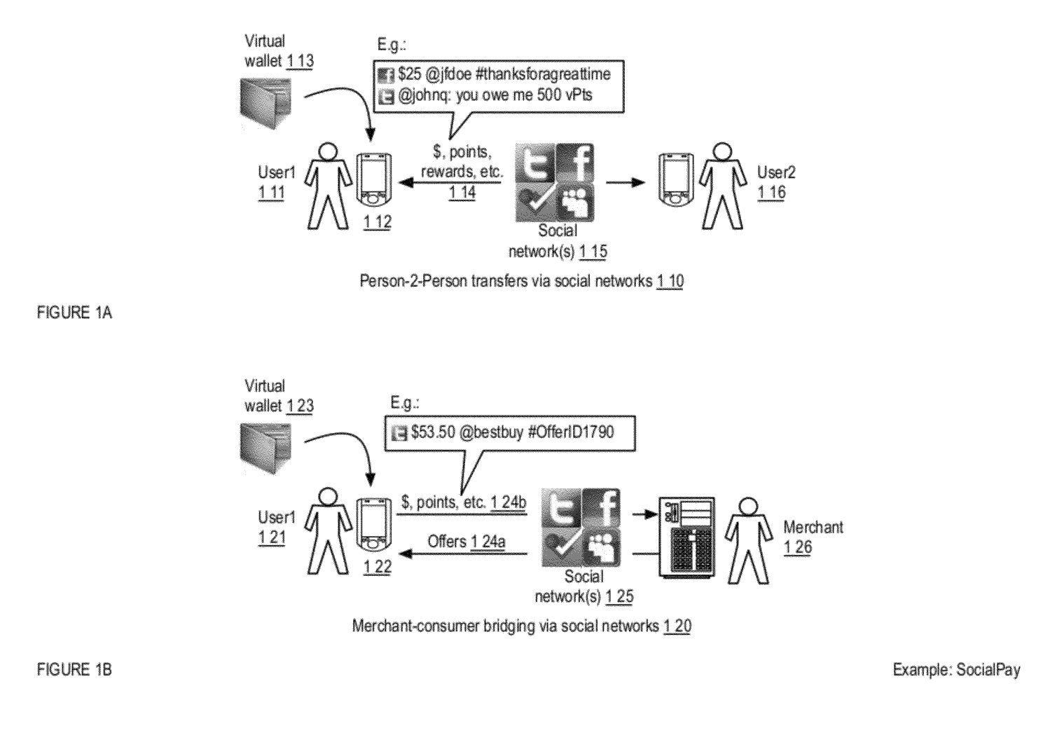

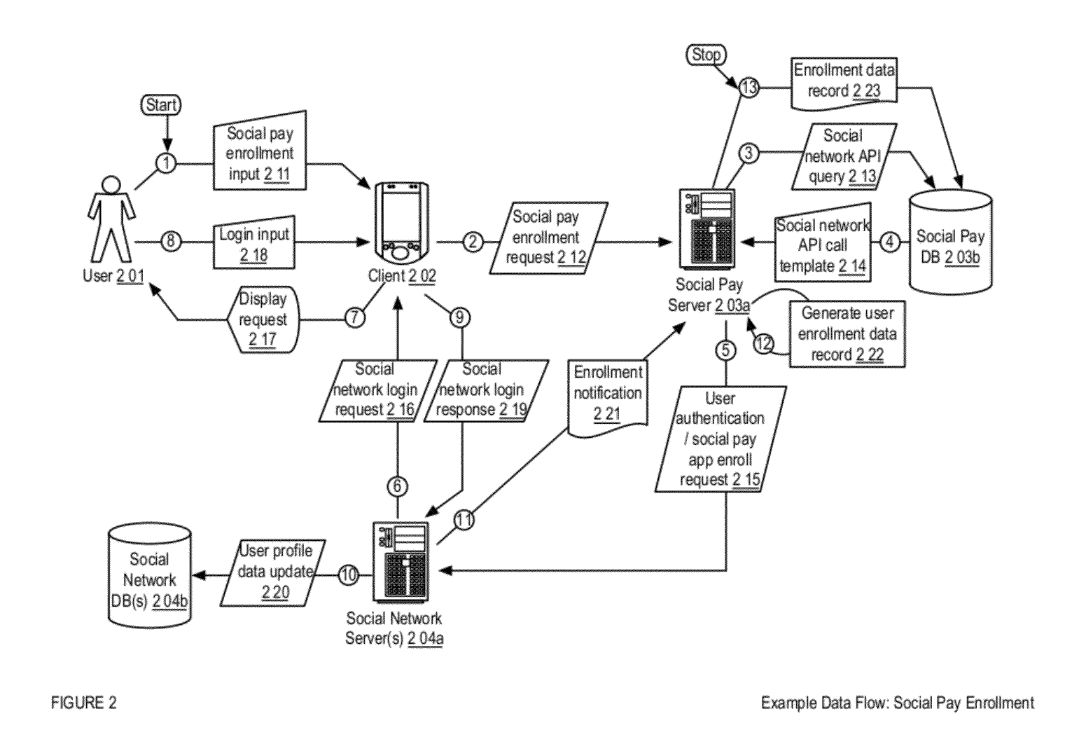

The leading number of each reference number within the drawings indicates the FIGURE in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Social Media Payment Platform (SocialPay)

The SOCIAL MEDIA PAYMENT PLATFORM APPARATUSES, METHODS AND SYSTEMS (hereinafter “SocialPay”) transform message posts to social networks, via SocialPay components, into payment transaction receipts social merchant-consumer bridging offers. FIGS. 1A-B show block diagrams illustrating example aspects of payment transactions via social networks in some embodiments of the SocialPay. In some embodiments, the SocialPay may facilitate per-2-person transfers 110 of money via social networks. For example, a user (user1 111) may wish to provide funds (dollars, rewards, points, miles, etc. 114) to another user (user2 116). The user may utilize a virtual wallet to provide a source of funds. In some embodiments, the user may utilize a device 112 (such as a smartphone, mobile device, laptop computer, desktop computer, and/or the like) to send a social post message via the social network 115. In some embodiments, the social post message may include information on an amount of funds to be transferred and an identity of another user to whom the funds should be transferred. The SocialPay may intercept the message before it is sent to the social networking service, or it may obtain the message from the social networking service. Using the social post message, the SocialPay may resolve the identities of a payor and payee in the transaction. The SocialPay may identify accounts of the payor and payee to/from which funds need be credited or debited, and an amount of credit/debit to apply to each of the accounts. The SocialPay may, on the basis of resolving this information, execute a transaction to transfer funds from the payor to the payee. For example, the SocialPay may allow a payor, by sending a tweet on Twitter™ such as “$25@jfdoe #ackpls” to transfer funds to a payee (user ID jfdoe), and request an acknowledgement from SocialPay of receipt of funds. In another example, the SocialPay may allow a potential payee to request funds from another user by sending a tweet on Twitter™ such as “@johnq, you owe me 50000 Visa rewards points #id1234”; the SocialPay may automatically provide an alert within a virtual wallet application of the user with user ID johnq to provide the funds to the potential payee user. The user johnq may respond by sending a tweet in response, referencing the id (#id1234), such as “50000 vpts @jfdoe #id1234”; the SocialPay may transfer the funds and recognize transaction request #id1234 as being fulfilled. In some embodiments, the SocialPay may generate transaction/request ID numbers for the users to prevent coinciding transaction/request ID numbers for different transaction/requests.

In some embodiments, the SocialPay may utilize one or more social networking services (e.g., Facebook®, Twitter™, MySpace™, etc.). In some embodiments, the SocialPay may allow users across different social networks to transact with each other. For example, a user may make a request for payment on one social network. As an example, a Twitter™ user may tweet “@johnq@facebook.com, you owe me 500 vpts #ID7890”). The SocialPay may provide an alert to the user with ID johnq@facebook.com either via the other social networking or via the user's virtual wallet. In response, the payee may social post to Facebook® a message “@jfdoe: here's your 500 vpts #ID7890”, and the SocialPay may facilitate the payment transaction and provide a receipt/acknowledgment to the two users on their respective social networks or virtual wallets.

In some embodiments, the SocialPay may facilitate transfers of funds to more than one payee by a payor via a single social post message. In some embodiments, the SocialPay may facilitate use of more than one source of funds of a payee to fund payment of funds to one or more payors via a single post message. For example, the SocialPay may utilize default settings or customized rules, stored within a virtual wallet of a payor, to determine which funding sources to utilize to fund a payment transaction to one or more payees via a social post message.

In some implementations, the SocialPay may facilitate merchants to make offers of products and/or services to consumers via social networks 120. For example, a merchant 126 may sign up to participate in the SocialPay. The SocialPay may aggregate transactions of a user, and determine any products or services that may relevant for offering to the user. The SocialPay may determine whether any participating merchants are available to provide the products or services for the users. If so, the SocialPay may provide social post messages via a social network 125 on behalf of the merchants (or, alternatively, inform the merchants who may then send social post messages to the users) providing the offers 124a to the user 121. An example of an offer to the followers of a merchant on may be “@amazon offers the new Kindle™ at only $149.99—click here to buy.” In such an example, the offer posted on the social networking site may have a link embedded (e.g., “here”) that users can click to make the purchase (which may be automatically performed with one-click if they are currently logged into their virtual wallet accounts 123). Another example of a merchant offer may be “@amazon offers the 22 new Kindle™ at only $149.99—reply with #offerID123456 to buy.” In such an example, the hash tag value serves as an identifier of the offer, which the users can reference when making their purchase via their social post messages (e.g., “buy from @amazon #offerID123456”). In some embodiments, merchants may provide two or more offers via a single social post message. In some embodiments, users may reference two or more offers in the same social post message.

In some implementations, users and/or merchants may utilize alternate messaging modes. For example, a user may be able to utilize electronic mail, SMS messages, phone calls, etc., to communicate with the SocialPay and the social networks.

For example, a merchant may provide a social post message offer such as ““@amazon offers the new Kindle™ at only $149.99—text #offerID123456 to buy”. When a user utilize a mobile phone to send a text message to redeem the offer, the SocialPay may utilize a user profile of the user store on the social networking service to identify an identifying attribute of the user's mobile phone (e.g., a phone number), using which the SocialPay may correlate the text message to a particular user. Thus, the SocialPay may be able to process a transaction with the merchant on behalf of the user, using user information from the user's virtual wallet. In some embodiments where a social network is incapable of handling a particular mode of communication, the SocialPay may serve as an intermediary translator to convert the message to a form that can be utilized by the social network.

FIG. 2 shows a data flow diagram illustrating an example social pay enrollment procedure in some embodiments of the SocialPay. In some embodiments, a user, e.g., 201, may desire to enroll in SocialPay. The user may communicate with a SocialPay server, e.g., 203a, via a client such as, but not limited to: a personal computer, mobile device, television, point-of-sale terminal, kiosk, ATM, and/or the like (e.g., 202). For example, the user may provide user input, e.g., social pay enrollment input 211, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like.

In some implementations, using the user's input, the client may generate a social pay enrollment request, e.g., 212, and provide the enrollment request to the SocialPay server 203a. For example, the client may provide a (Secure) Hypertext Transfer Protocol (“HTTP(S)”) POST message including data formatted according to the eXtensible Markup Language (“XML”). Below is an example HTTP(S) POST message including an XML-formatted enrollment request for the social pay server:

```
POST /enroll.php HTTP/1.1
Host: www.socialpay.com
Content-Type: Application/XML
Content-Length: 484
<?XML version = “1.0” encoding = “UTF-8”?>
<enrollment_request>
    <request_ID>4NFU4RG94</request_ID>
    <timestamp>2011-02-22 15:22:43</timestamp>
    <user_ID>john.q.public@facebook.com</user_ID>
    <wallet_account_ID>7865493028712345</wallet_account_ID>
    <client_details>
        <client_IP>192.168.23.126</client_IP>
        <client_type>smartphone</client_type>
        <client_model>HTC Hero</client_model>
        <OS>Android 2.2</OS>
        <app_installed_flag>true</app_installed_flag>
    </client_details>
</enrollment_request>
```

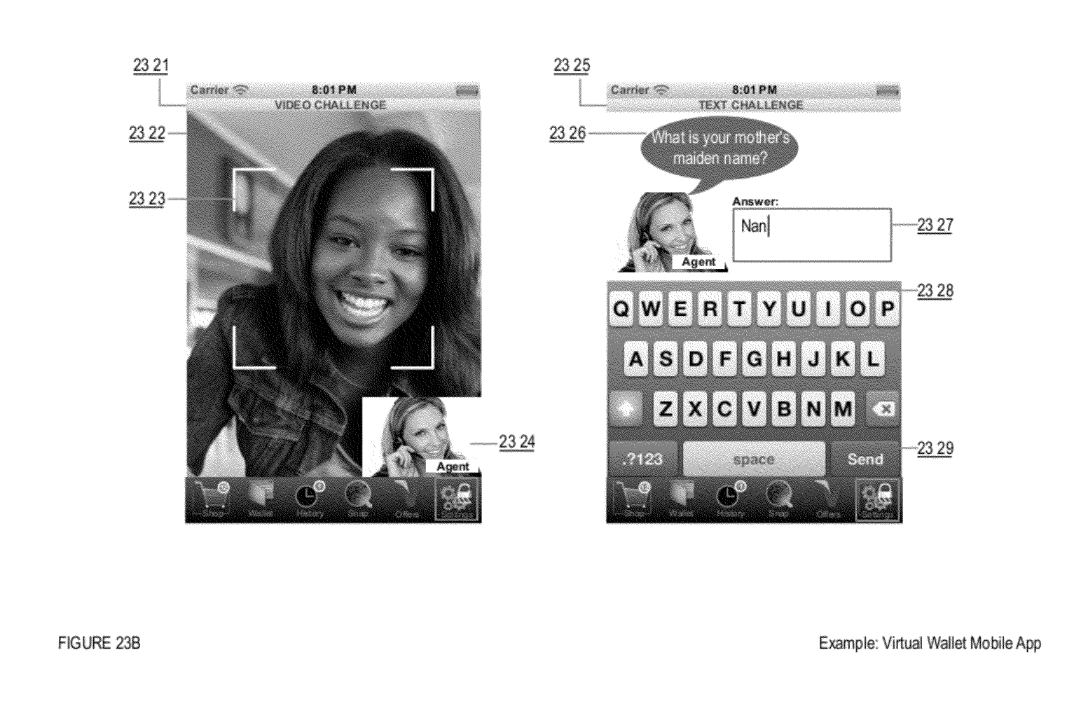

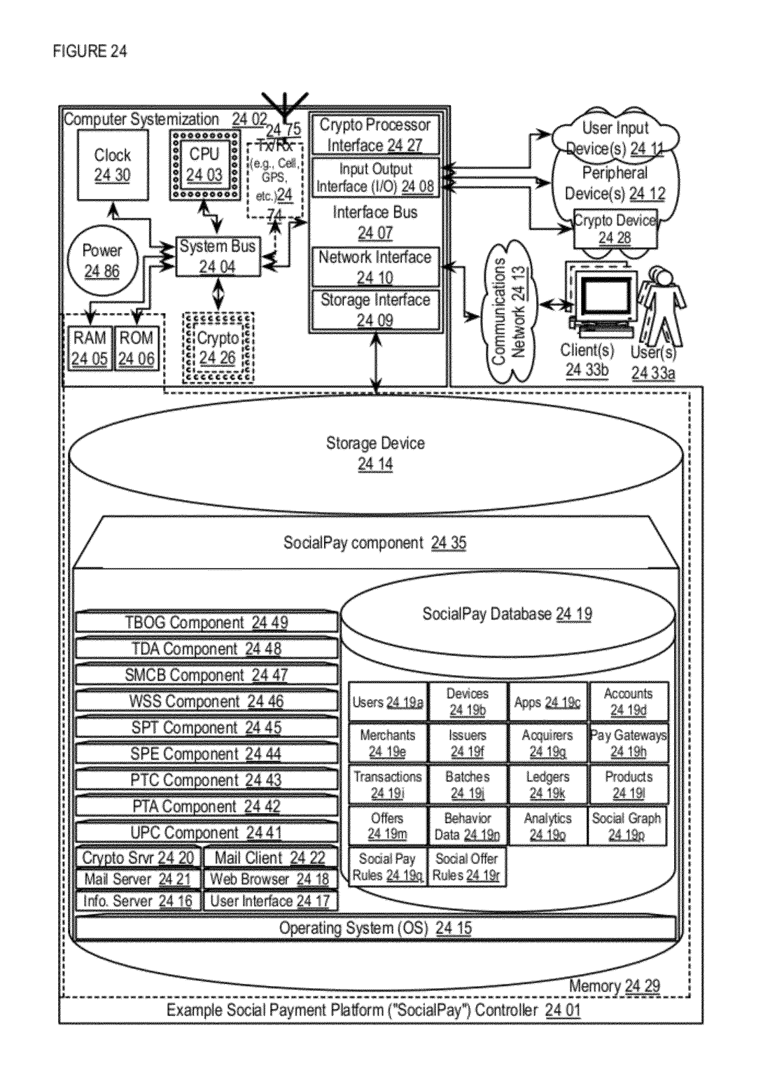

In some embodiments, the social pay server may obtain the enrollment request from the client, and extract the user's payment detail (e.g., XML data) from the enrollment request. For example, the social pay server may utilize a parser such as the example parsers described below in the discussion with reference to FIG. 24. In some implementations, the social pay server may query, e.g., 213, a social pay database, e.g., 203b, to obtain a social network request template, e.g., 214, to process the enrollment request. The social network request template may include instructions, data, login URL, login API call template and/or the like for facilitating social network authentication. For example, the database may be a relational database responsive to Structured Query Language (“SQL”) commands. The merchant server may execute a hypertext preprocessor (“PHP”) script including SQL commands to query the database for product data. An example PHP/SQL command listing, illustrating substantive aspects of querying the database, e.g., 214-215, is provided below:

<?PHP
header(‘Content-Type: text/plain’);
mysql_connect(“254.93.179.112”,$DBserver,$password); // access
database server
mysql_select_db(“SOCIALPAY.SQL”); // select database table to search
//create query
$query = “SELECT template FROM EnrollTable WHERE network
LIKE ‘%’ $socialnet”;

| | |
|---|---|
| $result = mysql_query($query); | // perform the search query |
| mysql_close(“SOCIALAUTH.SQL”); | // close database access |
| ?> | |

In some implementations, the social pay server may redirect the client to a social network server, e.g., 204a, by providing a HTTP(S) REDIRECT 300 message, similar to the example below:

```
HTTP/1.1 300 Multiple Choices
Location:
    https://www.facebook.com/dialog/oauth?client_id=
    snpa_app_ID&redirect_uri=www.paynetwork.com/enroll.php
<html>
    <head><title>300 Multiple Choices</title></head>
    <body><h1>Multiple Choices</h1></body>
</html>
```

In some implementations, the social pay server may provide information extracted from the social pay enrollment request to the social network server as part of a user authentication/social pay app enroll request, e.g., 215. For example, the social pay server may provide a HTTP(S) POST message to the social network server, similar to the example below:

```
POST /authenticate_enroll.php HTTP/1.1
Host: www.socialnet.com
Content-Type: Application/XML
Content-Length: 484
<?XML version = “1.0” encoding = “UTF-8”?>
<enrollment_request>
    <request_ID>4NFU4RG94</request_ID>
    <timestamp>2011-02-22 15:22:43</timestamp>
    <user_ID>john.q.public@facebook.com</user_ID>
    <wallet_account_ID>7865493028712345</wallet_account_ID>
    <client_details>
            <client_IP>192.168.23.126</client_IP>
            <client_type>smartphone</client_type>
            <client_model>HTC Hero</client_model>
            <OS>Android 2.2</OS>
            <app_installed_flag>true</app_installed_flag>
    </client_details>
</enrollment_request>
```

In some implementations, the social network server may provide a social network login request, e.g., 216, to the client. For example, the social network server may provide a HTML input form to the client. The client may display, e.g., 217, the login 29 form for the user. In some implementations, the user may provide login input into the client, e.g., 218, and the client may generate a social network login response, e.g., 219, for the social network server. In some implementations, the social network server may authenticate the login credentials of the user, and upon doing so, update the profile of the user to indicate the user's enrollment in the social pay system. For example, in a social networking service such as Facebook®, the social network server may provide permission to a social pay third-party developer app to access the user's information stored within the social network. In some embodiments, such enrollment may allow a virtual wallet application installed on a user device of to access the user's social profile information stored within the social network. Upon authentication, the social network server may generate an updated data record for the user, e.g., 220, and provide an enrollment notification, e.g., 221, to the social pay server. For example, the social network server may provide a HTTP(S) POST message similar to the example below:

```
POST /enrollnotification.php HTTP/1.1
Host: www.socialpay.com
Content-Type: Application/XML
Content-Length: 1306
<?XML version = “1.0” encoding = “UTF-8”?>
<enroll_notification>
    <request_ID>4NFU4RG94</request_ID>
    <timestamp>2011-02-22 15:22:43</timestamp>
    <result>enrolled</result>
</enroll_notification>
```

Upon receiving notification of enrollment from the social network server, the social pay server may generate, e.g., 222, a user enrollment data record, and store the enrollment data record in a social pay database, e.g., 223, to complete enrollment. In some implementations, the enrollment data record may include the information from the enrollment notification 221.

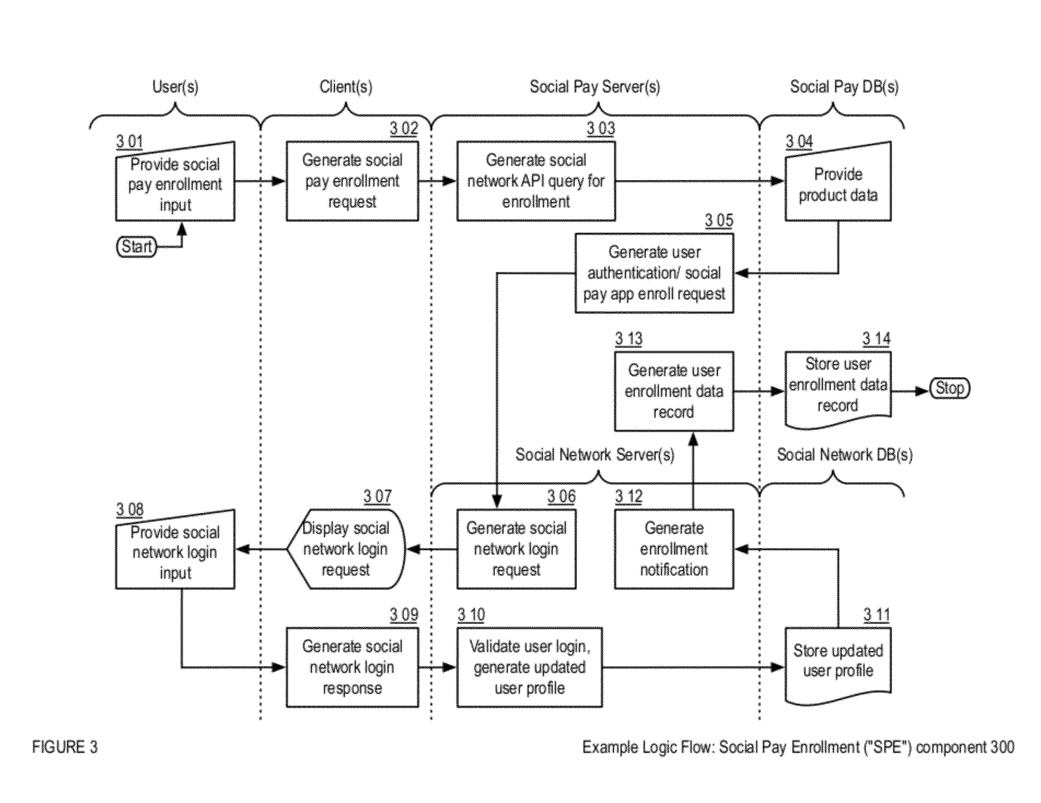

FIG. 3 shows a logic flow diagram illustrating example aspects of social pay enrollment in some embodiments of the SocialPay, e.g., a Social Pay Enrollment (“SPE”) component 300. In some embodiments, a user may desire to enroll in SocialPay. The user may provide user input, e.g., social pay enrollment input 301, into the client indicating the user's desire to enroll in social network authenticated purchase payment. In some implementations, using the user's input, the client may generate a social pay enrollment request, e.g., 302, and provide the enrollment request to the social pay server. In some embodiments, the social pay server may obtain the enrollment request from the client, and extract the user's payment detail (e.g., XML data) from the enrollment request. For example, the social pay server may utilize a parser such as the example parsers described below in the discussion with reference to FIG. 24. In some implementations, the social pay server may query, e.g., 303, a social pay database to obtain a social network request template to process the enrollment request. The social network request template may include instructions, data, login URL, login API call template and/or the like for facilitating social network authentication. In some implementations, the social pay server may redirect the client to a social network server. In some implementations, the social pay server may provide information extracted from the social pay enrollment request to the social network server as part of a user authentication/social pay app enroll request, e.g., 305. In some implementations, the social network server may provide a social network login request, e.g., 306, to the client. For example, the social network server may provide a HTML input form to the client. The client may display, e.g., 307, the login form for the user. In some implementations, the user may provide login input into the client, e.g., 308, and the client may generate a social network login response, e.g., 309, for the social network server. In some implementations, the social network server may authenticate the login credentials of the user, and upon doing so, update the profile of the user to indicate the user's enrollment in the social pay system. For example, in a social networking service such as Facebook®, the social network server may provide permission to a social pay third-party developer app to access the user's information stored within the social network. In some embodiments, such enrollment may allow a virtual wallet application installed on a user device of to access the user's social profile information stored within the social network. Upon authentication, the social network server may generate an updated data record for the user, e.g., 310-311, and provide an enrollment notification, e.g., 312 to the social pay server. Upon receiving notification of enrollment from the social network server, the social pay server may generate, e.g., 313, a user enrollment data record, and store the enrollment data record in a social pay database, e.g., 314, to complete enrollment. In some implementations, the enrollment data record may include the information from the enrollment notification.

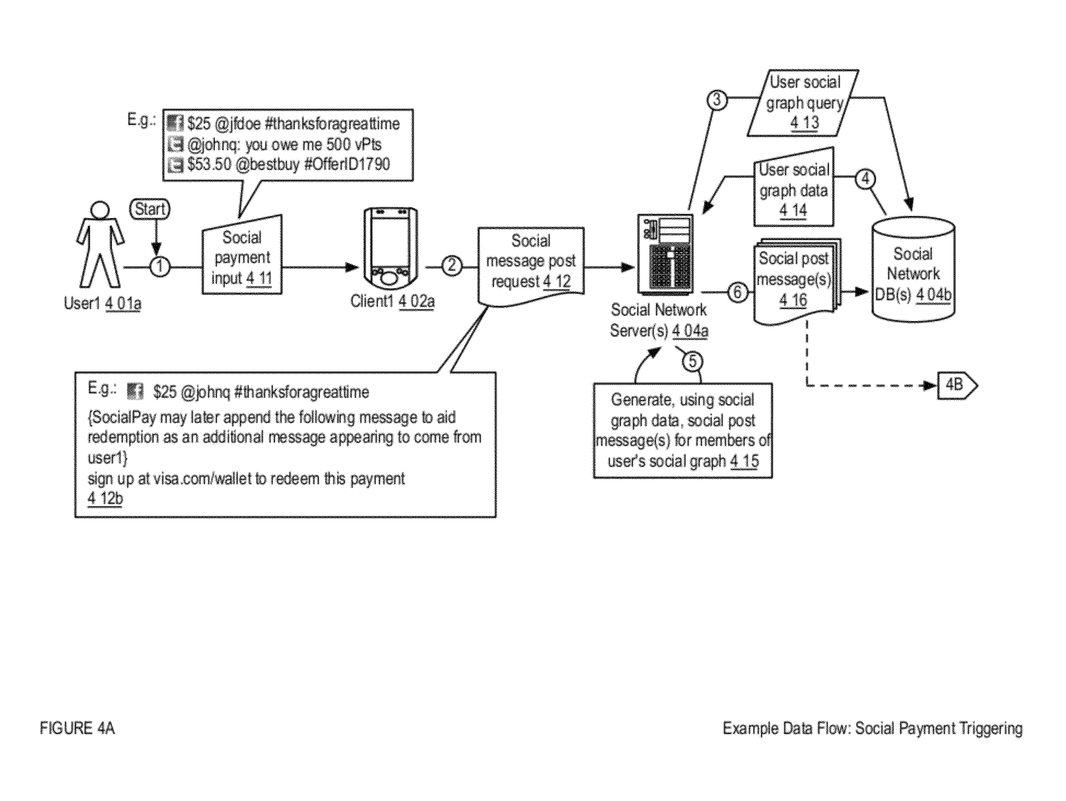

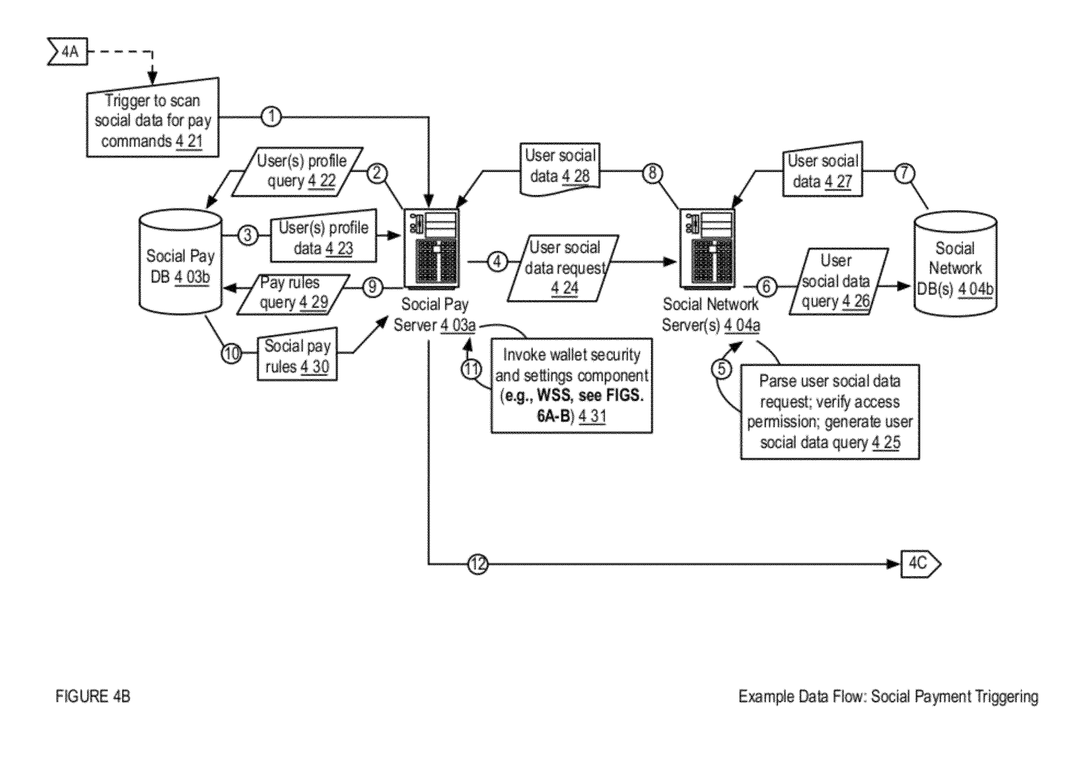

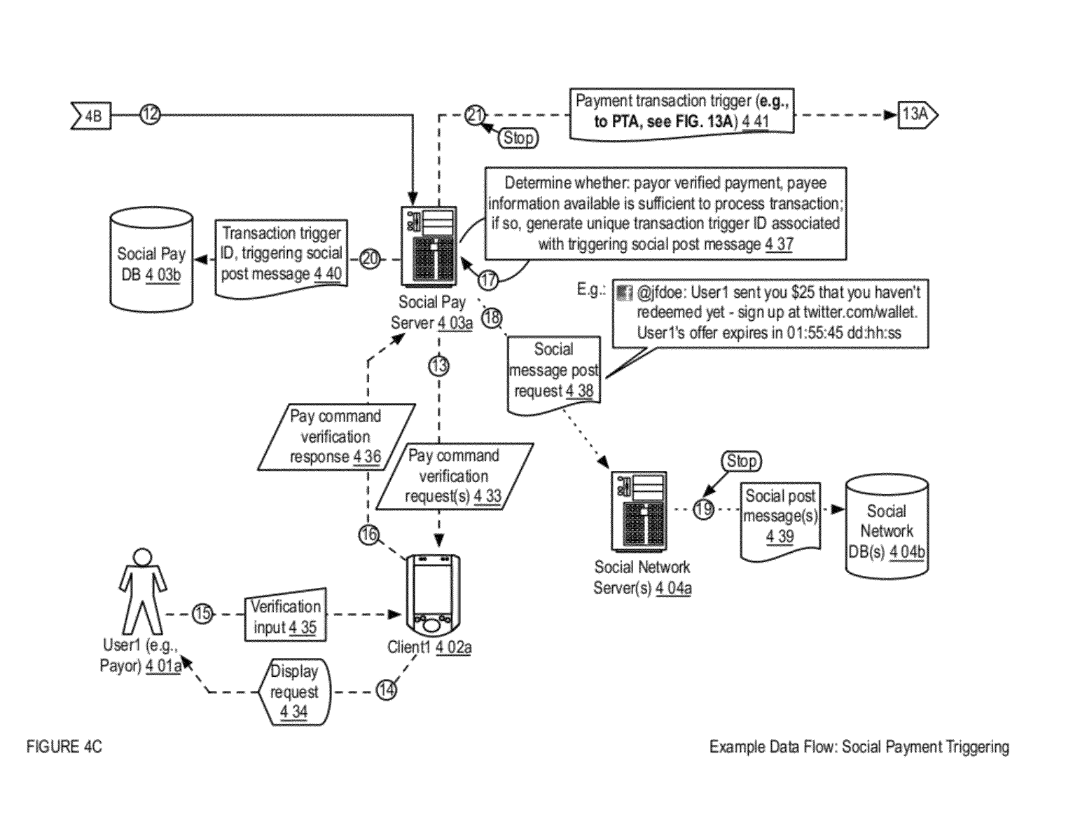

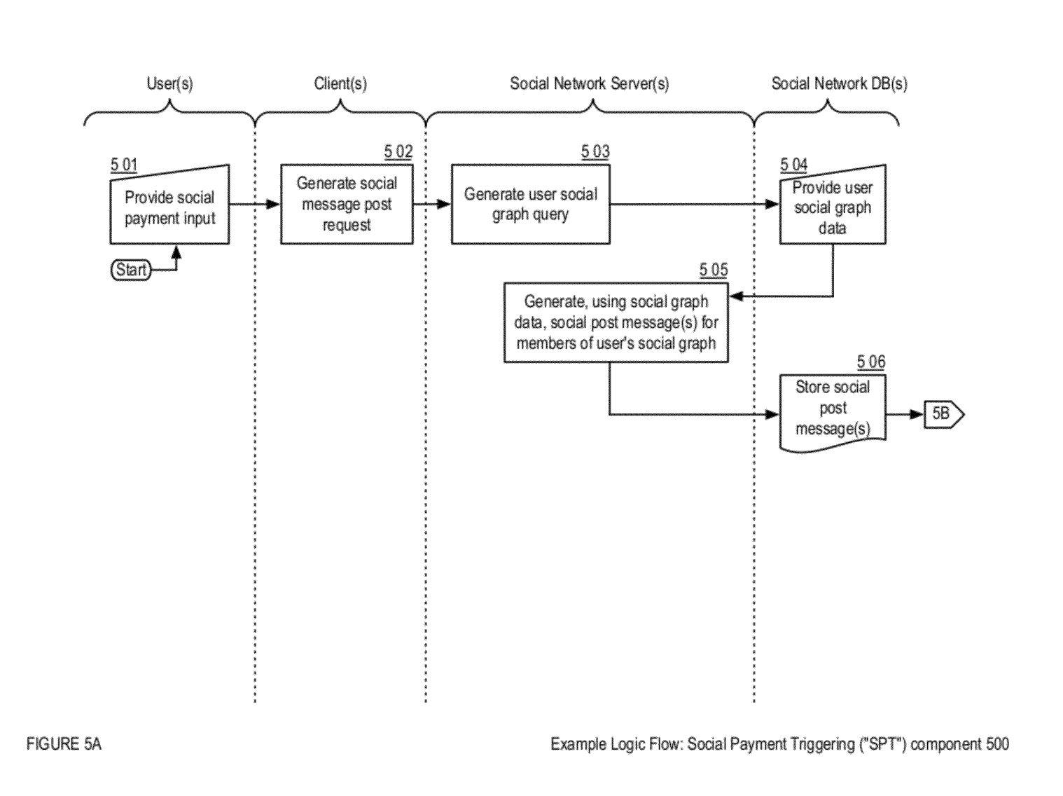

FIGS. 4A-C show data flow diagrams illustrating an example social payment triggering procedure in some embodiments of the SocialPay. With reference to FIG. 4A, in some embodiments, a user, e.g., user, e.g., user1 401a may desire to provide or request funds from another (e.g., a user, a participating merchant, etc.). The user may communicate with a social network server, e.g., 403a, via a client (client1 402a) such as, but not limited to: a personal computer, mobile device, television, point-of-sale terminal, kiosk, ATM, and/or the like. For example, the user may provide social payment input 411, into the client indicating the user's desire to provide or request funds from another. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In response, the client may provide a social message post request 412 to the social network server. In some implementations, a virtual wallet application executing on the client may provide the user with an easy-to-use interface to generate and send the social message post request. In alternate implementations, the user may utilize other applications to provide the social message post request. For example, the client may provide a social message post request to the social network server as a HTTP(S) POST message including XML-formatted data. An example listing of a social message post request 412, substantially in the form of a HTTP(S) POST message including XML-formatted data, is provided below:

```
POST /socialpost.php HTTP/1.1
Host: www.socialnetwork.com
Content-Type: Application/XML
Content-Length: 310
<?XML version = “1.0” encoding = “UTF-8”?>
<message_post_request>
    <request_ID>value</request_ID>
    <timestamp>2011-02-02 03:04:05</timestamp>
    <sender_id>jfdoe@facebook.com</sender_id>
    <receiver_id>johnqp@facebook.com</receiver_id>
    <message>$25 @johnqp #thanksforagreattimelastnite</message>
</message_post_request>
```

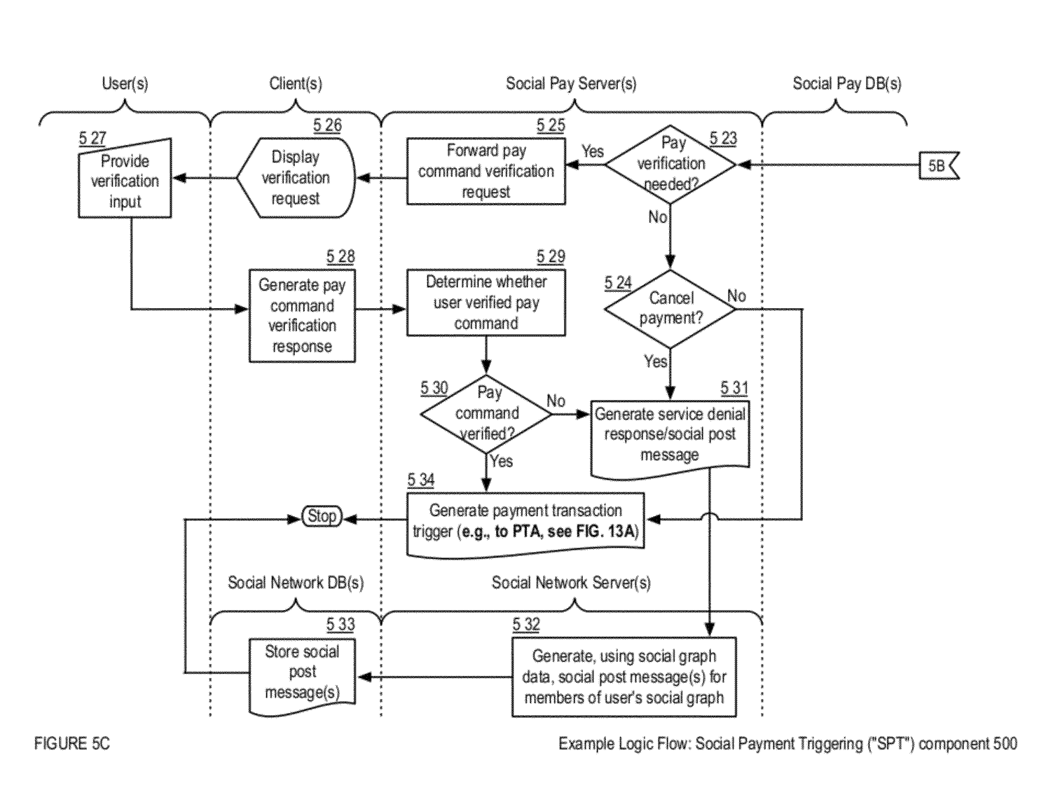

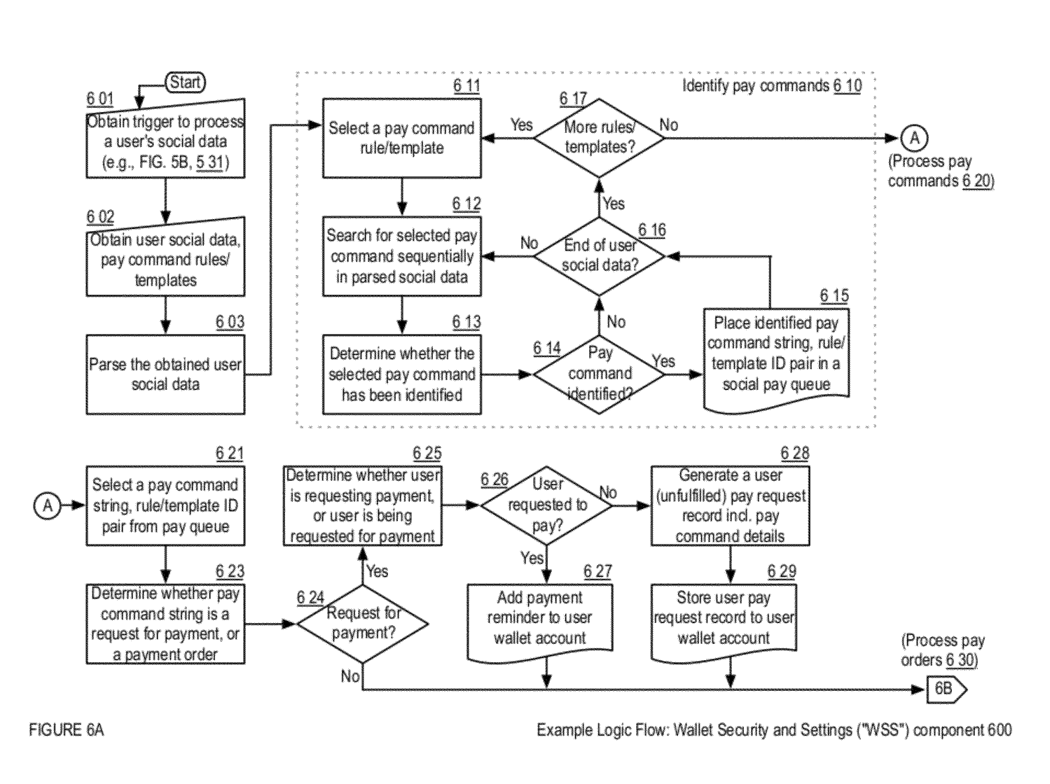

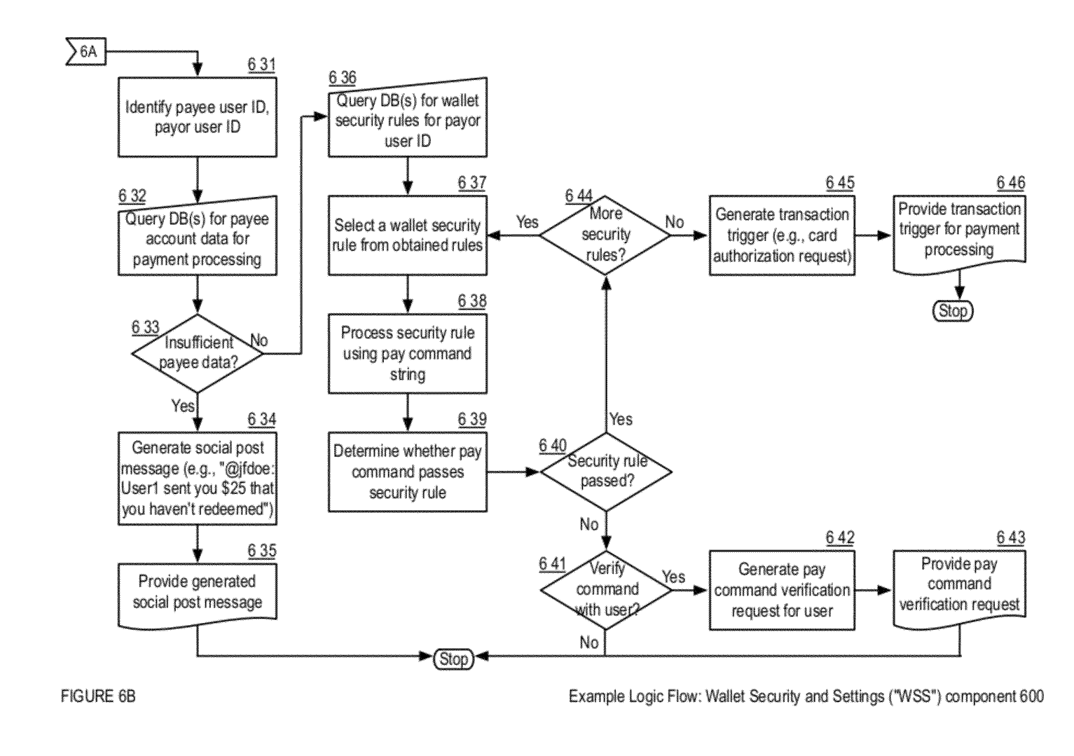

The user may have signed up for numerous wallets. The message 412 may be sent be sent from the user 402a to a second user via the social network 404a. In this example, user1 401a sent $25 to johnq with a message “#thanksforagreattime” 412b. SocialPay may later append various messages and/or send additional various messages that will appear to the target user to have been sent by user1 410a. As an example, here the SocialPay determined (determination and parsing as described further below, e.g., FIGS. 6, 9 and 10 et al.) that user2 does not have a wallet into which they may redeem payment. As such SocialPay upon parsing and determination may append a message to allow the receiving user to sign up for a wallet and thus obtain the payment from user1; in this example, social pay appended “signup at visa.com/wallet to redeem this payment.” It should be noted that various wallets may be employed and/or offered; for example, a social network may itself offer a wallet and as such another message of “signup at twitter.com/wallet to redeem this payment” may be appended. In another embodiment, social pay itself may host an e-wallet and as such the following message may be appended “signup at socialpay.com/wallet to redeem this payment.” In one example, the SocialPay server may use login credentials provided by a user to automatically simultaneously and permanently be logged in reading every social message/post entered by the user from other client programs and in addition received messages that are sent to the user by other users. As such, SocialPay may parse all transactions send by the user and/or received messages that were directed to the user and determine which messages are directed to make person to person payments. In another embodiment, this type of interception parsing may be employed at the social network servers instead of at the SocialPay servers. In yet another embodiment, both the SocialPay server and the social network server may do this type of interception parsing, the details of which are described further below (e.g., FIGS. 6, 9 and 10 et al.). It should be noted when this type of interception parsing is ongoing, which will be all the time unless a user specifically requests the cessation of such interception parsing, when the SocialPay server and/or other servers intercept messages and parse them and determine, e.g., they are triggers for payments, those servers may go on to process the parsed message triggering payment and other activities. For example, if the target user does not have an e-wallet account, upon look up and determination by the server, then the server may send a message in addition to the social message POST request 412, where the additional message will provide details for where the target user may sign up and create an e-wallet account and redeem payment provided to them by another user/system. If SocialPay, instead, determines that the target user is already enrolled in an e-wallet, it may initiate and then facilitate the transfer of payment from the first user to the target user's account without further messaging or interaction (e.g., it may also require the target user to accept such payments, in which case it can send a second message to the target user asking them to reply to social pay saying yes to effectuate payment before such funds are delivered to the target user's e-wallet account).

In another embodiment, a Social Pay post message may be for an item. In such a sense, it may become a social gift message. For example, the message may be substantially in the form of a HTTP(S) POST message including XML-formatted data, is provided below:

```
POST /socialpost.php HTTP/1.1
Host: www.socialnetwork.com
Content-Type: Application/XML
Content-Length: 310
<?XML version = “1.0” encoding = “UTF-8”?>
<message_post_request>
                <message_link_label>iPad</message_link_label >
          <message_link_label_address>http:store.apple.com/?
    itemquery?ipad_32GB_WiFi_white
    </message_link_label_address>
                <request_ID>value</request_ID>
                <store_login>jfdoe@mac.com</store_login>
                <store_pass>abc123</store_pass>
                <store_wallet_account>Apple Store ID123
                </store_wallet_account>
    <timestamp>2011-02-02 03:04:05</timestamp>
    <sender_id>jfdoe@facebook.com</sender_id>
    <receiver_id>johnqp@facebook.com</receiver_id>
    <message>iPad @johnqp #christmasgift</message>
</message_post_request>
```

In such an example, the user may post a link to an item (e.g., drag and drop a link for a product into their social messaging application which will translate and/or include both the link label (e.g., iPad) and the address for the item (e.g., http:store.apple.com/?itemquery?ipad_{—}32GB_WiFi_white) identifying the product skew at the merchant. Social Pay may then see if the user's wallet has an account with that merchant and provide login credentials to affect a purchase through the merchant and identify shipping addresses from the target user. In another embodiment, the gifting user may be prompted for login information, which may then be passed along to Social Pay to affect the purchase.

In some embodiments, the social network server 404a may query its social network database for a social graph of the user, e.g., 413. For example, the social network server may issue PHP/SQL commands to query a database table (such as FIG. 24, Social Graph 2419p) for social graph data associated with the user. An example user social graph query 413, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“SocialPay_DB.SQL”); // select database table to
search
//create query
$query = “SELECT friend_name friend_type friend_weight
  message_params_list messaging_restrictions FROM
  SocialGraphTable WHERE user LIKE ‘%’ $user_id”;
$result = mysql_query($query); // perform the search query
mysql_close(“SocialPay_DB.SQL”); // close database access
?>
```

In some embodiments, the social network database may provide the requested social graph data in response, e.g., 414. Using the social graph data, the social network server may generate message(s) as appropriate for the user and/or members of the user's social graph, e.g., 415, and store the messages 416 for the user and/or social graph members.

With reference to FIG. 4B, in some embodiments, such posting of social messages may trigger SocialPay actions. For example, a social pay server 403a may be triggered to scan the social data for pay commands. In embodiments where every social post message originates from the virtual wallet application of a user, the SocialPay may optionally obtain the pay commands from the virtual wallet applications, and skip scanning the social networks for pay commands associated with the user. In embodiments where a user is allowed to issue pay commands from any device (even those not linked to the user's virtual wallet), the SocialPay may periodically, or even continuously scan the social networks for pay commands, e.g., 421. In embodiments where the SocialPay scans the social networks, the social pay server may query a social pay database for a profile of the user. For example, the social pay server may request a user ID and password for the social networks that the user provided to the social pay server during the enrollment phase (see, e.g., FIGS. 2-3). For example, the SocialPay server may issue PHP/SQL commands to query a database table (such as FIG. 24, Users 2419a) for user profile data. An example user profile data query 422, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“SocialPay_DB.SQL”); // select database table to
search
//create query
$query = “SELECT network_id network_name network_api
  user_login user_pass FROM UsersTable WHERE userid
  LIKE ‘%’ $user_id”;
$result = mysql_query($query); // perform the search query
mysql_close(“SocialPay_DB.SQL”); // close database access
?>
```

In response, the social pay database may provide the requested information, e.g., 423. In some embodiments, the social pay server may provide a user social data request 424 to the social network server. An example listing of commands to issue a user social data request 424, substantially in the form of PHP commands, is provided below:

```
<?PHP
header(‘Content-Type: text/plain’);
// Obtain user ID(s) of friends of the logged-in user
$friends =
    json_decode(file_get_contents(‘https://graph.-
    facebook.com/me/friends?access
    token=’$cookie[‘oauth_access_token’]), true);
$friend_ids = array_keys($friends);
// Obtain message feed associated with the profile of the logged-in user
$feed =
    json_decode(file_get_contents(‘https:llgraph.facebook.com/
    me/feed?access_token=’$cookie[‘oauth_access_token’]), true);
// Obtain messages by the user's friends
$result = mysql_query(‘SELECT * FROM content WHERE uid IN (’
    .implode($friend_ids, ‘,’) . ‘)’);
$friend_content = array( );
while ($row = mysql_fetch_assoc($result))
$friend_content [ ] $row;
?>
```

The user may have signed up for numerous wallets. The message 412, 424 may be sent be sent from the user 402a to a second user via the social network 404a. In this example, user1 401a sent $25 to johnq with a message “#thanksforagreattime” 412b. SocialPay may later append various messages and/or send additional various messages, which will appear to the target user to have been sent by user1 401a. As an example, here the SocialPay determined (determination and parsing as described further below, e.g., FIGS. 6, 9 and 10 et al.) that user2 does not have a wallet into which they may redeem payment. As such SocialPay upon parsing and determination may append a message to allow the receiving user to sign up for a wallet and thus obtain the payment from user1; in this example, SocialPay appended “signup at visa.com/wallet to redeem this payment.” It should be noted that various wallets may be employed and/or offered; for example, a social network may itself offer a wallet and as such another message of “signup at twitter.com/wallet to redeem this payment” may be appended. In another embodiment, SocialPay itself may host an e-wallet and as such the following message may be appended “signup at socialpay.com/wallet to redeem this payment.” In one example, the SocialPay server may use login credentials provided by a user to automatically simultaneously and permanently be logged in reading every social message/post entered by the user from other client programs and in addition received messages that are sent to the user by other users. As such, SocialPay may parse all transactions send by the user and/or received messages that were directed to the user and determine which messages are directed to make person to person/entity payments. In another embodiment, this type of interception parsing may be employed at the social network servers instead of at the SocialPay servers. In yet another embodiment, both the SocialPay server and the social network server may do this type of interception parsing, the details of which are described further below (e.g., FIGS. 6, 9 and 10 et al.). It should be noted when this type of interception parsing is ongoing, which will be all the time unless a user specifically requests the cessation of such interception parsing, when the SocialPay server and/or other servers intercept messages and parse them and determine, e.g., they are triggers for payments, those servers may go on to process the parsed message triggering payment and other activities. For example, if the target user does not have an e-wallet account, upon look up and determination by the server, then the server may send a message in addition to the social message POST request 412, 424, where the additional message will provide details for where the target user may sign up and create an e-wallet account and redeem payment provided to them by another user/system. If SocialPay, instead, determines that the target user is already enrolled in an e-wallet, it may initiate and then facilitate the transfer of payment from the first user to the target user's account without further messaging or interaction (e.g., it may also require the target user to accept such payments, in which case it can send a second message to the target user asking them to reply to SocialPay saying yes to effectuate payment before such funds are delivered to the target user's e-wallet account).

In some embodiments, the social network server may query, e.g., 426, it social network database 404b for social data results falling within the scope of the request. In response to the query, the database may provide social data, e.g., 427. The social network server may return the social data obtained from the databases, e.g., 428, to the social pay server. An example listing of user social data 428, substantially in the form of JavaScript Object Notation (JSON)-formatted data, is provided below:

| | | |
|---|---|---|
| [ “data”: | [ | |
| | { | “name”: “Tabatha Orloff”, |
| | | “id”: “483722”}, |
| | { | “name”: “Darren Kinnaman”, |
| | | “id”: “86S743”}, |
| | { | “name”: “Sharron Jutras”, |
| | | “id”: “O91274”} |
| ] } | | |

In some embodiments, the social pay server may query the social pay database for social pay rules, e.g., 429. For example, the social pay server may issue PHP/SQL commands to query a database table (such as FIG. 24, Social Pay Rules 2419q) for the social pay rules 430. An example pay rules query 429, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“SocialPay_DB.SQL”); // select database table to
search
//create query
$query = “SELECT rule_id rule_type rule_description
    rule_priority rule_source FROM SocialPayRulesTable WHERE
    rule_type LIKE pay_rules”;
$result = mysql_query($query); // perform the search query
mysql_close(“SocialPay_DB.SQL”); // close database access
?>
```

In some embodiments, the social pay server may process the user social data using the social pay rules to identify pay commands, pay requests, merchant offers, and/or like content of the user social data. In some embodiments, rules may be provided by the SocialPay to ensure the privacy and security of the user's social data and virtual wallet. As another example, the rules may include procedures to detect fraudulent transaction attempts, and request user verification before proceeding, or cancel the transaction request entirely. In some embodiments, the social pay server may utilize a wallet security and settings component, such as the example WSS 600 component described further below in the discussion with reference to FIGS. 6A-B.

With reference to FIG. 4C, in some embodiments, the social pay server may optionally determine that, based on processing of the rules, user verification is needed to process a transaction indicated in a pay command. For example, if the rules processing indicated that there is a probability of the pay command being an attempt at a fraudulent transaction attempt, the social pay server may determine that the user must be contacted for payment verification before the transaction can be processed. In such scenarios, the social pay server may provide a pay command verification request 433 to the client, which the client may display, e.g., 434, to the user. For example, the social pay server may provide a pay command verification request to the client 402a as a HTTP(S) POST message including XML-formatted data. An example listing of a pay command verification request 433, substantially in the form of a HTTP(S) POST message including XML-formatted data, is provided below:

```
POST /verifyrequest.php HTTP/1.1
Host: www.client.com
Content-Type: Application/XML
Content-Length: 256
<?XML version = “1.0” encoding = “UTF-8”?>
<verify_request>
    <transaction_ID>AE1234</transaction_ID>
    <timestamp>2011-02-02 03:04:05</timestamp>
    <amount>50000 vpts</amount>
    <message_string>5000000 vpts @jfdoe #thx</message_string>
</verify_request>
```

In some embodiments, the user may provide a verification input 435 into the client, which may provide a pay command verification response to the social pay server. The social pay server may determine whether the payor verified payment, whether payee information available is sufficient to process the transaction, and/or the like. In scenarios where sufficient payee information is unavailable, the social pay server may optionally provide a social post message 438 to a social networking service associated with the potential payee requesting the payee to enroll in social pay service (e.g., using the SPE 300 component described above in the discussion with reference to FIGS. 2-3), which the social network server may post 439 for the payee. If all the requirements are met for processing the transaction, the social pay server may generate a unique transaction trigger associated with the triggering social post message, e.g., 437, and store a transaction trigger ID, triggering social post message, etc., for recordkeeping or analytics purposes, e.g., 440. The social pay server may provide the transaction trigger to trigger a purchase transaction 441, e.g., via a purchase transaction authorization such as the example PTA 1400 component described below in the discussion with reference to FIGS. 13-14.

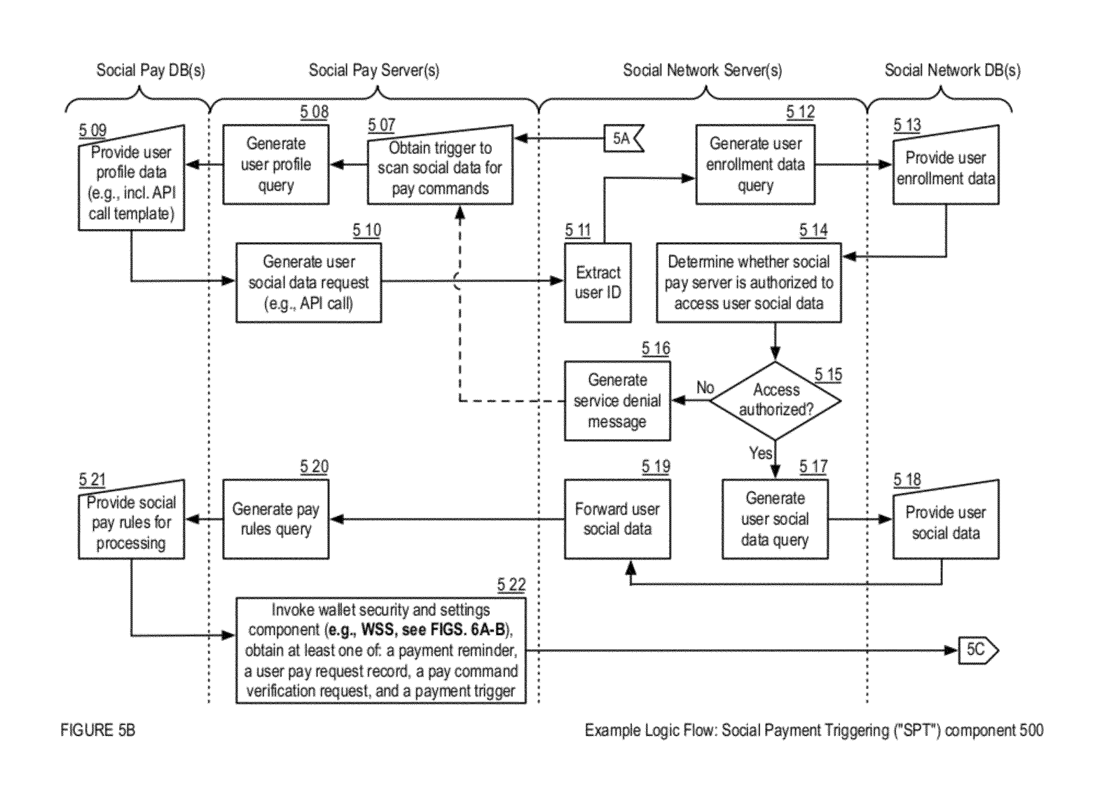

FIGS. 5A-C show logic flow diagrams illustrating example aspects of social payment triggering in some embodiments of the SocialPay, e.g., a Social Payment Triggering (“SPT”) component 500. With reference to FIG. 5A, in some embodiments, a user may desire to provide or request funds from another (e.g., a user, a participating merchant, etc.). The user may communicate with a social network server via a client. For example, the user may provide social payment input 501, into the client indicating the user's desire to provide or request funds from another. In response, the client may generate and provide a social message post request 502 to the social network server. In some implementations, a virtual wallet application executing on the client may provide the user with an easy-to-use interface to generate and send the social message post request. In alternate implementations, the user may utilize other applications to provide the social message post request. In some embodiments, the social network server may query its social network database for a social graph of the user, e.g., 503. In response, the social network database may provide the requested social graph data, e.g., 504. Using the social graph data, the social network server may generate message(s) as appropriate for the user and/or members of the user's social graph, e.g., 505, and store the messages 506 for the user and/or social graph members.

With reference to FIG. 5B, in some embodiments, such posting of social messages may trigger SocialPay actions. For example, a social pay server may be triggered to scan the social data for pay commands, e.g., 507. In embodiments where every social post message originates from the virtual wallet application of a user, the SocialPay may optionally obtain the pay commands from the virtual wallet applications, and skip scanning the social networks for pay commands associated with the user. In embodiments where a user is allowed to issue pay commands from any device (even those not linked to the user's virtual wallet), the SocialPay may periodically, or even continuously scan the social networks for pay commands. In embodiments where the SocialPay scans the social networks, the social pay server may query a social pay database for a profile of the user, 508. For example, the social pay server may request a user ID and password for the social networks that the user provided to the social pay server during the enrollment phase (see, e.g., FIGS. 2-3). In response, the social pay database may provide the requested information, e.g., 509. In some embodiments, the social pay server may generate provide a user social data request 510 to the social network server.

In some embodiments, the social network server may extract a user ID from the user social data request, e.g., 511. The social network server may query, e.g., 512, it social network database to determine whether the user is enrolled in SocialPay with the social network (e.g., “did the user allow the SocialPay Facebook® app to access user data?”). In response, the social network database may provide user enrollment data relating to SocialPay. The social network server may determine whether the user is enrolled, and thus whether the social pay server is authorized to access the user social data, 514. If the social network server determines that the social pay server is not authorized, 515, option “No,” it may generate a service denial message, 516, and provide the message to the social pay server. If the social network server determines that the social pay server is authorized to access the user social data, 517, option “Yes,” the social network server may generate a user social data query 517, and provide it to the social network database. In response, the social network database may provide the user social data requested, 518. The social network server may provide the user social data 519 to the social pay server.

In some embodiments, the social pay server may query the social pay database for social pay rules, e.g., 520-521. In some embodiments, the social pay server may process the user social data using the social pay rules to identify pay commands, pay requests, merchant offers, and/or like content of the user social data, 522. In some embodiments, rules may be provided by the SocialPay to ensure the privacy and security of the user's social data and virtual wallet. As another example, the rules may include procedures to detect fraudulent transaction attempts, and request user verification before proceeding, or cancel the transaction request entirely. In some embodiments, the social pay server may utilize a wallet security and settings component, such as the example WSS 600 component described further below in the discussion with reference to FIGS. 6A-B.

With reference to FIG. 5C, in some embodiments, the social pay server may optionally determine that, based on processing of the rules, user verification is needed to process a transaction indicated in a pay command, 523, option “Yes.” For example, if the rules processing indicated that there is a probability of the pay command being an attempt at a fraudulent transaction attempt, the social pay server may determine that the user must be contacted for payment verification before the transaction can be processed. In such scenarios, the social pay server may provide a pay command verification request 525 to the client, which the client may display, e.g., 526, to the user. In some embodiments, the user may provide a verification input 527 into the client, which may provide a pay command verification response to the social pay server, 528. The social pay server may determine whether the payor verified payment, whether payee information available is sufficient to process the transaction, and/or the like, 529. In scenarios where sufficient payee information is unavailable or the payor needs to be contacted for payment verification, 530, option “No,” the social pay server may optionally provide a social post message 531 to a social networking service associated with the potential payee/payor requesting the payee to enroll in social pay service (e.g., using the SPE 300 component described above in the discussion with reference to FIGS. 2-3) or provide verification, which the social network server may post 532-533 for the payee. If all the requirements are met for processing the transaction, 530, option “Yes,” the social pay server may generate a unique transaction trigger associated with the triggering social post message, e.g., 534, and may optionally store a transaction trigger ID, triggering social post message, etc., for recordkeeping or analytics purposes. The social pay server may provide the transaction trigger to trigger a purchase transaction, e.g., via a purchase transaction authorization such as the example PTA 1400 component described below in the discussion with reference to FIGS. 13-14.

FIGS. 6A-B show logic flow diagrams illustrating example aspects of implementing wallet security and settings in some embodiments of the SocialPay, e.g., a Something (“WSS”) component 600. In some embodiments, the social pay server may process the user social data using the social pay rules to identify pay commands, pay requests, merchant offers, and/or like content of the user social data. In some embodiments, rules may be provided by the SocialPay to ensure the privacy and security of the user's social data and virtual wallet. As another example, the rules may include procedures to detect fraudulent transaction attempts, and request user verification before proceeding, or cancel the transaction request entirely.

Accordingly, with reference to FIG. 6A, in some embodiments, the SocialPay may obtain a trigger to process a user's social data (e.g., from FIG. 5B, element 531), 601. The SocialPay may obtain user and/or user social graph member social data, as well as pay command rules and templates (e.g., for identifying standard pay commands), 602. The SocialPay may parse the obtained user social data in preparation for rules processing, 603. For example, the SocialPay may utilize parsers such as the example parsers described below in the discussion with reference to FIG. 24. The SocialPay may select a pay command rule/template for processing. The SocialPay may search through the parsed user social data, e.g., in a sequential manner, for the selected pay command, 612, and determine whether the pay command is present in the user social data, 613. It should be noted that in an alternative embodiment such parsing and processing may occur continuously and in real time through interception parsing where SocialPay is logged into a user social account (e.g., with a user's provided login credentials) and as such receiving every post made by the user and other clients and receiving every message directed to the user and parsing such messages in real time as they occur (e.g., see paragraphs [0045] and [0052] above for further detail). If the pay command is identified, 614, option “Yes,” the SocialPay may place the identified pay command string, an identification of the rule/template, the actual listing of the rule/template, and/or the like in a queue for further processing, 615. The SocialPay may perform such a procedure until the entirety of the user's social data has been searched through (see 616). In some embodiments, the SocialPay may perform the above procedure for all available rules/templates, to identify all the pay command strings included in the user social data (see 617).

In some embodiments, the SocialPay may process each pay command identified from the user social data, 720. For example, the SocialPay may select a pay command string from the queue and its associated template/identification rule, 621. Using the rule/template and pay command string, the SocialPay may determine whether the string represents a request for payment, or an order to pay, 623. If the pay command string represents a request for payment (e.g., “hey @jfdoe, you owe me 25 bucks #cashflowblues”), 624, option “Yes,” the SocialPay may determine whether the user for whom the WSS component is executing is the requested payor, or the payee, 625. If the user has been requested to pay, 626, option “Yes,” the SocialPay may add a payment reminder to the user wallet account, 627. Otherwise, the SocialPay may generate a user pay request record including the pay command details, 628, and store the pay request record in the user's wallet account for recordkeeping purposes or future analytics processing, 629.

With reference to FIG. 6B, in some embodiments, the SocialPay may extract an identification of a payor and payee in the transaction, 631. The SocialPay may query a database for payee account data for payment processing, 632. If the payee data available is insufficient, 633, option “Yes,” the SocialPay may generate a social post message to the payee's social network account 634, requesting that the payee either enroll in the SocialPay (if not already), or provide additional information so that the SocialPay may process the transaction. The SocialPay may provide 635 the social post message to the social networking service associated with the payee. If sufficient payee information is available, 633, option “No,” the SocialPay may query the payor's wallet account for security rules associated with utilizing the virtual wallet account, 636. The SocialPay may select a wallet security rule, 637, and process the security rule using the pay command string as input data, 638. Based on the processing, the SocialPay may determine whether the pay command passes the security rule, or instead poses a security risk to the user wallet. If the security rule is not passed, 640, option “No,” the SocialPay may determine whether verification from the user can salvage the pay command string, 641. If the SocialPay determines that the risk is too great, the SocialPay may directly terminate the transaction and remove the pay command string from the processing queue. Otherwise (641, option “Yes”), the SocialPay may generate a pay command verification request for the user, 642, and provide the pay command verification request as an output of the component, 643. If all security rules are passed for the pay command string, 644, option “No,” the SocialPay may generate a transaction trigger with a trigger ID (such as a card authorization request), and provide the transaction trigger for payment processing.

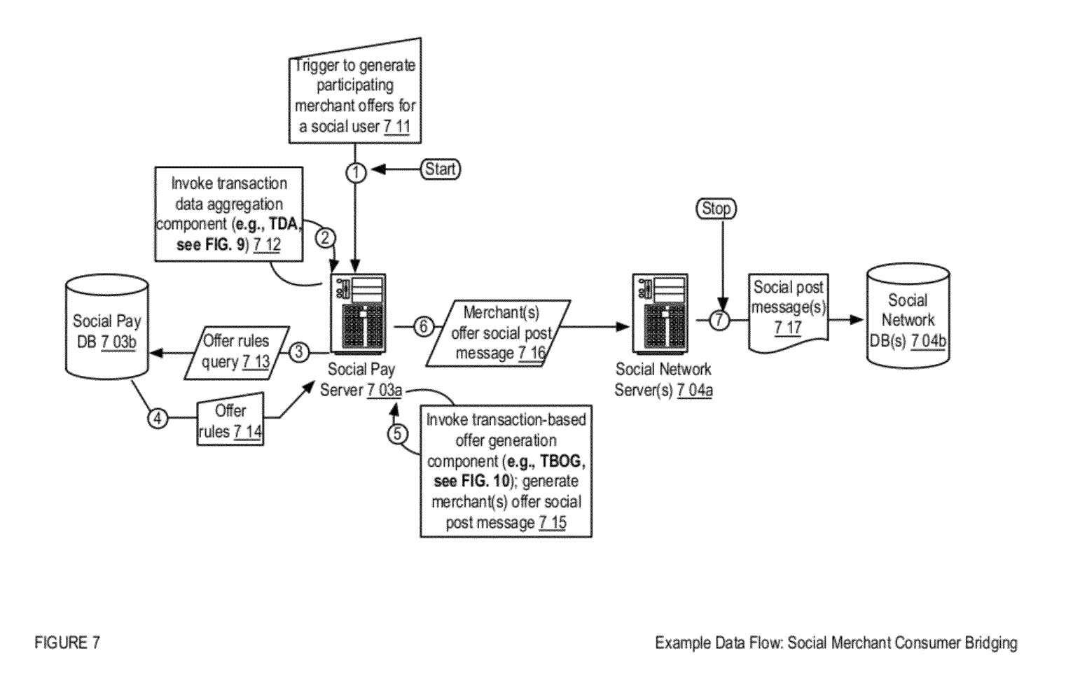

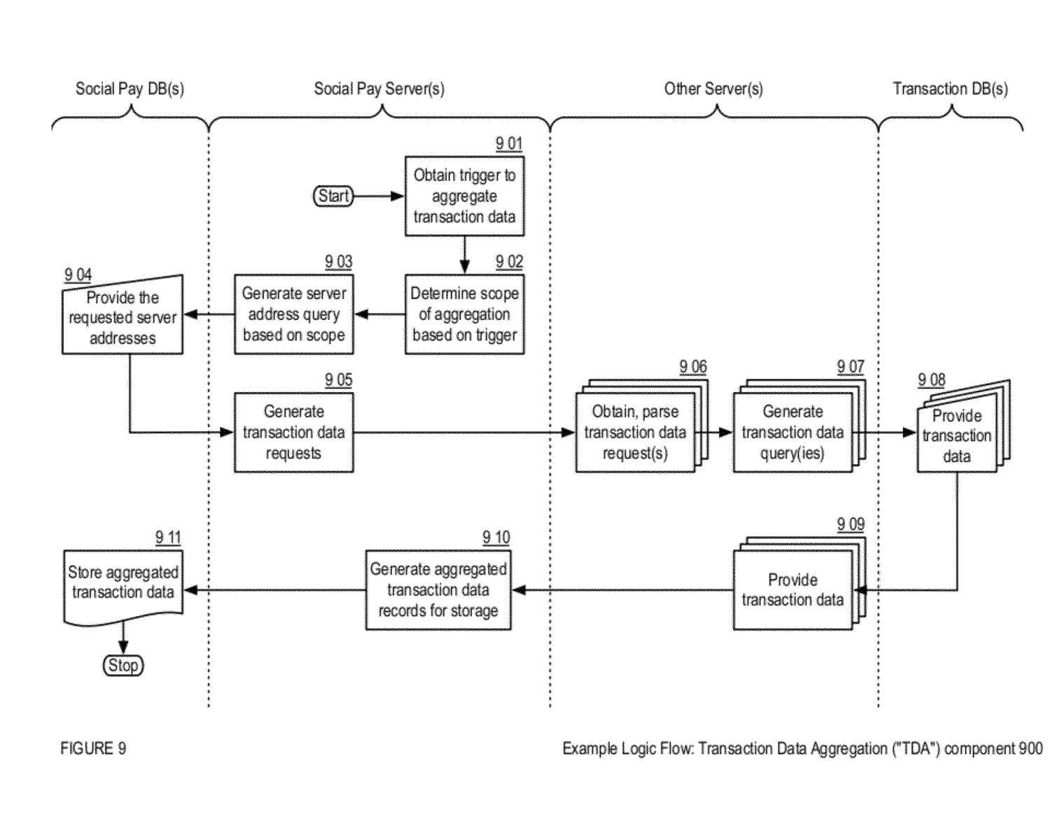

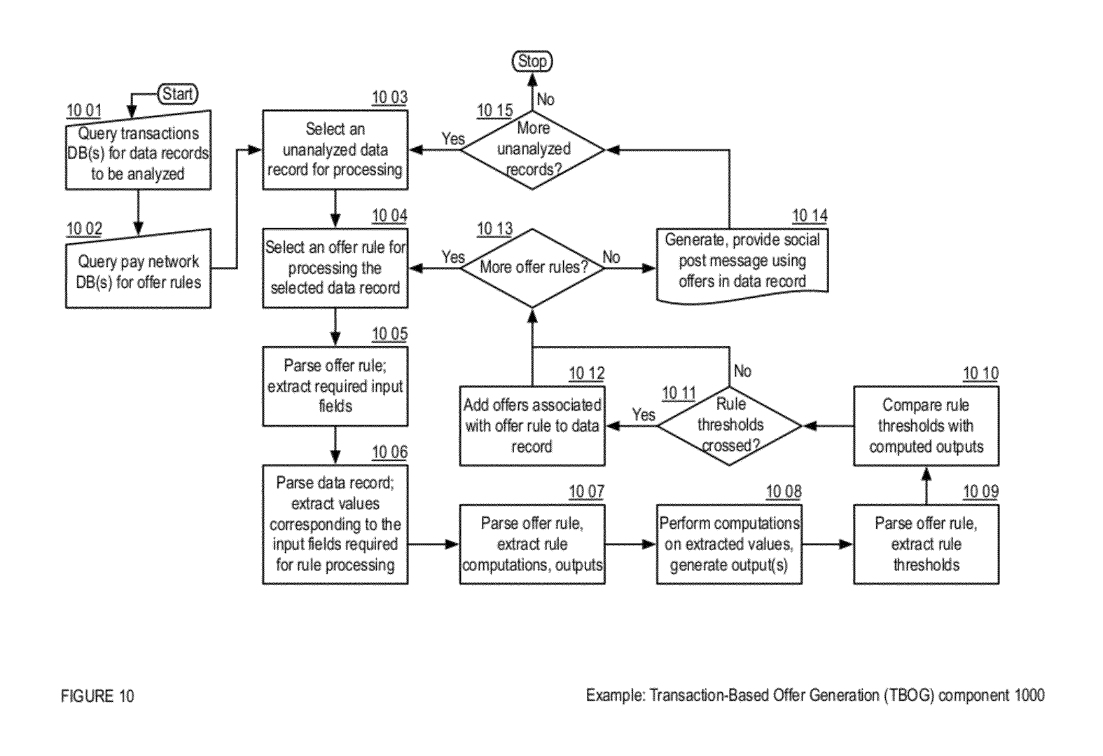

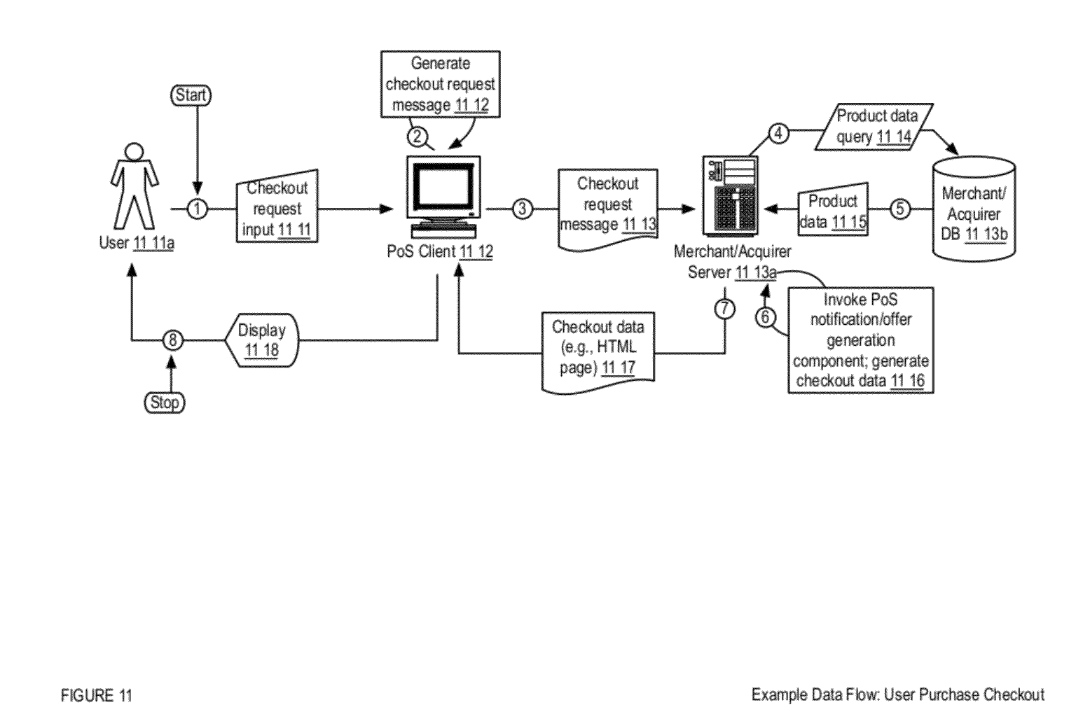

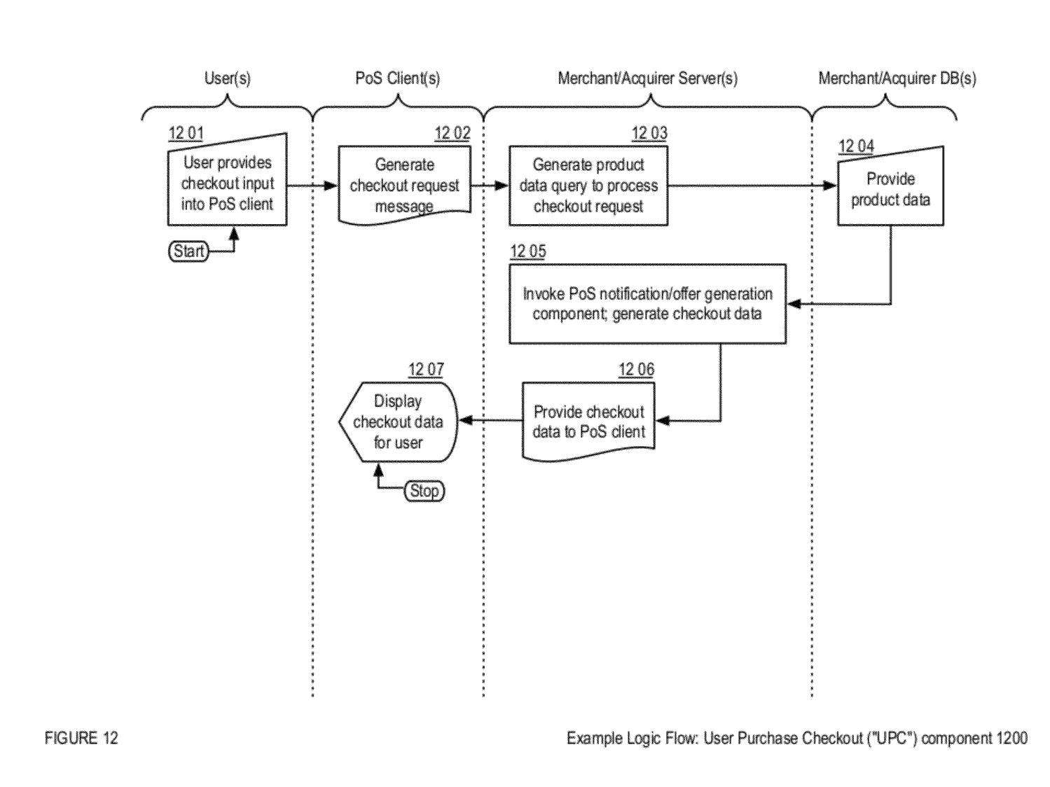

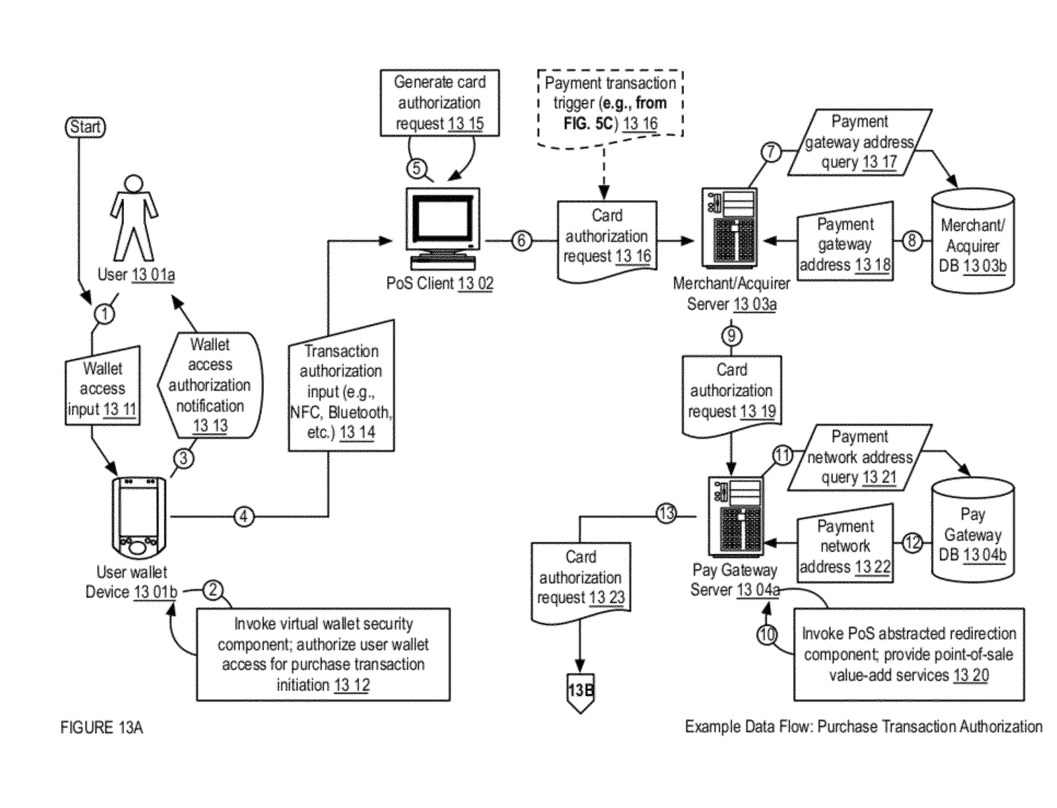

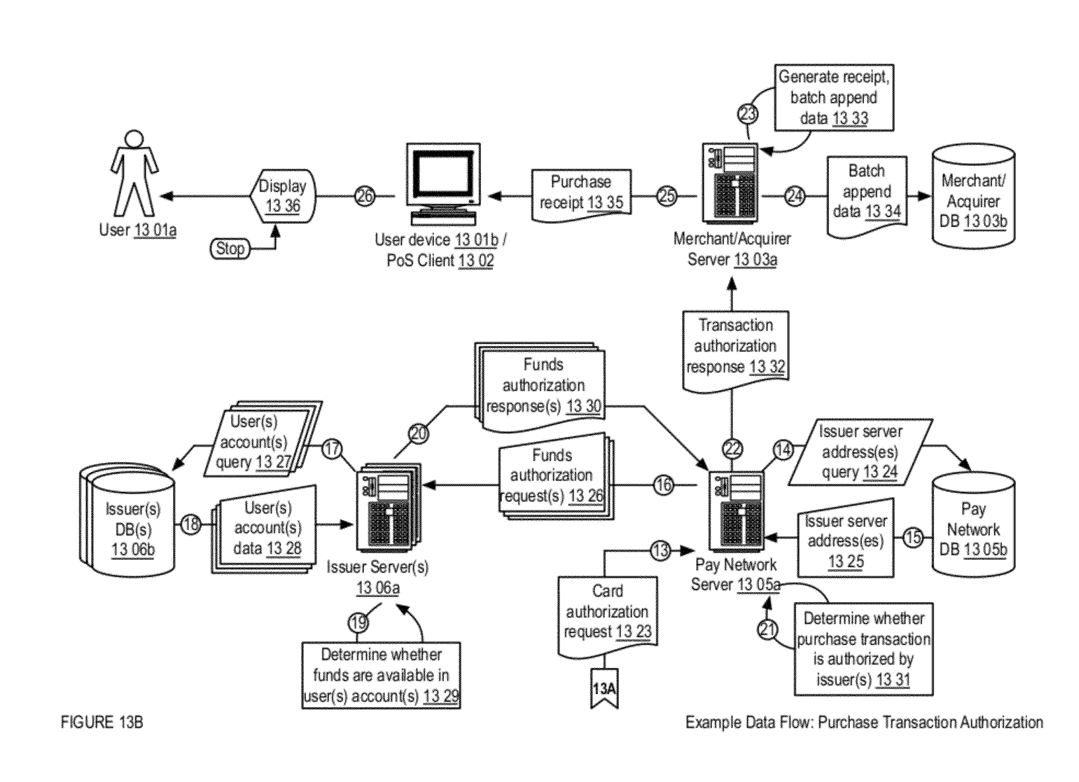

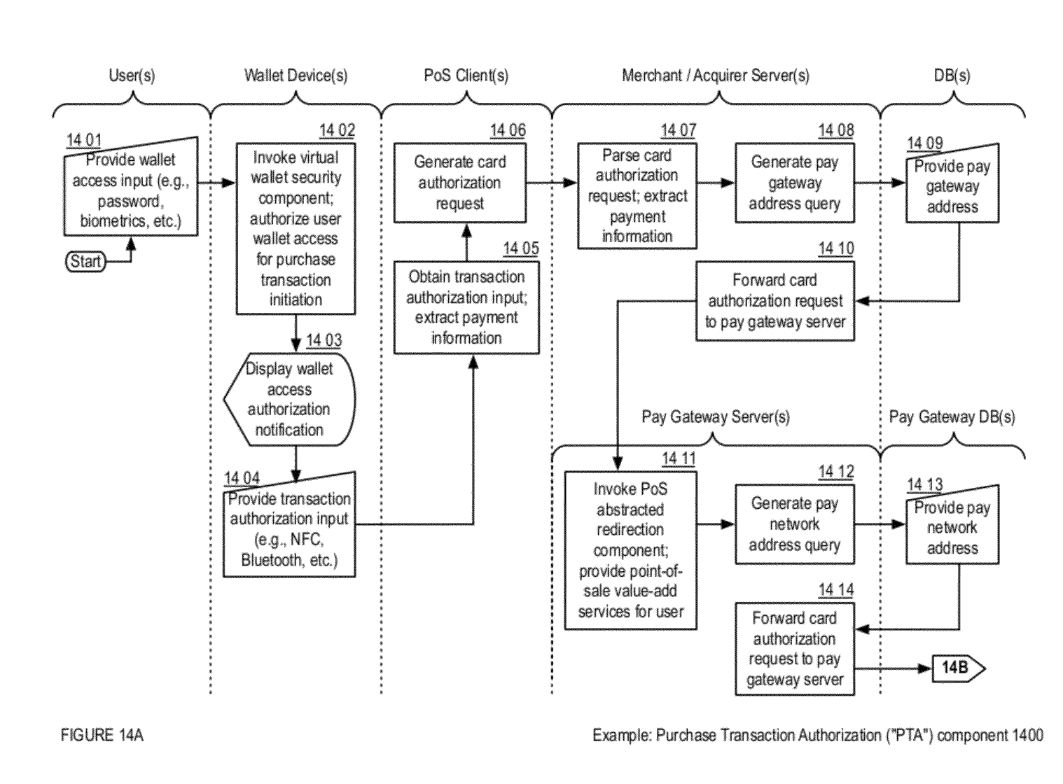

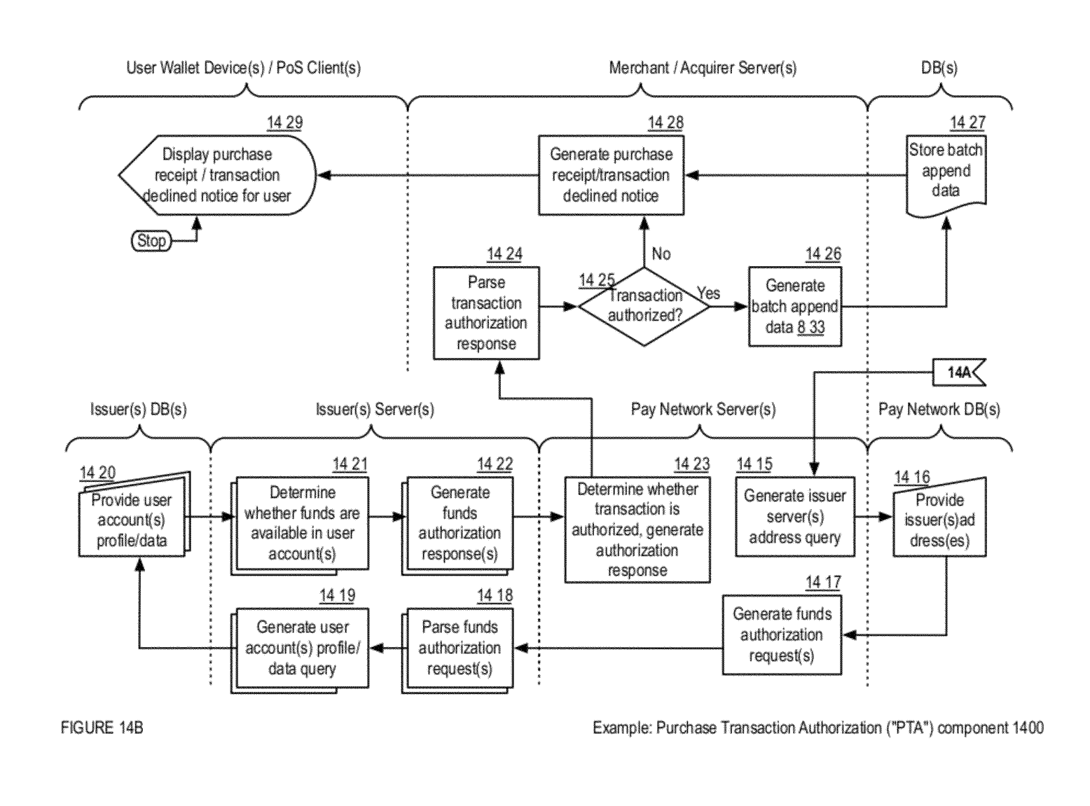

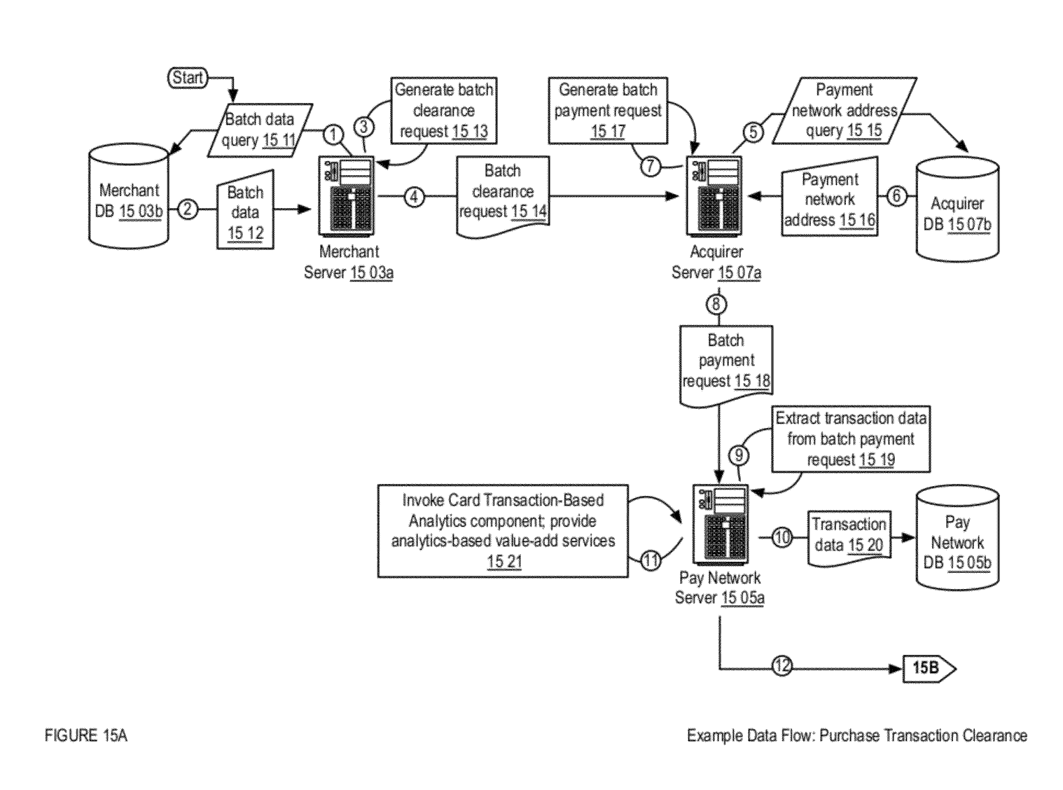

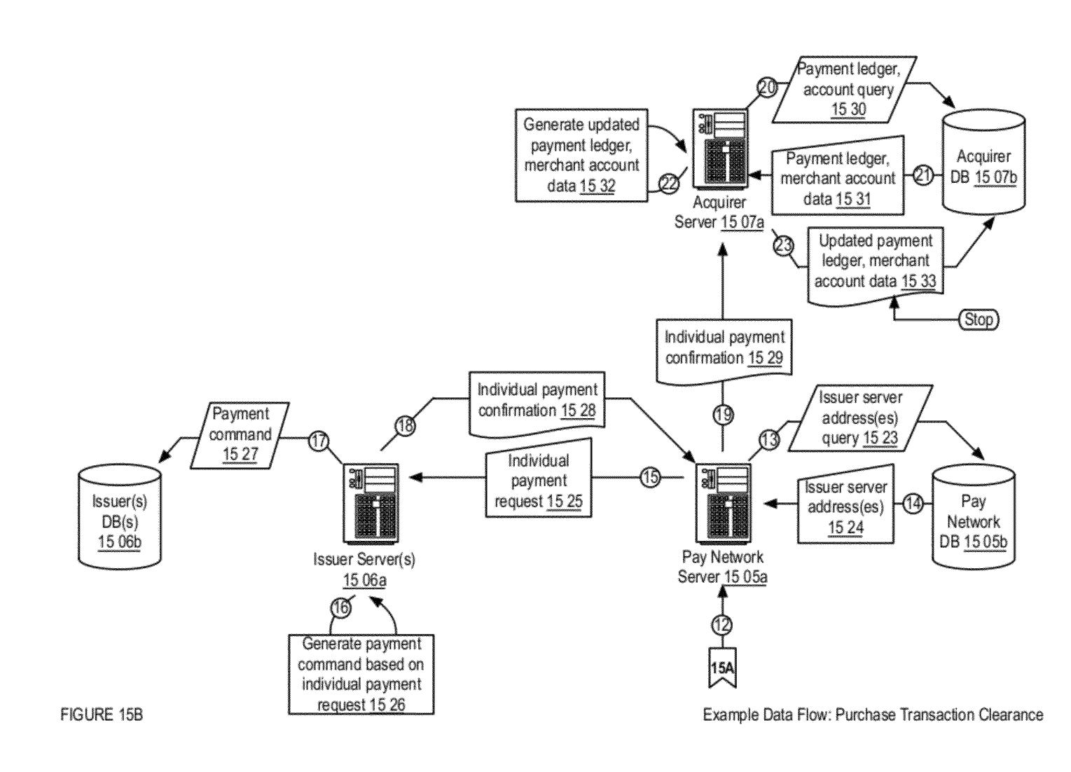

FIG. 7 shows a data flow diagram illustrating an example social merchant consumer bridging procedure in some embodiments of the SocialPay. In some implementations, a social pay server 703a may be triggered to provide services that bridge consumers and merchants over social networks. For example, the social pay server may identify a consumer is need of offers for products or services, and may identify merchants participating in SocialPay that can provide the needed products or services. The social pay server may generate offers on behalf of the participating merchants, and provide the offers to consumers via social networks. In some embodiments, the social pay server may periodically initiate merchant-consumer bridging services for a user. In alternate embodiments, the social pay server may initiate merchant-consumer bridging upon notification of a consumer engaging in a transaction (e.g., a consumer may request checkout for a purchase via the user's virtual wallet; for illustration, see the example User Purchase Checkout (UPC) component 1200 described further below in the discussion with reference to FIGS. 11-12), or when a authorization is requested for a purchase transaction (see the example Purchase Transaction Authorization (PTA) component 1400 described further below in the discussion with reference to FIGS. 13-14). Upon obtaining a trigger to perform merchant-consumer bridging, the social pay server may invoke a transaction data aggregation component, e.g., the TDA component 900 described further below in the discussion with reference to FIG. 9. The social pay server may query a social pay database 703b for offer generation rules, e.g., 713. For example, the social pay server may utilize PHP/SQL commands similar to the other examples described herein. In response, the database may provide the requested offer generation rules, e.g., 714. Using the aggregated transaction data and the offer generation rules, the social pay server may generate merchant(s) offer social post messages for posting to profiles of the user on social networks, e.g., 715. For example, the social pay server may invoke a transaction-based offer generation component, such as the example TBOG 1000 component described further below in the discussion with reference to FIG. 10. The social pay server may provide the generated social post messages 716 to a social network server 704a. The social network server may store the social post messages 717 to a social network database 704b for distribution to the user (e.g., when the user logs onto the social networking service provided by the social network server).

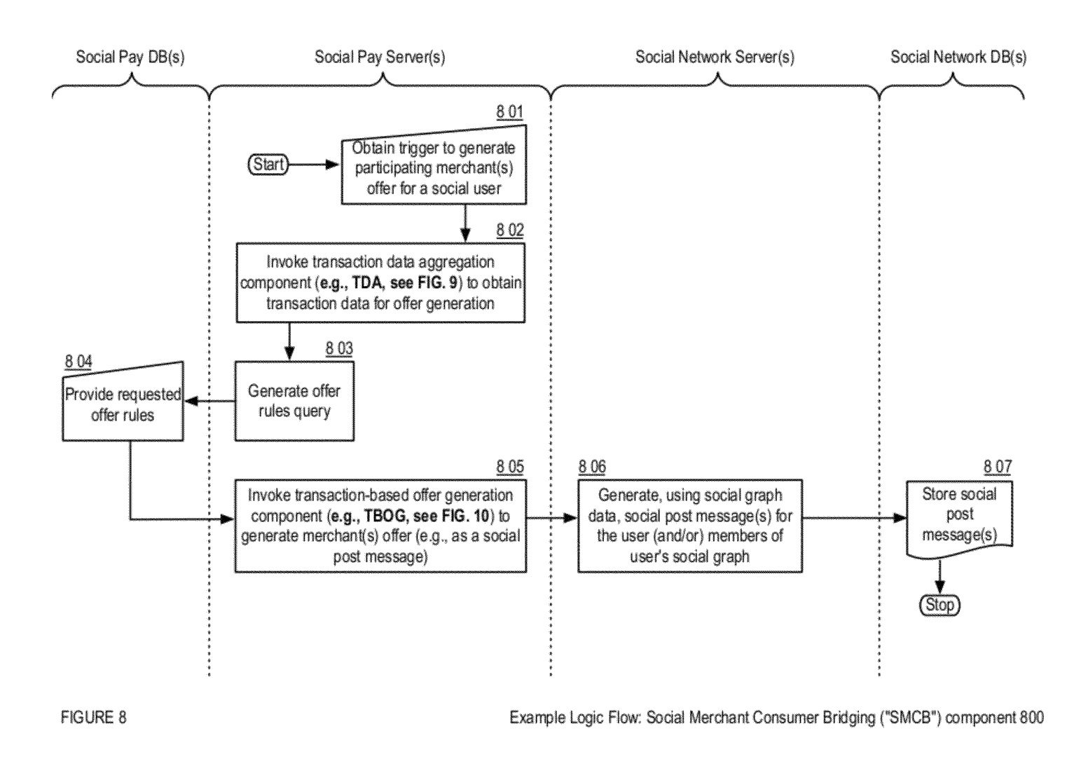

FIG. 8 shows a logic flow diagram illustrating example aspects of social merchant consumer bridging in some embodiments of the SocialPay, e.g., a Social Merchant Consumer Bridging (“SMCB”) component 800. In some implementations, a social pay server may be triggered to provide services that bridge consumers and merchants over social networks, e.g., 801. Upon obtaining a trigger to perform merchant-consumer bridging, the social pay server may invoke a transaction data aggregation component such as the TDA component 900 described further below in the discussion with reference to FIG. 9, e.g., 802. The social pay server may query a social pay database for offer generation rules, e.g., 803. For example, the social pay server may utilize PHP/SQL commands similar to the other examples described herein. In response, the database may provide the requested offer generation rules, e.g., 804. Using the aggregated transaction data and the offer generation rules, the social pay server may generate merchant(s) offer social post messages for posting to profiles of the user on social networks, e.g., 805. For example, the social pay server may invoke a transaction-based offer generation component, such as the example TBOG 1000 component described further below in the discussion with reference to FIG. 10. The social pay server may provide the generated social post messages to a social network server. The social network server may store the social post messages to a social network database for distribution to the user (e.g., when the user logs onto the social networking service provided by the social network server). In some embodiments, the social network server may generate, using social graph data of the user, social post messages for the user and/or members of the user's social graph, e.g., 806, and store the social post message in a social network database for posting to their profiles, e.g., 807.

FIG. 9 shows a logic flow diagram illustrating example aspects of transaction data aggregation in some embodiments of the SocialPay, e.g., a Transaction Data Aggregation (“TDA”) component 900. In some embodiments, a social pay server may obtain a trigger to aggregate transaction data, e.g., 901. For example, the server may be configured to initiate transaction data aggregation on a regular, periodic, or continuous basis. As another example, the server may be configured to initiate transaction data aggregation in real-time on-demand. The social pay server may determine a scope of data aggregation desired to perform the transaction analytics, e.g., 902. For example, the scope of data aggregation may be pre-determined. As another example, the scope of data aggregation may be determined based on a received request for analytics, in real-time. The social pay server may initiate data aggregation based on the determined scope. The social pay server may generate a query for addresses of servers storing transaction data within the determined scope, e.g., 903. The social pay server may query a database for addresses of other servers that may have stored transaction data within the determined scope of the data aggregation. The database may provide, e.g., 904, a list of server addresses in response to the social pay server's query. Based on the list of server addresses, the social pay server may generate transaction data requests, e.g., 905. The social pay server may issue the generated transaction data requests to the other servers. The other servers may obtain and parse the transaction data requests, e.g., 906. Based on parsing the data requests, the other servers may generate transaction data queries, e.g., 907, and provide the transaction data queries to their transaction databases. In response to the transaction data queries, the transaction databases may provide transaction data, e.g., 908, to the other servers. The other servers may return, e.g., 909, the transaction data obtained from the transactions databases to the social pay server making the transaction data requests. The social pay server may generate aggregated transaction data records from the transaction data received from the other servers, e.g., 910, and store the aggregated transaction data in a database, e.g., 911.

FIG. 10 shows a logic flow diagram illustrating example aspects of transaction-based offer generation in some embodiments of the SocialPay, e.g., a Transaction-Based Offer Generation (“TBOG”) component 1000. In some embodiments, a server may generate one or more offers to provide for a SocialPay user on behalf of a SocialPay participating merchant, based on analyzing aggregated transaction data records of the user or like users (e.g., by demographic group, location, members of the user's social graph on a social networking service, common interests, etc.). The server may obtain transactions from a database that are unanalyzed, e.g., 1001, and obtain rules for generating offers, e.g., 1002. For example, the database may store offer generation analytics rules, such as the exemplary illustrative XML-encoded analytics rule provided below:

```
<rule>
    <id>ABCDE44_45</id>
    <name>Demog_search_23</name>
    <inputs>product_type</inputs>
    <operations>
          <1>IF (product_type == ‘gaming’) $search_key += ‘console
    game online videogame’</2>
          <2> result = SEARCH ($offers_db, $search_key)
    </operations>
    <outputs>result</outputs>
</rule>
```

The server may select an unanalyzed data record for processing, e.g., 1003. The server may also select an analytics rule for processing the unanalyzed data record, e.g., 1004. The server may parse the analytics rule, and determine the desired inputs for the rule, e.g., 1005. Based on parsing the analytics rule, the server may parse the data record template, e.g., 1006, and extract the values for the fields required as inputs to the analytics rule. For example, to process the rule in the example above, the server may extract the value of the field ‘product_type’ from the transaction data record. The server may parse the analytics rule, and extract the operations to be performed on the inputs provided for the rule processing, e.g., 1007. Upon determining the operations to be performed, the server may perform the rule-specified operations on the inputs provided for the analytics rule, e.g., 1008. In some embodiments, the rule may provide threshold values. For example, the rule may specify restrictions, such as, but not limited to: that the number of products in the transaction, total value of the transaction, average luxury rating of the products sold in the transaction, etc. may need to cross a threshold in order for the label(s) associated with the rule to be applied to the transaction data record. The server may parse the analytics rule to extract any threshold values required for the rule to apply, e.g., 1009. The server may compare the computed values with the rule thresholds, e.g., 1010. If the rule threshold(s) is crossed, e.g., loll, option “Yes,” the server may generate offers for the user according to the rule and add the generated offers to a data record, e.g., 1012. For example, for the example rule above, the server may perform a search using the additional keywords, and add the returned results to the data record. In some embodiments, the server may apply an analytics rule to an individual product within the transaction, and/or to the transaction as a whole. In some embodiments, the server may process the transaction data record using each rule (see, e.g., 1013). Once all offer analytics rules have been processed for the transaction record, e.g., 1013, option “No,” the server may generate and provide a social post message using offers included in the data record, e.g., 1014. The server may perform such processing for each transaction data record until all transaction data records have been processed (see, e.g., 1015).

FIG. 11 shows a data flow diagram illustrating an example user purchase checkout procedure in some embodiments of the SocialPay. In some embodiments, a user, e.g., nom, may desire to purchase a product, service, offering, and/or the like (“product”), from a merchant via a merchant online site or in the merchant's store. The user may communicate with a merchant/acquirer (“merchant”) server, e.g., 1103a, via a client such as, but not limited to: a personal computer, mobile device, television, point-of-sale terminal, kiosk, ATM, and/or the like (e.g., 1102). For example, the user may provide user input, e.g., checkout input 1111, into the client indicating the user's desire to purchase the product. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. As an example, a user in a merchant store may scan a product barcode of the product via a barcode scanner at a point-of-sale terminal. As another example, the user may select a product from a webpage catalog on the merchant's website, and add the product to a virtual shopping cart on the merchant's website. The user may then indicate the user's desire to checkout the items in the (virtual) shopping cart. For example, the user may activate a user interface element provided by the client to indicate the user's desire to complete the user purchase checkout. The client may generate a checkout request, e.g., 1112, and provide the checkout request, e.g., 1113, to the merchant server. For example, the client may provide a (Secure) Hypertext Transfer Protocol (“HTTP(S)”) POST message including the product details for the merchant server in the form of data formatted according to the eXtensible Markup Language (“XML”). An example listing of a checkout request 1112, substantially in the form of a HTTP(S) POST message including XML-formatted data, is provided below:

```
POST /checkoutrequest.php HTTP/1.1
Host: www.merchant.com
Content-Type: Application/XML
Content-Length: 667
<?XML version = “1.0” encoding = “UTF-8”?>
<checkout_request>
    <checkout_ID>4NFU4RG94</checkout_ID>
    <timestamp>2011-02-22 15:22:43</timestamp>
    <purchase_detail>
          <num_products>5</num_products>
          <product_ID>AE95049324</product_ID>
          <product_ID>MD09808755</product_ID>
          <product_ID>OC12345764</product_ID>
          <product_ID>KE76549043</product_ID>
          <product_ID>SP27674509</product_ID>
    </purchase_detail>
<!--optional parameters-->
    <user_ID>john.q.public@gmail.com</user_ID>
    <PoS_client_detail>
          <client_IP>192.168.23.126</client_IP>
          <client_type>smartphone</client_type>
          <client_model>HTC Hero</client_model>
          <OS>Android 2.2</OS>
          <app_installed_flag>true</app_installed_flag>
    </PoS_client_detail>
</checkout_request>
```

In some embodiments, the merchant server may obtain the checkout request from the client, and extract the checkout detail (e.g., XML data) from the checkout request. For example, the merchant server may utilize a parser such as the example parsers described below in the discussion with reference to FIG. 24. Based on parsing the checkout request 1112, the merchant server may extract product data (e.g., product identifiers), as well as available PoS client data, from the checkout request. In some embodiments, using the product data, the merchant server may query, e.g., 1114, a merchant/acquirer (“merchant”) database, e.g., 1103b, to obtain product data, e.g., 1115, such as product information, product pricing, sales tax, offers, discounts, rewards, and/or other information to process the purchase transaction and/or provide value-added services for the user. For example, the merchant database may be a relational database responsive to Structured Query Language (“SQL”) commands. The merchant server may execute a hypertext preprocessor (“PHP”) script including SQL commands to query a database table (such as FIG. 24, Products 2419l) for product data. An example product data query 1114, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“SocialPay_DB.SQL”); // select database table to
search
//create query
$query = “SELECT product_title product_attributes_list product_price
    tax_info_list related_products_list offers_list discounts_list
    rewards_list merchants_list merchant_availability_list
    FROM ProductsTable WHERE product_ID LIKE ‘%’ $prodID”;
$result = mysql_query($query); // perform the search query
mysql_close(“SocialPay_DB.SQL”); // close database access
?>
```

In some embodiments, in response to obtaining the product data, the merchant server may generate, e.g., 1116, checkout data to provide for the PoS client. In some embodiments, such checkout data, e.g., 1117, may be embodied, in part, in a HyperText Markup Language (“HTML”) page including data for display, such as product detail, product pricing, total pricing, tax information, shipping information, offers, discounts, rewards, value-added service information, etc., and input fields to provide payment information to process the purchase transaction, such as account holder name, account number, billing address, shipping address, tip amount, etc. In some embodiments, the checkout data may be embodied, in part, in a Quick Response (“QR”) code image that the PoS client can display, so that the user may capture the QR code using a user's device to obtain merchant and/or product data for generating a purchase transaction processing request. In some embodiments, a user alert mechanism may be built into the checkout data. For example, the merchant server may embed a URL specific to the transaction into the checkout data. In some embodiments, the alerts URL may further be embedded into optional level 3 data in card authorization requests, such as those discussed further below with reference to FIGS. 13-14. The URL may point to a webpage, data file, executable script, etc., stored on the merchant's server dedicated to the transaction that is the subject of the card authorization request. For example, the object pointed to by the URL may include details on the purchase transaction, e.g., products being purchased, purchase cost, time expiry, status of order processing, and/or the like. Thus, the merchant server may provide to the payment network the details of the transaction by passing the URL of the webpage to the payment network. In some embodiments, the payment network may provide notifications to the user, such as a payment receipt, transaction authorization confirmation message, shipping notification and/or the like. In such messages, the payment network may provide the URL to the user device. The user may navigate to the URL on the user's device to obtain alerts regarding the user's purchase, as well as other information such as offers, coupons, related products, rewards notifications, and/or the like. An example listing of a checkout data 1117, substantially in the form of XML-formatted data, is provided below:

```
<?XML version = “1.0” encoding = “UTF-8”?>
<checkout_data>
    <session_ID>4NFU4RG94</session_ID>
    <timestamp>2011-02-22 15:22:43</timestamp>
    <expiry_lapse>00:00:30</expiry_lapse>
    <transaction_cost>$34.78</transaction_cost>
    <alerts_URL>www.merchant.com/shopcarts.php?sessionID=
    4NFU4RG94</alerts_URL>
    <!--optional data-->
    <user_ID>john.q.public@gmail.com</user_ID>
    <client_details>
        <client_IP>192.168.23.126</client_IP>
        <client_type>smartphone</client_type>
        <client_model>HTC Hero</client_model>
        <OS>Android 2.2</OS>
        <app_installed_flag>true</app_installed_flag>
    </client_details>
    <purchase_details>
        <num_products>1</num_products>
        <product>
            <product_type>book</product_type>
            <product_params>
                <product_title>XML for dummies</product_title>
                <ISBN>938-2-14-168710-0</ISBN>
                <edition>2nd ed.</edition>
                <cover>hardbound</cover>
                <seller>bestbuybooks</seller>
            </product_params>
            <quantity>1</quantity>
        </product>
    </purchase_details>
    <offers_details>
        <num_offers>1</num_offers>
        <product>
            <product_type>book</product_type>
            <product_params>
                <product_title>Here's more XML</product_title>
                <ISBN>922-7-14-165720-1</ISBN>
                <edition>1nd ed.</edition>
                <cover>hardbound</cover>
                <seller>digibooks</seller>
            </product_params>
            <quantity>1</quantity>
        </product>
    </offers_details>
    <secure_element>www.merchant.com/securedyn/0394733/123.png
    </secure_element>
    <merchant_params>
        <merchant_id>3FBCR4INC</merchant_id>
        <merchant_name>Books & Things, Inc.</merchant_name>
        <merchant_auth_key>1NNF484MCP59CHB27365
        </merchant_auth_key>
    </merchant_params>
<checkout_data>
```

Upon obtaining the checkout data, e.g., 1117, the PoS client may render and display, e.g., 1118, the checkout data for the user.

FIG. 12 shows a logic flow diagram illustrating example aspects of a user purchase checkout in some embodiments of the SocialPay, e.g., a User Purchase Checkout (“UPC”) component 1200. In some embodiments, a user may desire to purchase a product, service, offering, and/or the like (“product”), from a merchant via a merchant online site or in the merchant's store. The user may communicate with a merchant/acquirer (“merchant”) server via a PoS client. For example, the user may provide user input, e.g., 1201, into the client indicating the user's desire to purchase the product. The client may generate a checkout request, e.g., 1202, and provide the checkout request to the merchant server. In some embodiments, the merchant server may obtain the checkout request from the client, and extract the checkout detail (e.g., XML data) from the checkout request. For example, the merchant server may utilize a parser such as the example parsers described below in the discussion with reference to FIG. 24. Based on parsing the checkout request, the merchant server may extract product data (e.g., product identifiers), as well as available PoS client data, from the checkout request. In some embodiments, using the product data, the merchant server may query, e.g., 1203, a merchant/acquirer (“merchant”) database to obtain product data, e.g., 1204, such as product information, product pricing, sales tax, offers, discounts, rewards, and/or other information to process the purchase transaction and/or provide value-added services for the user. In some embodiments, in response to obtaining the product data, the merchant server may generate, e.g., 1205, checkout data to provide, e.g., 1206, for the PoS client. Upon obtaining the checkout data, the PoS client may render and display, e.g., 1207, the checkout data for the user.

FIGS. 13A-B show data flow diagrams illustrating an example purchase transaction authorization procedure in some embodiments of the SocialPay. With reference to FIG. 13A, in some embodiments, a user, e.g., 1301a, may wish to utilize a virtual wallet account to purchase a product, service, offering, and/or the like (“product”), from a merchant via a merchant online site or in the merchant's store. The user may utilize a physical card, or a user wallet device, e.g., 1301b, to access the user's virtual wallet account. For example, the user wallet device may be a personal/laptop computer, cellular telephone, smartphone, tablet, eBook reader, netbook, gaming console, and/or the like. The user may provide a wallet access input, e.g., 1311 into the user wallet device. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user.

In some embodiments, upon authenticating the user for access to virtual wallet features, the user wallet device may provide a transaction authorization input, e.g., 1314, to a point-of-sale (“PoS”) client, e.g., 1302. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. For example, the PoS client may obtain, as transaction authorization input 1314, track 1 data from the user's plastic card (e.g., credit card, debit card, prepaid card, charge card, etc.), such as the example track 1 data provided below:

```
%B123456789012345\hat{ }PUBLIC/
J.Q.\hat{ }99011200000000000000**901******?*
(wherein ‘123456789012345’ is the card number of ‘J.Q. Public’ and
  has a CVV number of 901. ‘990112’ is a service code, and
  *** represents decimal digits which change randomly each time the
  card is used.)
```

In embodiments where the user utilizes a user wallet device, the user wallet device may provide payment information to the PoS client, formatted according to a data formatting protocol appropriate to the communication mechanism employed in the communication between the user wallet device and the PoS client. An example listing of transaction authorization input 1314, substantially in the form of XML-formatted data, is provided below:

```
<?XML version = “1.0” encoding = “UTF-8”?>
<transaction_authorization_input>
    <payment_data>
            <account>
                    <charge_priority>1</charge_priority>
                    <charge_ratio>40%</charge_ratio>
                    <account_number>123456789012345</account_number>
                    <account_name>John Q. Public</account_name>
                    <bill_add>987 Green St #456, Chicago, IL 94652</bill_add>
                    <ship_add>987 Green St #456, Chicago, IL 94652</ship_add>
                    <CVV>123</CVV>
            </account>
            <account>
                    <charge_priority>1</charge_priority>
                    <charge_ratio>60%</charge_ratio>
                    <account_number>234567890123456</account_number>
                    <account_name>John Q. Public</account_name>
                    <bill_add>987 Green St #456, Chicago, IL 94652</bill_add>
                    <ship_add>987 Green St #456, Chicago, IL 94652</ship_add>
                    <CVV>173</CVV>
            </account>
            <account>
                    <charge_priority>2</charge_priority>
                    <charge_ratio>100%</charge_ratio>
                    <account_number>345678901234567</account_number>
                    <account_name>John Q. Public</account_name>
                    <bill_add>987 Green St #456, Chicago, IL 94652</bill_add>
                    <ship_add>987 Green St #456, Chicago, IL 94652</ship_add>
                    <CVV>695</CVV>
            </account>
    </payment_data>
    <!--optional data-->
    <timestamp>2011-02-22 15:22:43</timestamp>
    <expiry_lapse>00:00:30</expiry_lapse>
    <secure_key>0445329070598623487956543322</secure_key>
    <alerts_track_flag>TRUE</alerts_track_flag>
    <wallet_device_details>
            <device_IP>192.168.23.126</client_IP>
            <device_type>smartphone</client_type>
            <device_model>HTC Hero</client_model>
            <OS>Android 2.2</OS>
            <wallet_app_installed_flag>true</wallet_app_installed_flag>
    </wallet_device_details>
</transaction_authorization_input>
```

In some embodiments, the PoS client may generate a card authorization request, e.g., 1315, using the obtained transaction authorization input from the user wallet device, and/or product/checkout data (see, e.g., FIG. 11, 1115-1117). An example listing of a card authorization request 1315, substantially in the form of a HTTP(S) POST message including XML-formatted data, is provided below:

```
POST /authorizationrequests.php HTTP/1.1
Host: www.acquirer.com
Content-Type: Application/XML
Content-Length: 1306
<?XML version = “1.0” encoding = “UTF-8”?>
<card_authorization_request>
    <session_ID>4NFU4RG94</order_ID>
    <timestamp>2011-02-22 15:22:43</timestamp>
    <expiry>00:00:30</expiry>
    <alerts_URL>www.merchant.com/shopcarts.php?sessionID=AEBB4356</alerts_URL>
    <!--optional data-->
    <user_ID>john.q.public@gmail.com</user_ID>
    <PoS_details>
            <PoS_IP>192.168.23.126</client_IP>
            <PoS_type>smartphone</client_type>
            <PoS_model>HTC Hero</client_model>
            <OS>Android 2.2</OS>
            <app_installed_flag>true</app_installed_flag>
    </PoS_details>
    <purchase_details>
            <num_products>1</num_products>
            <product>
                    <product_type>book</product_type>
                    <product_params>
                            <product_title>XML for dummies</product_title>
                            <ISBN>938-2-14-168710-0</ISBN>
                            <edition>2nd ed.</edition>
                            <cover>hardbound</cover>
                            <seller>bestbuybooks</seller>
                    </product_params>
                    <quantity>1</quantity>
            </product>
    </purchase_details>
    <merchant_params>
            <merchant_id>3FBCR4INC</merchant_id>
            <merchant_name>Books & Things, Inc.</merchant_name>
            <merchant_auth_key>1NNF484MCP59CHB27365</merchant_auth_key>
    </merchant_params>
    <account_params>
            <account_name>John Q. Public</account_name>
            <account_type>credit</account_type>
            <account_num>123456789012345</account_num>
            <billing_address>123 Green St., Norman, OK 98765</billing_address>
            <phone>123-456-7809</phone>
            <sign>/jqp/</sign>
            <confirm_type>email</confirm_type>
            <contact_info>john.q.public@gmail.com</contact_info>
    </account_params>
    <shipping_info>
            <shipping_adress>same as billing</shipping_address>
            <ship_type>expedited</ship_type>
            <ship_carrier>FedEx</ship_carrier>
            <ship_account>123-45-678</ship_account>
            <tracking_flag>true</tracking_flag>
            <sign_flag>false</sign_flag>
    </shipping_info>
</card_authorization_request>
```

In some embodiments, the card authorization request generated by the user device may include a minimum of information to process the purchase transaction. For example, this may improve the efficiency of communicating the purchase transaction request, and may also advantageously improve the privacy protections provided to the user and/or merchant. For example, in some embodiments, the card authorization request may include at least a session ID for the user's shopping session with the merchant. The session ID may be utilized by any component and/or entity having the appropriate access authority to access a secure site on the merchant server to obtain alerts, reminders, and/or other data about the transaction(s) within that shopping session between the user and the merchant. In some embodiments, the PoS client may provide the generated card authorization request to the merchant server, e.g., 1316. The merchant server may forward the card authorization request to a pay gateway server, e.g., 1304a, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., merchant/acquirer database 1303b, for a network address of the payment gateway server, for example by using a portion of a user payment card number, or a user ID (such as an email address) as a keyword for the database query. For example, the merchant server may issue PHP/SQL commands to query a database table (such as FIG. 24, Pay Gateways 2419h) for a URL of the pay gateway server. An example payment gateway address query 1317, substantially in the form of PHP/SQL commands, is provided below:

```
<?PHP
header(‘Content-Type: text/plain’);
mysql_connect(“254.93.179.112”,$DBserver,$password);
// access database server
mysql_select_db(“SocialPay_DB.SQL”); // select database
table to search
//create query
$query = “SELECT paygate_id paygate_address paygate_URL
    paygate_name FROM PayGatewayTable WHERE
    card_num LIKE ‘%’ $cardnum”;
$result = mysql_query($query); // perform the search query
mysql_close(“SocialPay_DB.SQL”); // close database access
?>
```

In response, the merchant/acquirer database may provide the requested payment gateway address, e.g., 1318. The merchant server may forward the card authorization request to the pay gateway server using the provided address, e.g., 1319. In some embodiments, upon receiving the card authorization request from the merchant server, the pay gateway server may invoke a component to provide one or more services associated with purchase transaction authorization. For example, the pay gateway server may invoke components for fraud prevention, loyalty and/or rewards, and/or other services for which the user-merchant combination is authorized. The pay gateway server may forward the card authorization request to a social pay server, e.g., 1305a, for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., pay gateway database 1304b, for a network address of the payment network server, for example by using a portion of a user payment card number, or a user ID (such as an email address) as a keyword for the database query. For example, the pay gateway server may issue PHP/SQL commands to query a database table (such as FIG. 24, Pay Gateways 2419h) for a URL of the social pay server. An example payment network address query 1321, substantially in the form of PHP/SQL commands, is provided below:

```
<?PHP
header(‘Content-Type: text/plain’);
mysql_connect(“254.93.179.112”,$DBserver,$password);
// access database server
mysql_select_db(“SocialPay_DB.SQL”); // select
database table to search
//create query
$query = “SELECT payNET_id payNET_address payNET_URL
    payNET_name FROM PayGatewayTable WHERE
    card_num LIKE ‘%’ $cardnum”;
$result = mysql_query($query); // perform the search query
mysql_close(“SocialPay_DB.SQL”); // close database access
?>
```

In response, the payment gateway database may provide the requested payment network address, e.g., 1322. The pay gateway server may forward the card authorization request to the social pay server using the provided address, e.g., 1323.

With reference to FIG. 13B, in some embodiments, the social pay server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some embodiments, the social pay server may generate a query, e.g., 1324, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 1306a, of the issuer(s) may maintain details of the user's account(s). In some embodiments, a database, e.g., social pay database 1305b, may store details of the issuer server(s) associated with the issuer(s). In some embodiments, the social pay server may query a database, e.g., social pay database 1305b, for a network address of the issuer(s) server(s), for example by using a portion of a user payment card number, or a user ID (such as an email address) as a keyword for the database query. For example, the merchant server may issue PHP/SQL commands to query a database table (such as FIG. 24, Issuers 2419f) for network address(es) of the issuer(s) server(s). An example issuer server address(es) query 1324, substantially in the form of PHP/SQL commands, is provided below:

```
<?PHP
header(‘Content-Type: text/plain’);
mysql_connect(“254.93.179.112”,$DBserver,$password);
// access database server
mysql_select_db(“SocialPay_DB.SQL”); // select database
table to search
//create query
$query = “SELECT issuer_id issuer_address issuer_URL
    issuer_name FROM IssuersTable WHERE card_num
    LIKE ‘%’ $cardnum”;
$result = mysql_query($query); // perform the search query
mysql_close(“SocialPay_DB.SQL”); // close database access
?>
```

In response to obtaining the issuer server query, e.g., 1324, the social pay database may provide, e.g., 1325, the requested issuer server data to the social pay server. In some embodiments, the social pay server may utilize the issuer server data to generate funds authorization request(s), e.g., 1326, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. An example listing of a funds authorization request 1326, substantially in the form of a HTTP(S) POST message including XML-formatted data, is provided below:

```
POST /fundsauthorizationrequest.php HTTP/1.1
Host: www.issuer.com
Content-Type: Application/XML
Content-Length: 624
<?XML version = “1.0” encoding = “UTF-8”?>
<funds_authorization_request>
    <query_ID>VNEI39FK</query_ID>
    <timestamp>2011-02-22 15:22:44</timestamp>
    <transaction_cost>$22.61</transaction_cost>
    <account_params>
            <account_type>checking</account_type>
            <account_num>1234567890123456</account_num>
    </account_params>
    <!--optional parameters-->
    <purchase_summary>
            <num_products>1</num_products>
            <product>
                    <product_summary>Book - XML for
                    dummies</product_summary>
                    <product_quantity>1</product_quantity?
            </product>
    </purchase_summary>
    <merchant_params>
            <merchant_id>3FBCR4INC</merchant_id>
            <merchant_name>Books & Things, Inc.
            </merchant_name>
            <merchant_auth_key>1NNF484MCP59CHB27365
            </merchant_auth_key>
    </merchant_params>
</funds_authorization_request>
```

In some embodiments, an issuer server may parse the authorization request(s), and based on the request details may query a database, e.g., user profile database 1306b, for data associated with an account linked to the user. For example, the merchant server may issue PHP/SQL commands to query a database table (such as FIG. 24, Accounts 2419d) for user account(s) data. An example user account(s) query 1327, substantially in the form of PHP/SQL commands, is provided below:

```
<?PHP
header(‘Content-Type: text/plain’);
mysql_connect(“254.93.179.112”,$DBserver,$password);
// access database server
mysql_select_db(“SocialPay_DB.SQL”); // select database
table to search
//create query
$query = “SELECT issuer user_id user_name user_balance
    account_type FROM AccountsTable WHERE account_num
    LIKE ‘%’ $accountnum”;
$result = mysql_query($query); // perform the search query
mysql_close(“SocialPay_DB.SQL”); // close database access
?>
```

In some embodiments, on obtaining the user account(s) data, e.g., 1328, the issuer server may determine whether the user can pay for the transaction using funds available in the account, 1329. For example, the issuer server may determine whether the user has a sufficient balance remaining in the account, sufficient credit associated with the account, and/or the like. Based on the determination, the issuer server(s) may provide a funds authorization response, e.g., 1330, to the social pay server. For example, the issuer server(s) may provide a HTTP(S) POST message similar to the examples above. In some embodiments, if at least one issuer server determines that the user cannot pay for the transaction using the funds available in the account, the social pay server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the social pay server may abort the authorization process, and provide an “authorization fail” message to the merchant server, user device and/or client.

In some embodiments, the social pay server may obtain the funds authorization response including a notification of successful authorization, and parse the message to extract authorization details. Upon determining that the user possesses sufficient funds for the transaction, e.g., 1331, the social pay server may invoke a component to provide value-add services for the user.

In some embodiments, the social pay server may generate a transaction data record from the authorization request and/or authorization response, and store the details of the transaction and authorization relating to the transaction in a transactions database. For example, the social pay server may issue PHP/SQL commands to store the data to a database table (such as FIG. 24, Transactions 2419i). An example transaction store command, substantially in the form of PHP/SQL commands, is provided below:

```
<?PHP
header(‘Content-Type: text/plain’);
mysql_connect(“254.92.185.103”,$DBserver,$password);
// access database server
mysql_select(“SocialPay_DB.SQL”); // select database to append
mysql_query(“INSERT INTO TransactionsTable (PurchasesTable
    (timestamp, purchase_summary_list, num_products,
    product_summary, product_quantity, transaction_cost,
    account_params_list, account_name, account_type,
    account_num, billing_addres, zipcode, phone, sign,
    merchant_params_list, merchant_id, merchant_name,
    merchant_auth_key)
VALUES (time( ), $purchase_summary_list, $num_products,
    $product_summary, $product_quantity, $transaction_cost,
    $account_params_list, $account_name, $account_type,
    $account_num, $billing_addres, $zipcode, $phone, $sign,
    $merchant_params_list, $merchant_id, $merchant_name,
    $merchant_auth_key)”);
    // add data to table in database
mysql_close(“SocialPay_DB.SQL”); // close connection to database
?>
```

In some embodiments, the social pay server may forward a transaction authorization response, e.g., 1332, to the user wallet device, PoS client, and/or merchant server. The merchant may obtain the transaction authorization response, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1333, and store the XML data file, e.g., 1334, in a database, e.g., merchant database 404. For example, a batch XML data file may be structured similar to the example XML data structure template provided below:

```
<?XML version = “1.0” encoding = “UTF-8”?>
<merchant_data>
    <merchant_id>3FBCR4INC</merchant_id>
    <merchant_name>Books & Things, Inc.</merchant_name>
    <merchant_auth_key>1NNF484MCP59CHB27365
    </merchant_auth_key>
    <account_number>123456789</account_number>
</merchant_data>
<transaction_data>
    <transaction 1>
            ...
    </transaction 1>
    <transaction 2>
            ...
    </transaction 2>
            .
            .
            .
    <transaction n>
            ...
    </transaction n>
</transaction_data>
```

In some embodiments, the server may also generate a purchase receipt, e.g., 1333, and provide the purchase receipt to the client, e.g., 1335. The client may render and display, e.g., 1336, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 14A-B show logic flow diagrams illustrating example aspects of purchase transaction authorization in some embodiments of the SocialPay, e.g., a Purchase Transaction Authorization (“PTA”) component 1400. With reference to FIG. 14A, in some embodiments, a user may wish to utilize a virtual wallet account to purchase a product, service, offering, and/or the like (“product”), from a merchant via a merchant online site or in the merchant's store. The user may utilize a physical card, or a user wallet device to access the user's virtual wallet account. For example, the user wallet device may be a personal/laptop computer, cellular telephone, smartphone, tablet, eBook reader, netbook, gaming console, and/or the like. The user may provide a wallet access input, e.g., 1401, into the user wallet device. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user, e.g., 1402-1403.

In some embodiments, upon authenticating the user for access to virtual wallet features, the user wallet device may provide a transaction authorization input, e.g., 1404, to a point-of-sale (“PoS”) client. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. In embodiments where the user utilizes a user wallet device, the user wallet device may provide payment information to the PoS client, formatted according to a data formatting protocol appropriate to the communication mechanism employed in the communication between the user wallet device and the PoS client.

In some embodiments, the PoS client may obtain the transaction authorization input, and parse the input to extract payment information from the transaction authorization input, e.g., 1405. For example, the PoS client may utilize a parser, such as the example parsers provided below in the discussion with reference to FIG. 24. The PoS client may generate a card authorization request, e.g., 1406, using the obtained transaction authorization input from the user wallet device, and/or product/checkout data (see, e.g., FIG. 11, 1115-1117).

In some embodiments, the PoS client may provide the generated card authorization request to the merchant server. The merchant server may forward the card authorization request to a pay gateway server, for routing the card authorization 22 request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., 1408, for a network address of the payment gateway server, for example by using a portion of a user payment card number, or a user ID (such as an email address) as a keyword for the database query. In response, the merchant/acquirer database may provide the requested payment gateway address, e.g., 141o. The merchant server may forward the card authorization request to the pay gateway server using the provided address. In some embodiments, upon receiving the card authorization request from the merchant server, the pay gateway server may invoke a component to provide one or more service associated with purchase transaction authorization, e.g., 1411. For example, the pay gateway server may invoke components for fraud prevention (see e.g., VerifyChat, FIG. 3E), loyalty and/or rewards, and/or other services for which the user-merchant combination is authorized.

The pay gateway server may forward the card authorization request to a social pay server for payment processing, e.g., 1414. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., 1412, for a network address of the payment network server, for example by using a portion of a user payment card number, or a user ID (such as an email address) as a keyword for the database query. In response, the payment gateway database may provide the requested payment network address, e.g., 1413. The pay gateway server may forward the card authorization request to the social pay server using the provided address, e.g., 1414.

With reference to FIG. 14B, in some embodiments, the social pay server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer. In some embodiments, the social pay server may generate a query, e.g., 1415, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s) of the issuer(s) may maintain details of the user's account(s). In some embodiments, a database, e.g., a social pay database, may store details of the issuer server(s) associated with the issuer(s). In some embodiments, the social pay server may query a database, e.g., 1415, for a network address of the issuer(s) server(s), for example by using a portion of a user payment card number, or a user ID (such as an email address) as a keyword for the database query.

In response to obtaining the issuer server query, the social pay database may provide, e.g., 1416, the requested issuer server data to the social pay server. In some embodiments, the social pay server may utilize the issuer server data to generate funds authorization request(s), e.g., 1417, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. In some embodiments, an issuer server may parse the authorization request(s), e.g., 1418, and based on the request details may query a database, e.g., 1419, for data associated with an account linked to the user.

In some embodiments, on obtaining the user account(s) data, e.g., 1420, the issuer server may determine whether the user can pay for the transaction using funds available in the account, e.g., 1421. For example, the issuer server may determine whether the user has a sufficient balance remaining in the account, sufficient credit associated with the account, and/or the like. Based on the determination, the issuer server(s) may provide a funds authorization response, e.g., 1422, to the social pay server. In some embodiments, if at least one issuer server determines that the user cannot pay for the transaction using the funds available in the account, the social pay server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the social pay server may abort the authorization process, and provide an “authorization fail” message to the merchant server, user device and/or client.

In some embodiments, the social pay server may obtain the funds authorization response including a notification of successful authorization, and parse the message to extract authorization details. Upon determining that the user possesses sufficient funds for the transaction, e.g., 1423, the social pay server may invoke a component to provide value-add services for the user, e.g., 1423.

In some embodiments, the social pay server may forward a transaction authorization response to the user wallet device, PoS client, and/or merchant server. The merchant may parse, e.g., 1424, the transaction authorization response, and determine from it that the user possesses sufficient funds in the card account to conduct the transaction, e.g., 1425, option “Yes.” The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1426, and store the XML data file, e.g., 1427, in a database. In some embodiments, the server may also generate a purchase receipt, e.g., 1428, and provide the purchase receipt to the client. The client may render and display, e.g., 1429, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 15A-B show data flow diagrams illustrating an example purchase transaction clearance procedure in some embodiments of the SocialPay. With reference to FIG. 15A, in some embodiments, a merchant server, e.g., 1503a, may initiate clearance of a batch of authorized transactions. For example, the merchant server may generate a batch data request, e.g., 1511, and provide the request, to a merchant database, e.g., 1503b. For example, the merchant server may utilize PHP/SQL commands similar to the examples provided above to query a relational database. In response to the batch data request, the database may provide the requested batch data, e.g., 1512. The server may generate a batch clearance request, e.g., 1513, using the batch data obtained from the database, and provide, e.g., 1514, the batch clearance request to an acquirer server, e.g., 1507a. For example, the merchant server may provide a HTTP(S) POST message including XML-formatted batch data in the message body for the acquirer server. The acquirer server may generate, e.g., 1515, a batch payment request using the obtained batch clearance request, and provide, e.g., 1518, the batch payment request to the social pay server, e.g., 1505a. The social pay server may parse the batch payment request, and extract the transaction data for each transaction stored in the batch payment request, e.g., 1519. The social pay server may store the transaction data, e.g., 1520, for each transaction in a database, e.g., social pay database 1505b. In some embodiments, the social pay server may invoke a component to provide value-add analytics services based on analysis of the transactions of the merchant for whom the SocialPay is clearing purchase transactions. For example, the social pay server may invoke a component such as the example card transaction-based analytics component discussed above with reference to FIG. 10. Thus, in some embodiments, the social pay server may provide analytics-based value-added services for the merchant and/or the merchant's users.

With reference to FIG. 15B, in some embodiments, for each extracted 4 transaction, the social pay server may query, e.g., 1523, a database, e.g., social pay database 1505b, for an address of an issuer server. For example, the social pay server may utilize PHP/SQL commands similar to the examples provided above. The social pay server may generate an individual payment request, e.g., 1525, for each transaction for which it has extracted transaction data, and provide the individual payment request, e.g., 1525, to the issuer server, e.g., 1506a. For example, the social pay server may provide an individual payment request to the issuer server(s) as a HTTP(S) POST message including XML-formatted data. An example listing of an individual payment request 1525, substantially in the form of a HTTP(S) POST message including XML-formatted data, is provided below:

```
POST /paymentrequest.php HTTP/1.1
Host: www.issuer.com
Content-Type: Application/XML
Content-Length: 788
<?XML version = “1.0” encoding = “UTF-8”?>
<pay_request>
    <request_ID>CNI4ICNW2</request_ID>
    <timestamp>2011-02-22 17:00:01</timestamp>
    <pay_amount>$34.78</pay_amount>
    <account_params>
            <account_name>John Q. Public</account_name>
            <account_type>credit</account_type>
            <account_num>123456789012345</account_num>
            <billing_address>123 Green St., Norman,
            OK 98765</billing_address>
            <phone>123-456-7809</phone>
            <sign>/jqp/</sign>
    </account_params>
    <merchant_params>
            <merchant_id>3FBCR4INC</merchant_id>
            <merchant_name>Books & Things, Inc.
            </merchant_name>
            <merchant_auth_key>1NNF484MCP59CHB27365
            </merchant_auth_key>
    </merchant_params>
    <purchase_summary>
            <num_products>1</num_products>
            <product>
                    <product_summary>Book - XML for
                    dummies</product_summary>
                    <product_quantity>1</product_quantity?
            </product>
    </purchase_summary>
</pay_request>
```

In some embodiments, the issuer server may generate a payment command, e.g., 1527. For example, the issuer server may issue a command to deduct funds from the user's account (or add a charge to the user's credit card account). The issuer server may issue a payment command, e.g., 1527, to a database storing the user's account information, e.g., user profile database 1506b. The issuer server may provide an individual payment confirmation, e.g., 1528, to the social pay server, which may forward, e.g., 1529, the funds transfer message to the acquirer server. An example listing of an individual payment confirmation 1528, substantially in the form of a HTTP(S) POST message including XML-formatted data, is provided below:

```
POST /clearance.php HTTP/1.1
Host: www.acquirer.com
Content-Type: Application/XML
Content-Length: 206
<?XML version = “1.0” encoding = “UTF-8”?>
<deposit_ack>
    <request_ID>CNI4ICNW2</request_ID>
    <clear_flag>true</clear_flag>
    <timestamp>2011-02-22 17:00:02</timestamp>
    <deposit_amount>$34.78</deposit_amount>
</deposit_ack>
```

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 1530, an acquirer database 1507b for payment ledger and/or merchant account data, e.g., 1531. The acquirer server may utilize payment ledger and/or merchant account data from the acquirer database, along with the individual payment confirmation, to generate updated payment ledger and/or merchant account data, e.g., 1532. The acquirer server may then store, e.g., 1533, the updated payment ledger and/or merchant account data to the acquire database.

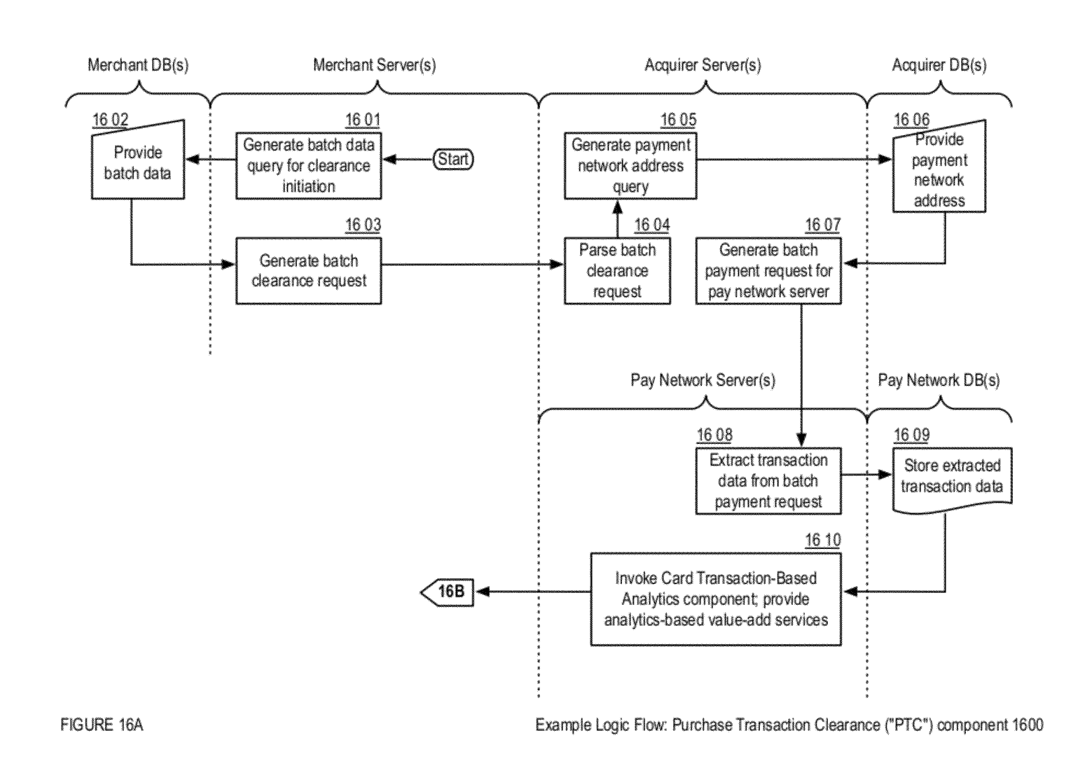

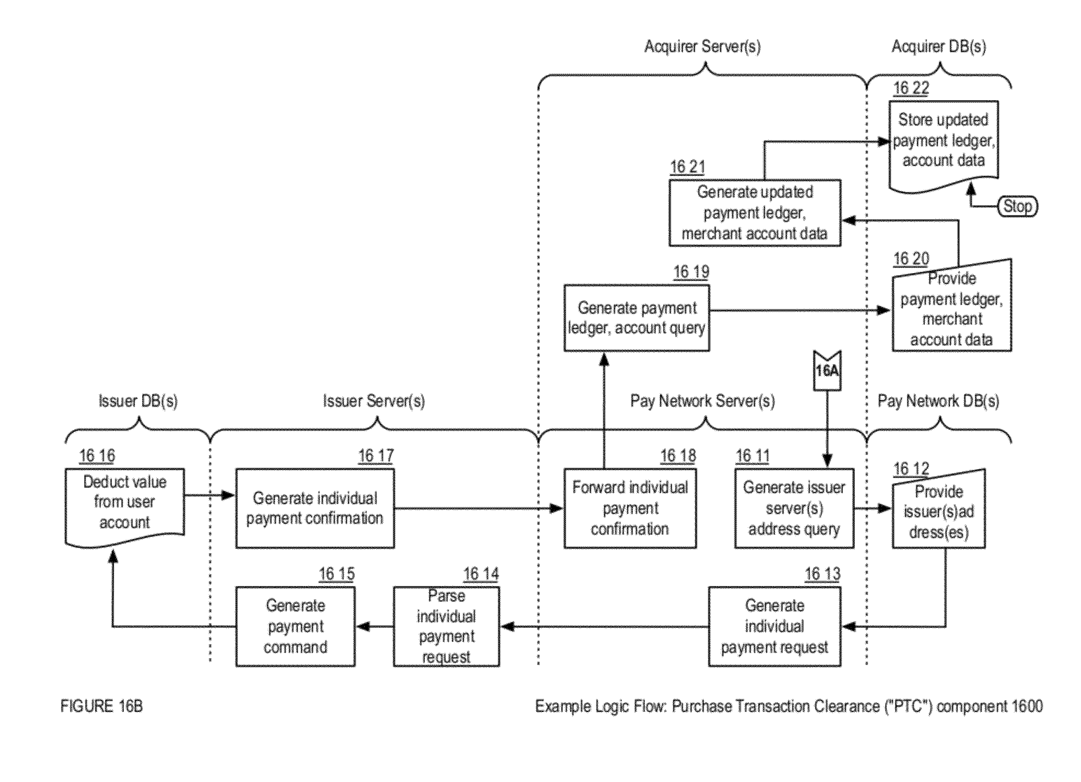

FIGS. 16A-B show logic flow diagrams illustrating example aspects of purchase transaction clearance in some embodiments of the SocialPay, e.g., a Purchase Transaction Clearance (“PTC”) component 1600. With reference to FIG. 16A, in some embodiments, a merchant server may initiate clearance of a batch of authorized transactions. For example, the merchant server may generate a batch data request, e.g., 1601, and provide the request to a merchant database. In response to the batch data request, the database may provide the requested batch data, e.g., 1602. The server may generate a batch clearance request, e.g., 1603, using the batch data obtained from the database, and provide the batch clearance request to an acquirer server. The acquirer server may parse, e.g., 1604, the obtained batch clearance request, and generate, e.g., 1607, a batch payment request using the obtained batch clearance request to provide, the batch payment request to a social pay server. For example, the acquirer server may query, e.g., 1605, an acquirer database for an address of a payment network server, and utilize the obtained address, e.g., 1606, to forward the generated batch payment request to the social pay server.

The social pay server may parse the batch payment request obtained from the acquirer server, and extract the transaction data for each transaction stored in the batch payment request, e.g., 1608. The social pay server may store the transaction data, e.g., 1609, for each transaction in a social pay database. In some embodiments, the social pay server may invoke a component, e.g., 1610, to provide analytics based on the transactions of the merchant for whom purchase transaction are being cleared. For example, the social pay server may invoke a component such as the example card transaction-based analytics component discussed above with reference to FIG. 10.

With reference to FIG. 16B, in some embodiments, for each extracted transaction, the social pay server may query, e.g., 1611, a social pay database for an address of an issuer server. The social pay server may generate an individual payment request, e.g., 1613, for each transaction for which it has extracted transaction data, and provide the individual payment request to the issuer server. In some embodiments, the issuer server may parse the individual payment request, e.g., 1614, and generate a payment command, e.g., 1615, based on the parsed individual payment request. For example, the issuer server may issue a command to deduct funds from the user's account (or add a charge to the user's credit card account). The issuer server may issue a payment command, e.g., 1615, to a database storing the user's account information, e.g., a user profile database. The issuer server may provide an individual payment confirmation, e.g., 1617, to the social pay server, which may forward, e.g., 1618, the individual payment confirmation to the acquirer server.

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 1619, an acquirer database for payment ledger and/or merchant account data, e.g., 1620. The acquirer server may utilize payment ledger and/or merchant account data from the acquirer database, along with the individual payment confirmation, to generate updated payment ledger and/or merchant account data, e.g., 1621. The acquirer server may then store, e.g., 1622, the updated payment ledger and/or merchant account data to the acquire database.

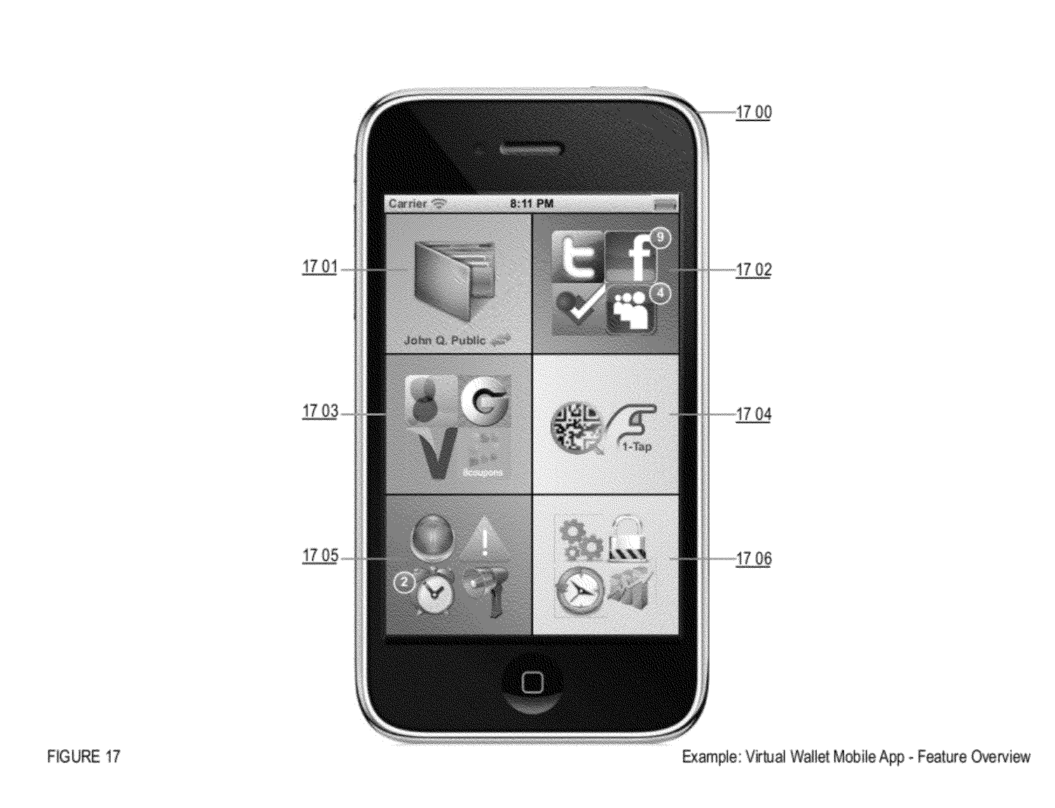

FIG. 17 shows a user interface diagram illustrating an overview of example features of virtual wallet applications in some embodiments of the SocialPay. FIG. 17 shows an illustration of various exemplary features of a virtual wallet mobile application 1700. Some of the features displayed include a wallet 1701, social integration via TWITTER, FACEBOOK, etc., offers and loyalty 1703, snap mobile purchase 1704, alerts 1705 and security, setting and analytics 1796. These features are explored in further detail below.

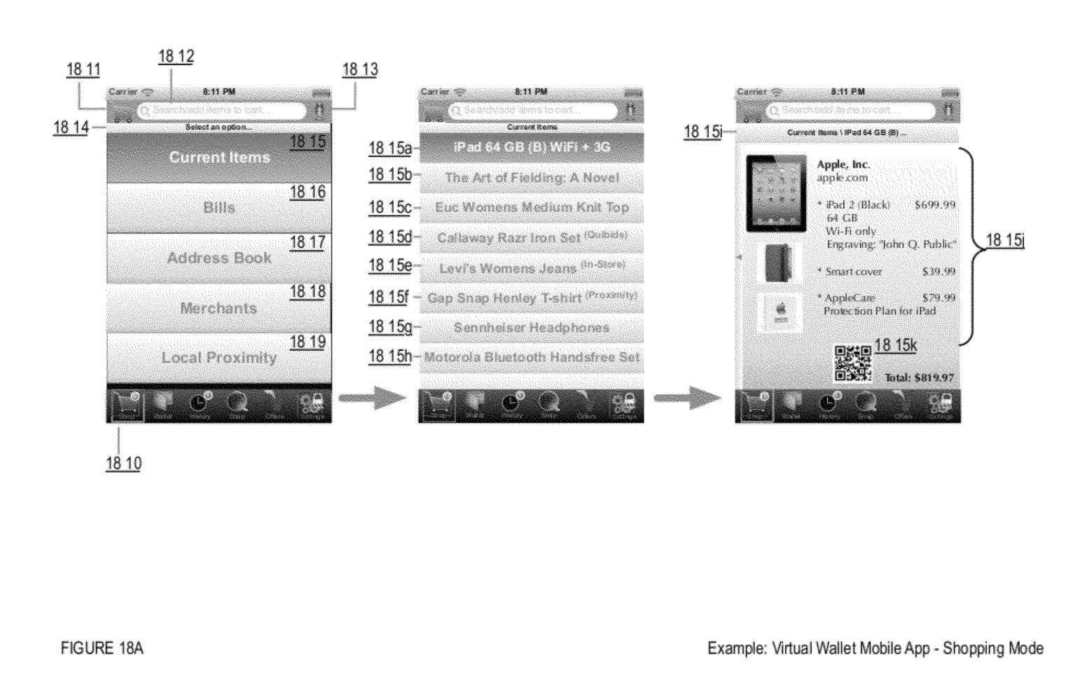

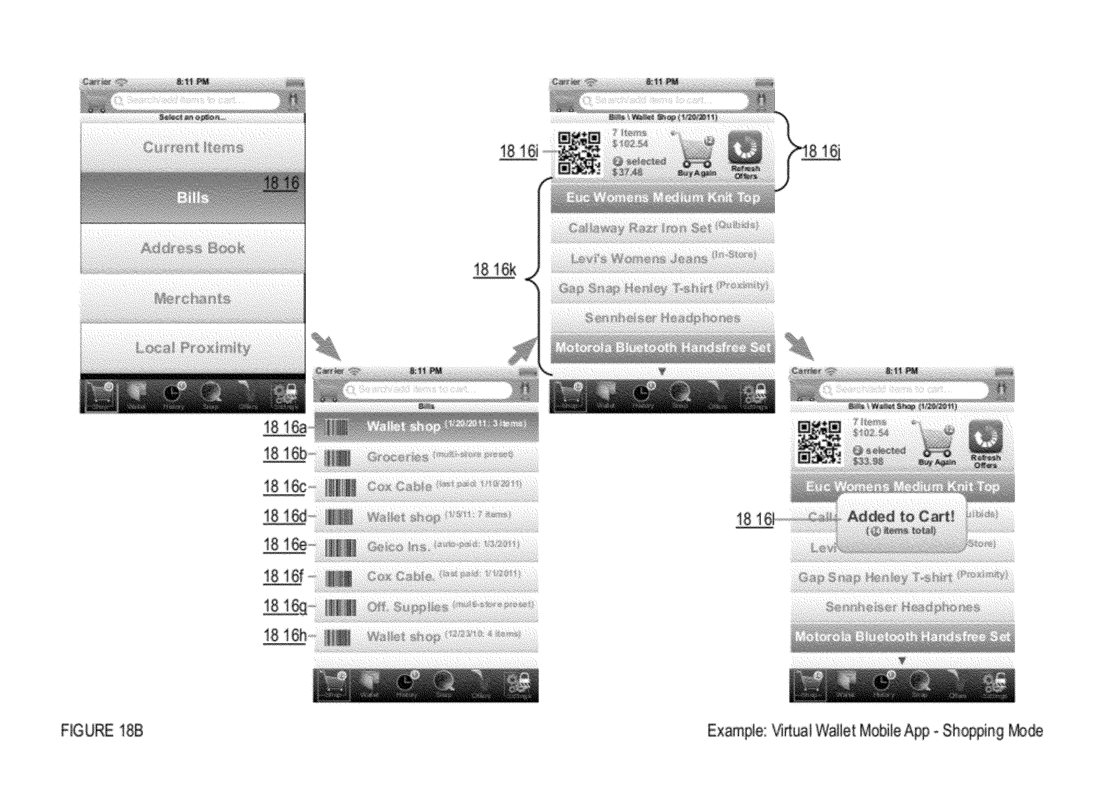

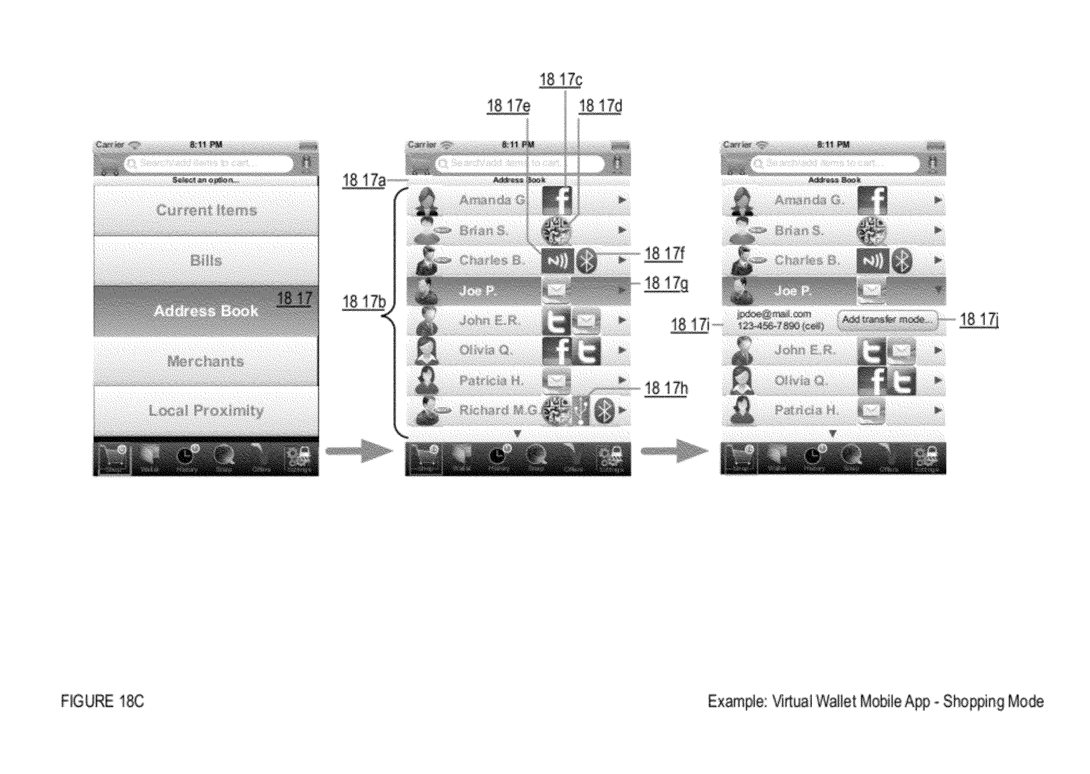

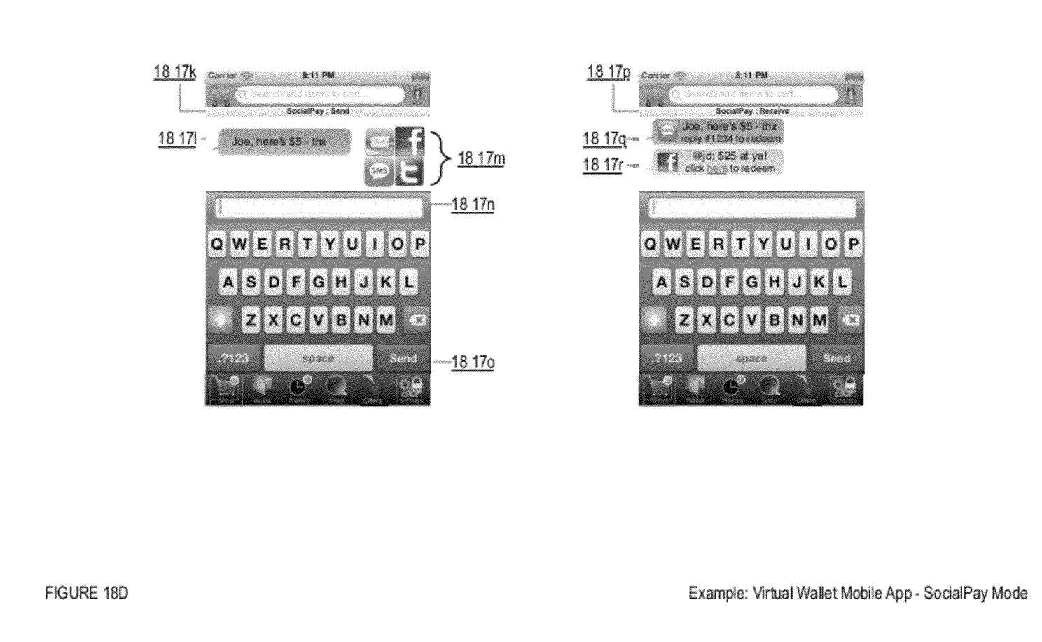

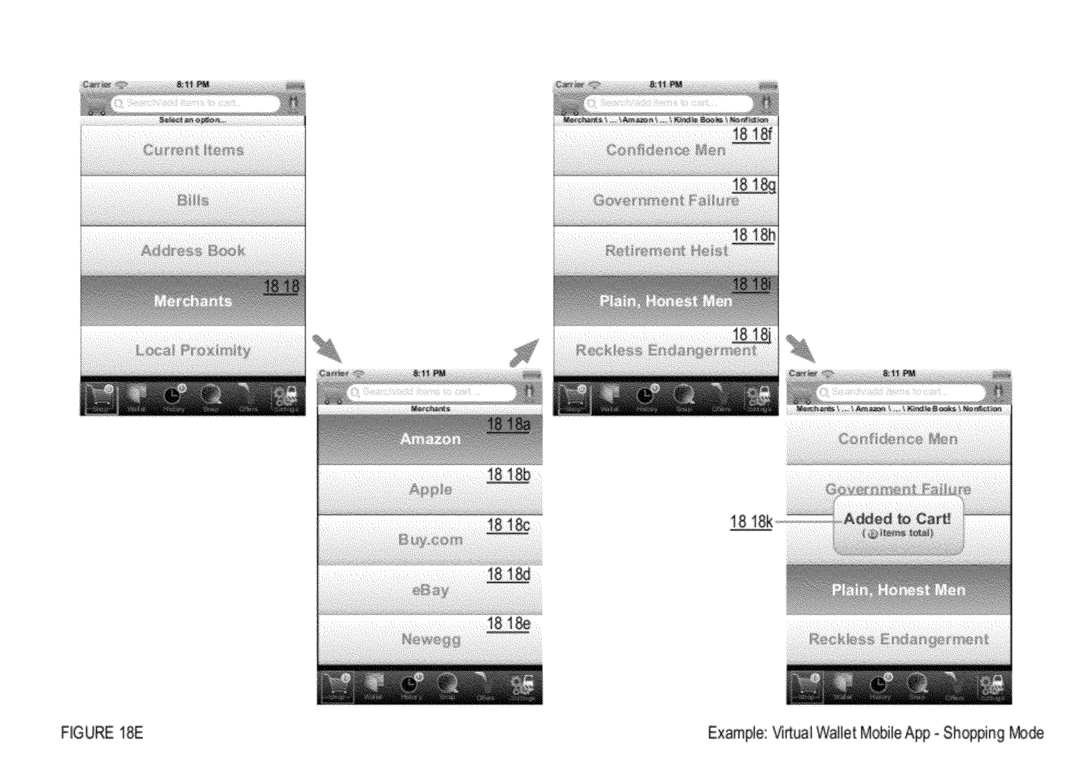

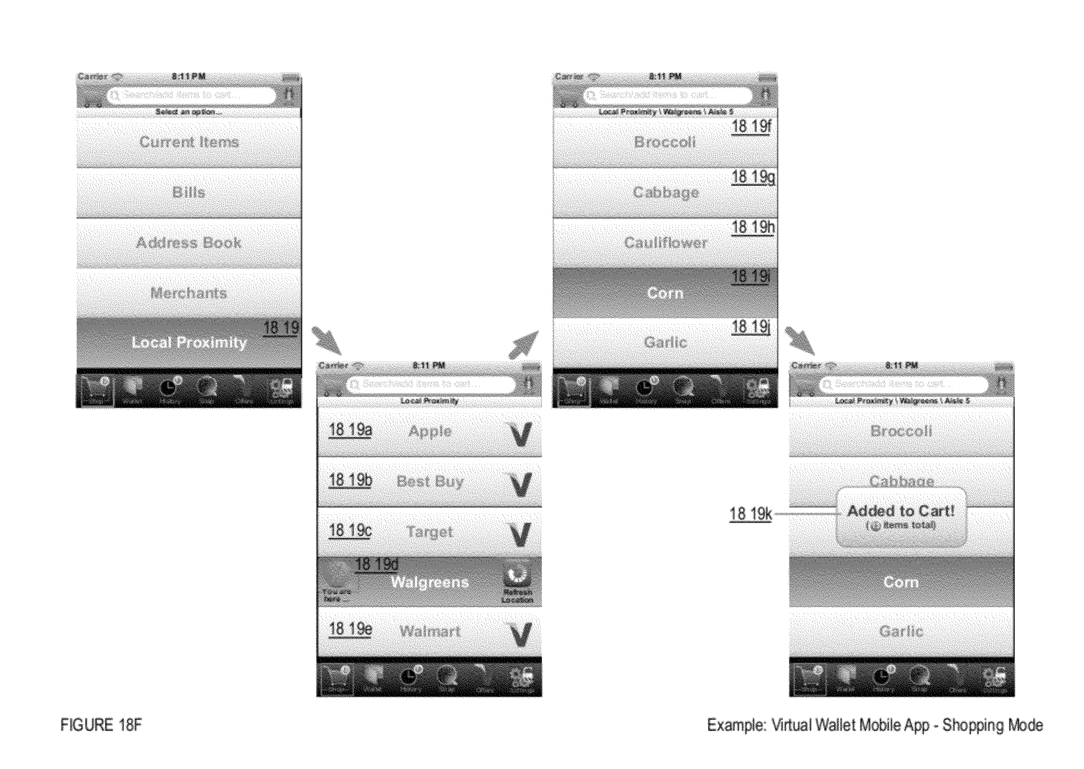

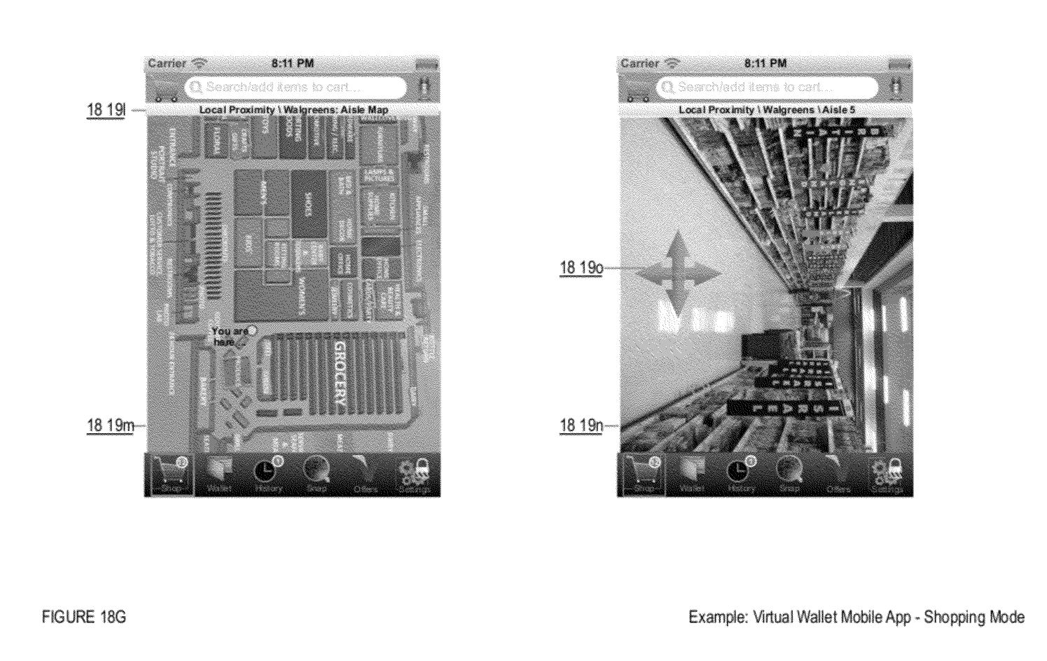

FIGS. 18A-G show user interface diagrams illustrating example features of virtual wallet applications in a shopping mode, in some embodiments of the SocialPay. With reference to FIG. 18A, some embodiments of the virtual wallet mobile app facilitate and greatly enhance the shopping experience of consumers. A variety of shopping modes, as shown in FIG. 18A, may be available for a consumer to peruse. In one implementation, for example, a user may launch the shopping mode by selecting the shop icon 1810 at the bottom of the user interface. A user may type in an item in the search field 1812 to search and/or add an item to a cart 1811. A user may also use a voice activated shopping mode by saying the name or description of an item to be searched and/or added to the cart into a microphone 1813. In a further implementation, a user may also select other shopping options 1814 such as current items 1815, bills 1816, address book 1817, merchants 1818 and local proximity 1819.

In one embodiment, for example, a user may select the option current items 1815, as shown in the left most user interface of FIG. 18A. When the current items 1815 option is selected, the middle user interface may be displayed. As shown, the middle user interface may provide a current list of items 1815a-h in a user's shopping cart 1811. A user may select an item, for example item 1815a, to view product description 1815j of the selected item and/or other items from the same merchant. The price and total payable information may also be displayed, along with a QR code 1815k that captures the information necessary to effect a snap mobile purchase transaction.

With reference to FIG. 18B, in another embodiment, a user may select the bills 1816 option. Upon selecting the bills 1816 option, the user interface may display a list of bills and/or receipts 1816a-h from one or more merchants. Next to each of the bills, additional information such as date of visit, whether items from multiple stores are present, last bill payment date, auto-payment, number of items, and/or the like may be displayed. In one example, the wallet shop bill 1816a dated January 20, 2911 may be selected. The wallet shop bill selection may display a user interface that provides a variety of information regarding the selected bill. For example, the user interface may display a list of items 1816k purchased, <<1816i>>, a total number of items and the corresponding value. For example, 7 items worth $102.54 were in the selected wallet shop bill. A user may now select any of the items and select buy again to add purchase the items. The user may also refresh offers 1816j to clear any invalid offers from last time and/or search for new offers that may be applicable for the current purchase. As shown in FIG. 18B, a user may select two items for repeat purchase. Upon addition, a message 18161 may be displayed to confirm the addition of the two items, which makes the total number of items in the cart 14.

With reference to FIG. 18C, in yet another embodiment, a user may select the address book option 1817 to view the address book 1817a which includes a list of contacts 1817b and make any money transfers or payments. In one embodiment, the address book may identify each contact using their names and available and/or preferred modes of payment. For example, a contact Amanda G. may be paid via social pay (e.g., via FACEBOOK) as indicated by the icon 1817c. In another example, money may be transferred to Brian S. via QR code as indicated by the QR code icon 1817d. In yet another example, Charles B. may accept payment via near field communication 1817e, Bluetooth 1817f and email 1817g. Payment may also be made via USB 1817h (e.g., by physically connecting two mobile devices) as well as other social channels such as TWITTER.

In one implementation, a user may select Joe P. for payment. Joe P., as shown in the user interface, has an email icon 1817g next to his name indicating that Joe P. accepts payment via email. When his name is selected, the user interface may display his contact information such as email, phone, etc. If a user wishes to make a payment to Joe P. by a method other than email, the user may add another transfer mode 1817j to his contact information and make a payment transfer. With reference to FIG. 18D, the user may be provided with a screen 1817k where the user can enter an amount to send Joe, as well as add other text to provide Joe with context for the payment transaction 18171. The user can choose modes (e.g., SMS, email, social networking) via which Joe may be contacted via graphical user interface elements, 1817m. As the user types, the text entered may be provided for review within a GUI element 1817n. When the user has completed entering in the necessary information, the user can press the send button 18170 to send the social message to Joe. If Joe also has a virtual wallet application, Joe may be able to review 1817p social pay message within the app, or directly at the website of the social network (e.g., for Twitter', Facebook®, etc.). Messages may be aggregated from the various social networks and other sources (e.g., SMS, email). The method of redemption appropriate for each messaging mode may be indicated along with the social pay message. In the illustration in FIG. 18D, the SMS 1817q Joe received indicates that Joe can redeem the $5 obtained via SMS by replying to the SMS and entering the hash tag value ‘#1234’. In the same illustration, Joe has also received a message 1817r via Facebook®, which includes a URL link that Joe can activate to initiate redemption of the $25 payment.

With reference to FIG. 18E, in some other embodiments, a user may select merchants 1818 from the list of options in the shopping mode to view a select list of merchants 1818a-e. In one implementation, the merchants in the list may be affiliated to the wallet, or have affinity relationship with the wallet. In another implementation, the merchants may include a list of merchants meeting a user-defined or other criteria. For example, the list may be one that is curated by the user, merchants where the user most frequently shops or spends more than an x amount of sum or shopped for three consecutive months, and/or the like. In one implementation, the user may further select one of the merchants, Amazon 1818a for example. The user may then navigate through the merchant's listings to find items of interest such as 1818f-j. Directly through the wallet and without visiting the merchant site from a separate page, the user may make a selection of an item 1818j from the catalog of Amazon 1818a. As shown in the right most user interface of FIG. 18D, the selected item may then be added to cart. The message 1818k indicates that the selected item has been added to the cart, and updated number of items in the cart is now 13.

With reference to FIG. 18F, in one embodiment, there may be a local proximity option 1819 which may be selected by a user to view a list of merchants that are geographically in close proximity to the user. For example, the list of merchants 1819a-e may be the merchants that are located close to the user. In one implementation, the mobile application may further identify when the is in a store based on the user's location. For example, position icon 1819d may be displayed next to a store (e.g., Walgreens) when the user is in close proximity to the store. In one implementation, the mobile application may refresh its location periodically in case the user moved away from the store (e.g., Walgreens). In a further implementation, the user may navigate the offerings of the selected Walgreens store through the mobile application. For example, the user may navigate, using the mobile application, to items 1819f-j available on aisle 5 of Walgreens. In one implementation, the user may select corn 1819i from his or her mobile application to add to cart 1819k.

With reference to FIG. 18G, in another embodiment, the local proximity option 1819 may include a store map and a real time map features among others. For example, upon selecting the Walgreens store, the user may launch an aisle map 18191 which displays a map 1819m showing the organization of the store and the position of the user (indicated by a yellow circle). In one implementation, the user may easily configure the map to add one or more other users (e.g., user's kids) to share each other's location within the store. In another implementation, the user may have the option to launch a “store view” similar to street views in maps. The store view 1819n may display images/video of the user's surrounding. For example, if the user is about to enter aisle 5, the store view map may show the view of aisle 5. Further the user may manipulate the orientation of the map using the navigation tool 18190 to move the store view forwards, backwards, right, left as well clockwise and counterclockwise rotation

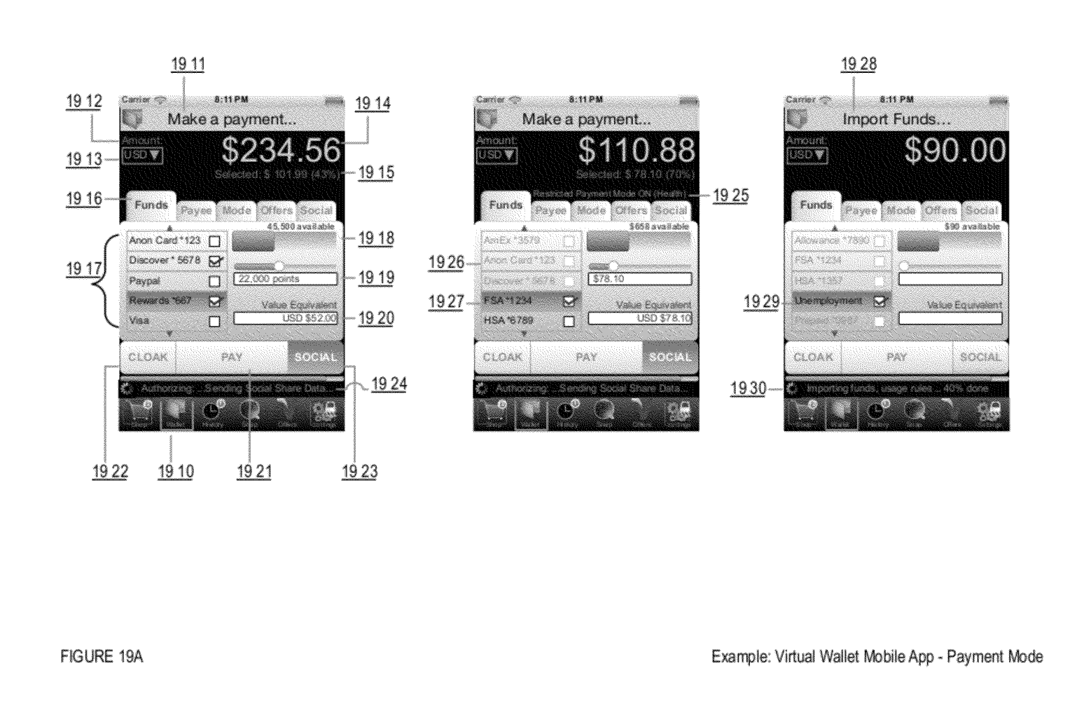

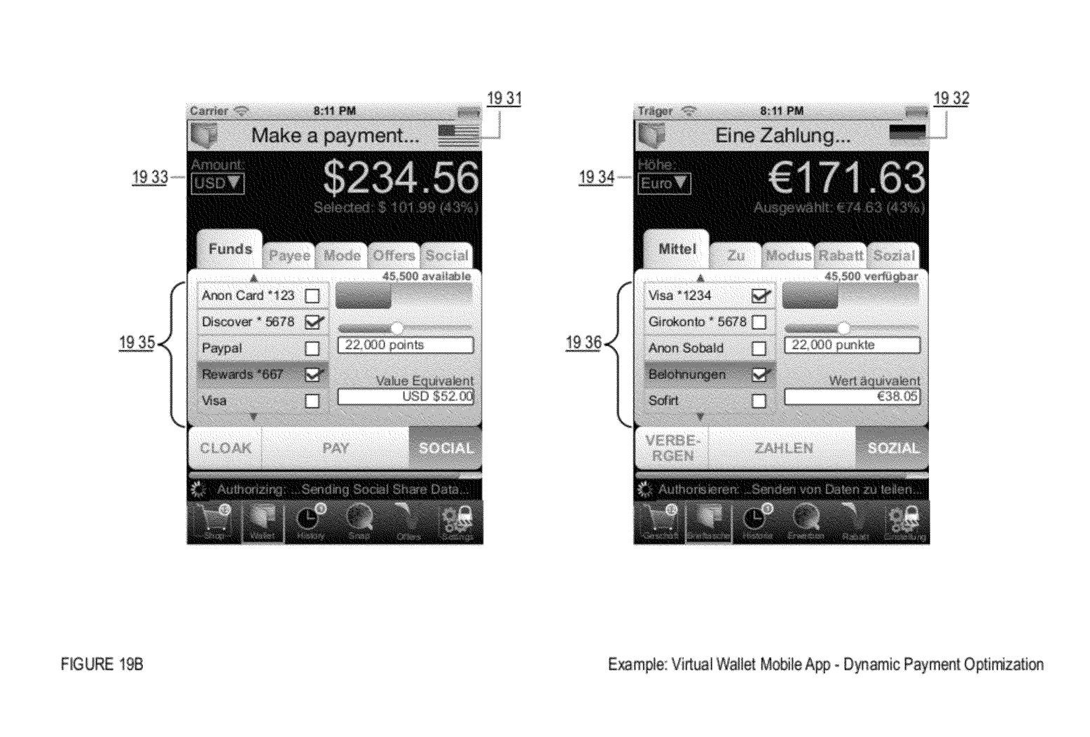

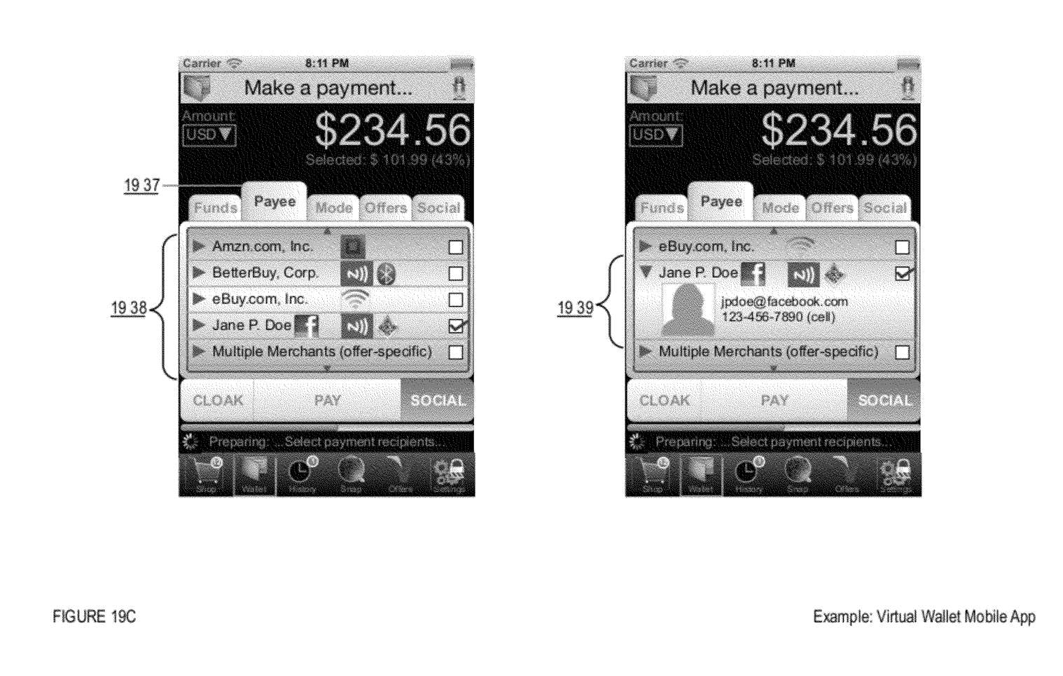

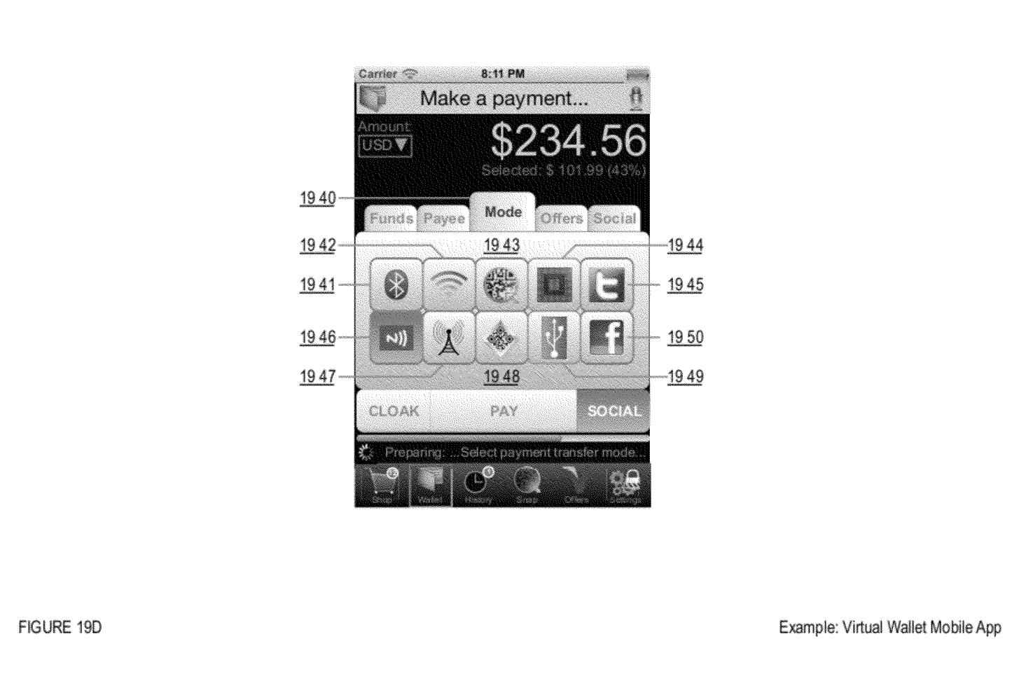

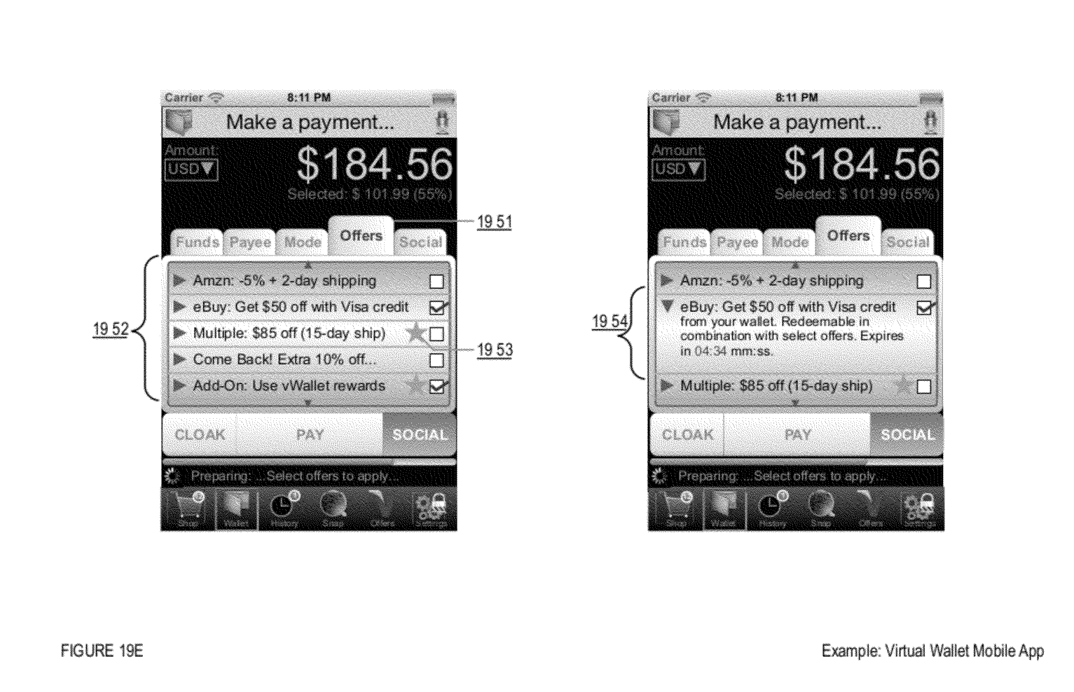

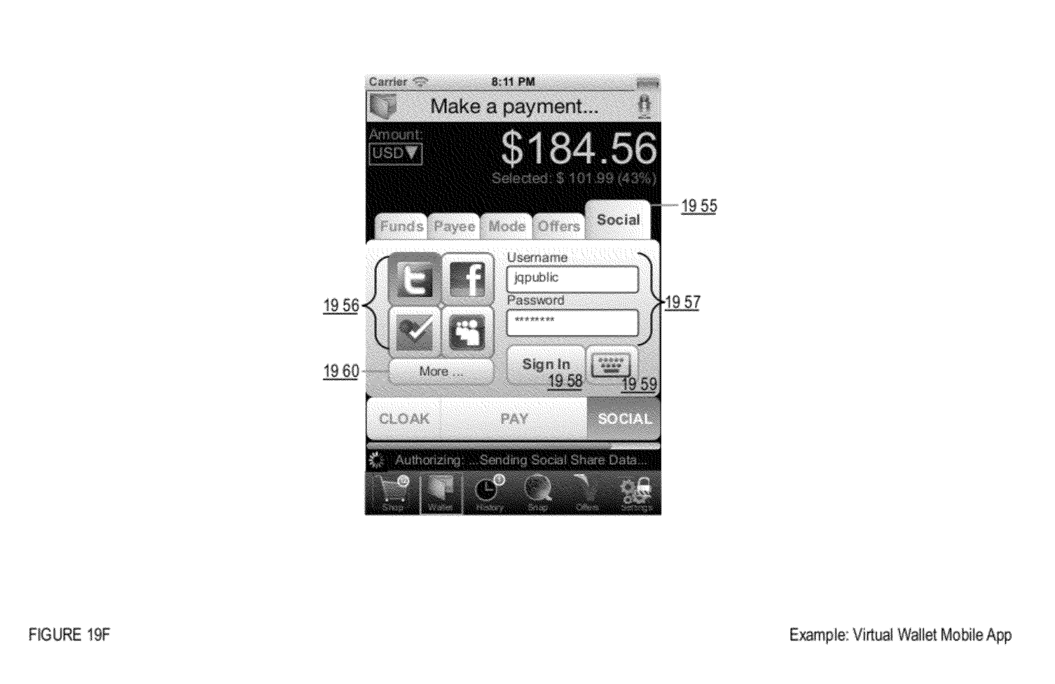

FIGS. 19A-F show user interface diagrams illustrating example features of virtual wallet applications in a payment mode, in some embodiments of the SocialPay. With reference to FIG. 19A, in one embodiment, the wallet mobile application may provide a user with a number of options for paying for a transaction via the wallet mode 1910. In one implementation, an example user interface 1911 for making a payment is shown. The user interface may clearly identify the amount 1912 and the currency 1913 for the transaction. The amount may be the amount payable and the currency may include real currencies such as dollars and euros, as well as virtual currencies such as reward points. The amount of the transaction 1914 may also be prominently displayed on the user interface. The user may select the funds tab 1916 to select one or more forms of payment 1917, which may include various credit, debit, gift, rewards and/or prepaid cards. The user may also have the option of paying, wholly or in part, with reward points. For example, the graphical indicator 1918 on the user interface shows the number of points available, the graphical indicator 1919 shows the number of points to be used towards the amount due 234.56 and the equivalent 1920 of the number of points in a selected currency (USD, for example).

In one implementation, the user may combine funds from multiple sources to pay for the transaction. The amount 1915 displayed on the user interface may 21 provide an indication of the amount of total funds covered so far by the selected forms of payment (e.g., Discover card and rewards points). The user may choose another form of payment or adjust the amount to be debited from one or more forms of payment until the amount 1915 matches the amount payable 1914. Once the amounts to be debited from one or more forms of payment are finalized by the user, payment authorization may begin.

In one implementation, the user may select a secure authorization of the transaction by selecting the cloak button 1922 to effectively cloak or anonymize some (e.g., pre-configured) or all identifying information such that when the user selects pay button 1921, the transaction authorization is conducted in a secure and anonymous manner. In another implementation, the user may select the pay button 1921 which may use standard authorization techniques for transaction processing. In yet another implementation, when the user selects the social button 1923, a message regarding the transaction may be communicated to one of more social networks (set up by the user) which may post or announce the purchase transaction in a social forum such as a wall post or a tweet. In one implementation, the user may select a social payment processing option 1923. The indicator 1924 may show the authorizing and sending social share data in progress.

In another implementation, a restricted payment mode 1925 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 1926 under the funds tab to select specialized accounts such as a flexible spending account (FSA) 1927, health savings account (HAS), and/or the like and amounts to be debited to the selected accounts. In one implementation, such restricted payment mode 1925 processing may disable social sharing of purchase information.

In one embodiment, the wallet mobile application may facilitate importing of funds via the import funds user interface 1928. For example, a user who is unemployed may obtain unemployment benefit fund 1929 via the wallet mobile application. In one implementation, the entity providing the funds may also configure rules for using the fund as shown by the processing indicator message 1930. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

With reference to FIG. 19B, in one embodiment, the wallet mobile application may facilitate dynamic payment optimization based on factors such as user location, preferences and currency value preferences among others. For example, when a user is in the United States, the country indicator 1931 may display a flag of the United States and may set the currency 1933 to the United States. In a further implementation, the wallet mobile application may automatically rearrange the order in which the forms of payments 1935 are listed to reflect the popularity or acceptability of various forms of payment. In one implementation, the arrangement may reflect the user's preference, which may not be changed by the wallet mobile application.

Similarly, when a German user operates a wallet in Germany, the mobile wallet application user interface may be dynamically updated to reflect the country of operation 1932 and the currency 1934. In a further implementation, the wallet application may rearrange the order in which different forms of payment 1936 are listed based on their acceptance level in that country. Of course, the order of these forms of payments may be modified by the user to suit his or her own preferences.

With reference to FIG. 19C, in one embodiment, the payee tab 1937 in the wallet mobile application user interface may facilitate user selection of one or more payees receiving the funds selected in the funds tab. In one implementation, the user interface may show a list of all payees 1938 with whom the user has previously transacted or available to transact. The user may then select one or more payees. The payees 1938 may include larger merchants such as Amazon.com Inc., and individuals such as Jane P. Doe. Next to each payee name, a list of accepted payment modes for the payee may be displayed. In one implementation, the user may select the payee Jane P. Doe 1939 for receiving payment. Upon selection, the user interface may display additional identifying information relating to the payee.

With reference to FIG. 19D, in one embodiment, the mode tab 1940 may facilitate selection of a payment mode accepted by the payee. A number of payment modes may be available for selection. Example modes include, blue tooth 1941, wireless 1942, snap mobile by user-obtained QR code 1943, secure chip 1944, TWITTER 1945, near-field communication (NFC) 1946, cellular 1947, snap mobile by user-provided QR code 1948, USB 1949 and FACEBOOK 1950, among others. In one implementation, only the payment modes that are accepted by the payee may be selectable by the user. Other non-accepted payment modes may be disabled.

With reference to FIG. 19E, in one embodiment, the offers tab 1951 may provide real-time offers that are relevant to items in a user's cart for selection by the user. The user may select one or more offers from the list of applicable offers 1952 for redemption. In one implementation, some offers may be combined, while others may not. When the user selects an offer that may not be combined with another offer, the unselected offers may be disabled. In a further implementation, offers that are recommended by the wallet application's recommendation engine may be identified by an indicator such as the one shown by 1953. In a further implementation, the user may read the details of the offer by expanding the offer row as shown by 1954 in the user interface.

With reference to FIG. 19F, in one embodiment, the social tab 1955 may facilitate integration of the wallet application with social channels 1956. In one implementation, a user may select one or more social channels 1956 and may sign in to the selected social channel from the wallet application by providing to the wallet application the social channel user name and password 1957 and signing in 1958. The user may then use the social button 1959 to send or receive money through the integrated social channels. In a further implementation, the user may send social share data such as purchase information or links through integrated social channels. In another embodiment, the user supplied login credentials may allow SocialPay to engage in interception parsing (e.g., as described in paragraphs [0045], [0052] and [0064]).

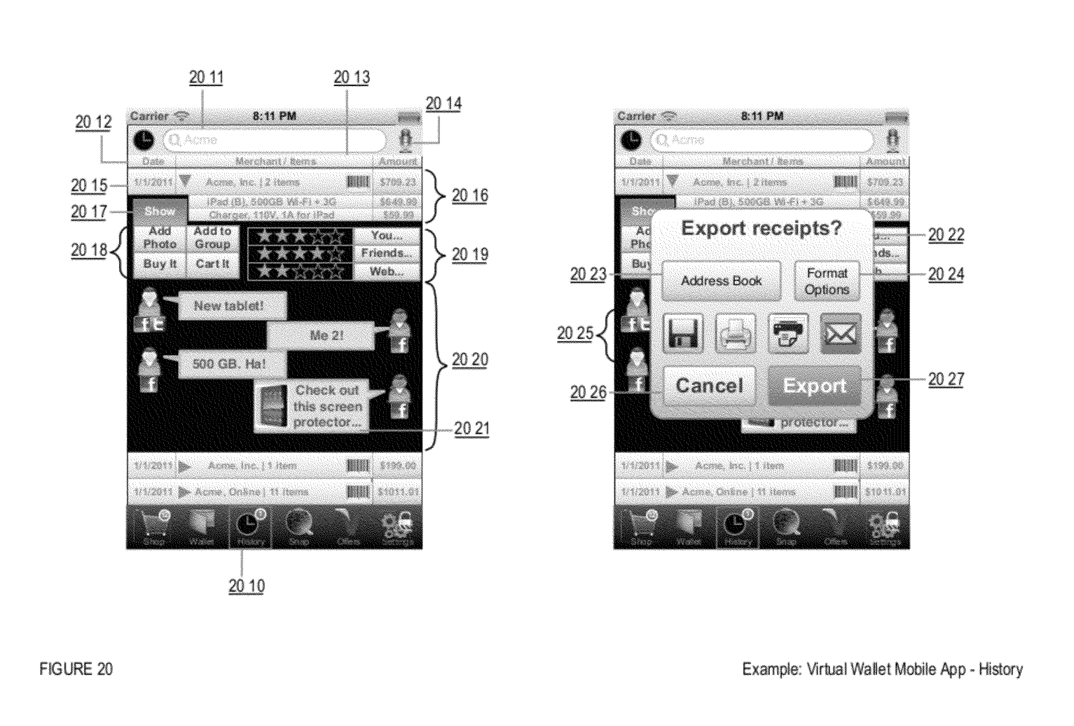

FIG. 20 shows a user interface diagram illustrating example features of virtual wallet applications, in a history mode, in some embodiments of the SocialPay. In one embodiment, a user may select the history mode 2010 to view a history of prior purchases and perform various actions on those prior purchases. For example, a user may enter a merchant identifying information such as name, product, MCC, and/or the like in the search bar 2011. In another implementation, the user may use voice activated search feature by clicking on the microphone icon 2014. The wallet application may query the storage areas in the mobile device or elsewhere (e.g., one or more databases and/or tables remote from the mobile device) for transactions matching the search keywords. The user interface may then display the results of the query such as transaction 2015. The user interface may also identify the date 2012 of the transaction, the merchants and items 2013 relating to the transaction, a barcode of the receipt confirming that a transaction was made, the amount of the transaction and any other relevant information.

In one implementation, the user may select a transaction, for example transaction 2015, to view the details of the transaction. For example, the user may view the details of the items associated with the transaction and the amounts 2016 of each item. In a further implementation, the user may select the show option 2017 to view actions 2018 that the user may take in regards to the transaction or the items in the transaction. For example, the user may add a photo to the transaction (e.g., a picture of the user and the iPad the user bought). In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 2019 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 2020 shows FACEBOOK message exchanges between two users. In one implementation, a user may share a link via a message 2021. Selection of such a message having embedded link to a product may allow the user to view a description of the product and/or purchase the product directly from the history mode.

In one embodiment, the history mode may also include facilities for exporting receipts. The export receipts pop up 2022 may provide a number of options for exporting the receipts of transactions in the history. For example, a user may use one or more of the options 2025 which include save (to local mobile memory, to server, to a cloud account, and/or the like), print to a printer, fax, email, and/or the like. The user may utilize his or her address book 2023 to look up email or fax number for exporting. The user may also specify format options 2024 for exporting receipts. Example format options may include, without limitation, text files (.doc, .txt, .rtf, iif, etc.), spreadsheet (.csv, .xls, etc.), image files (.jpg, .tff, .png, etc.), portable document format (.pdf), postscript (.ps), and/or the like. The user may then click or tap the export button 2027 to initiate export of receipts.

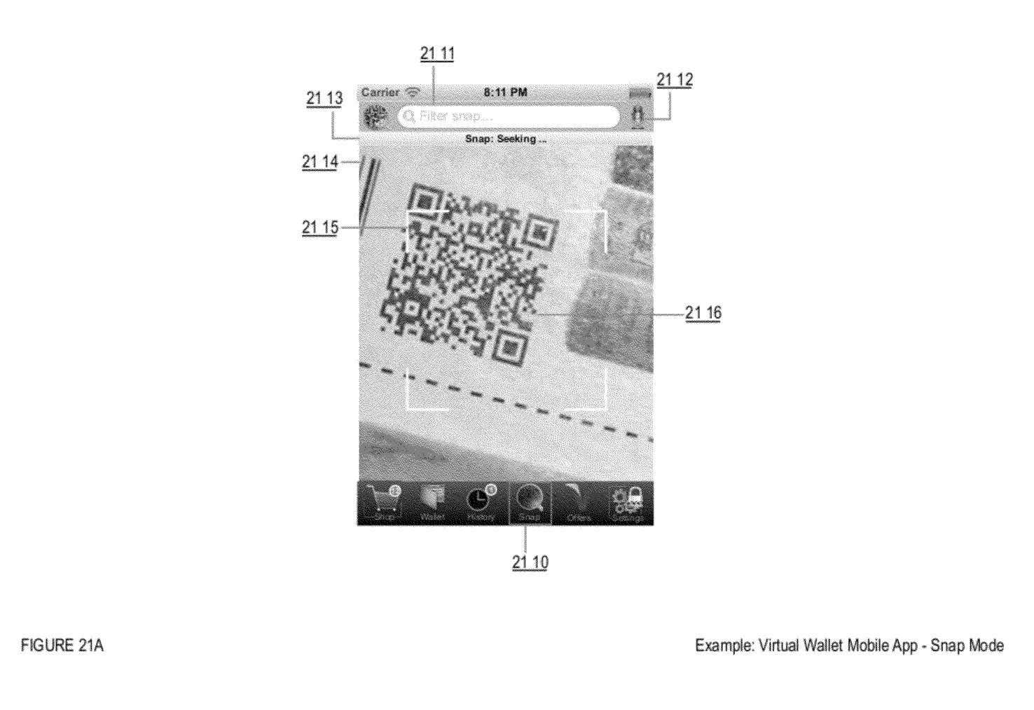

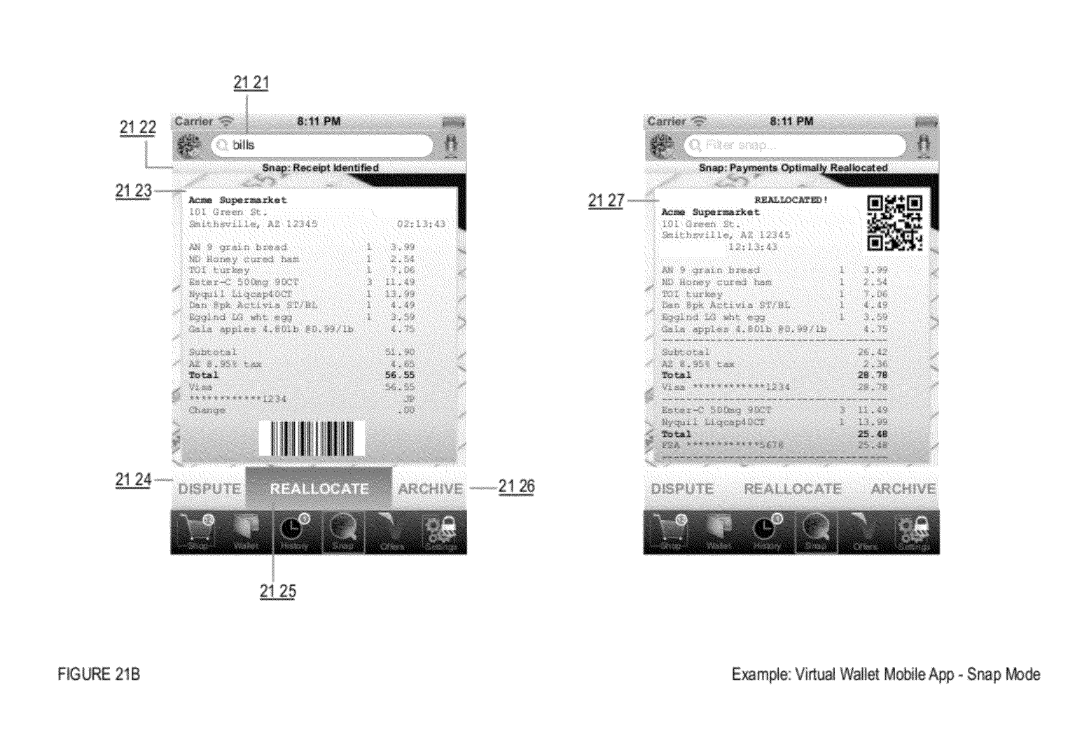

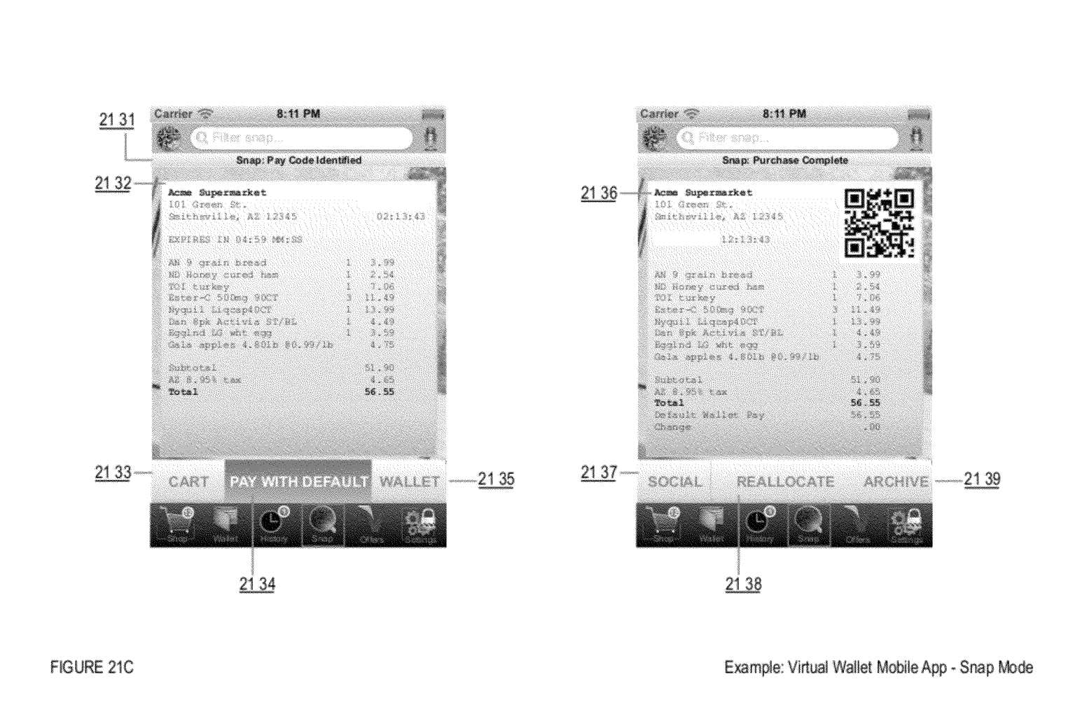

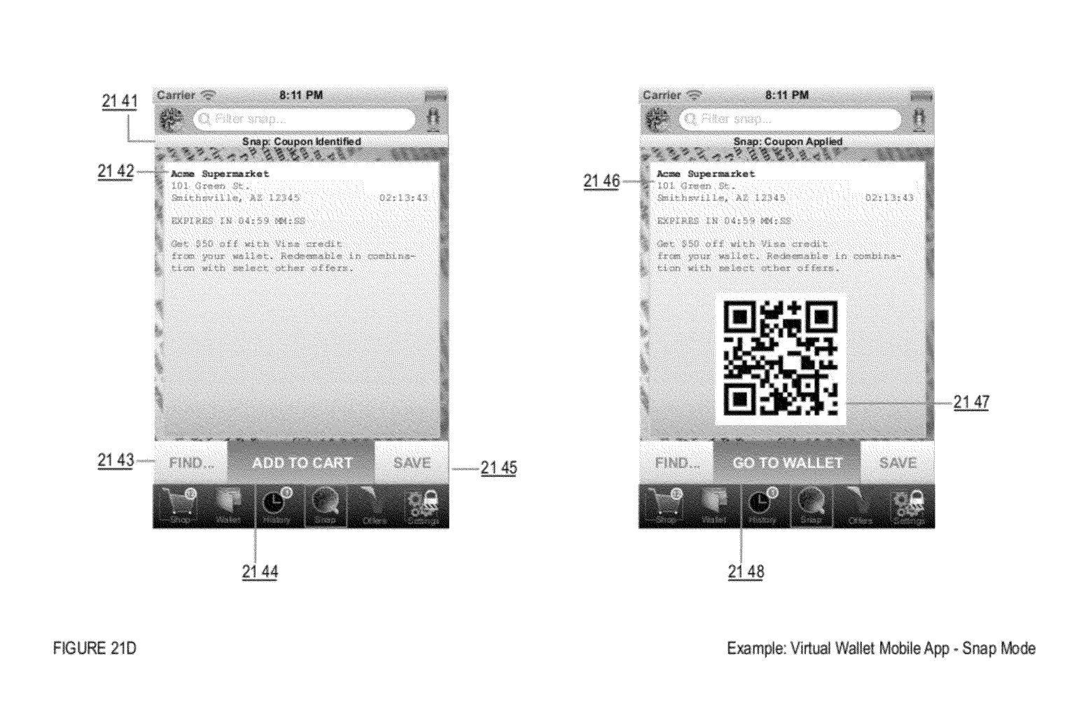

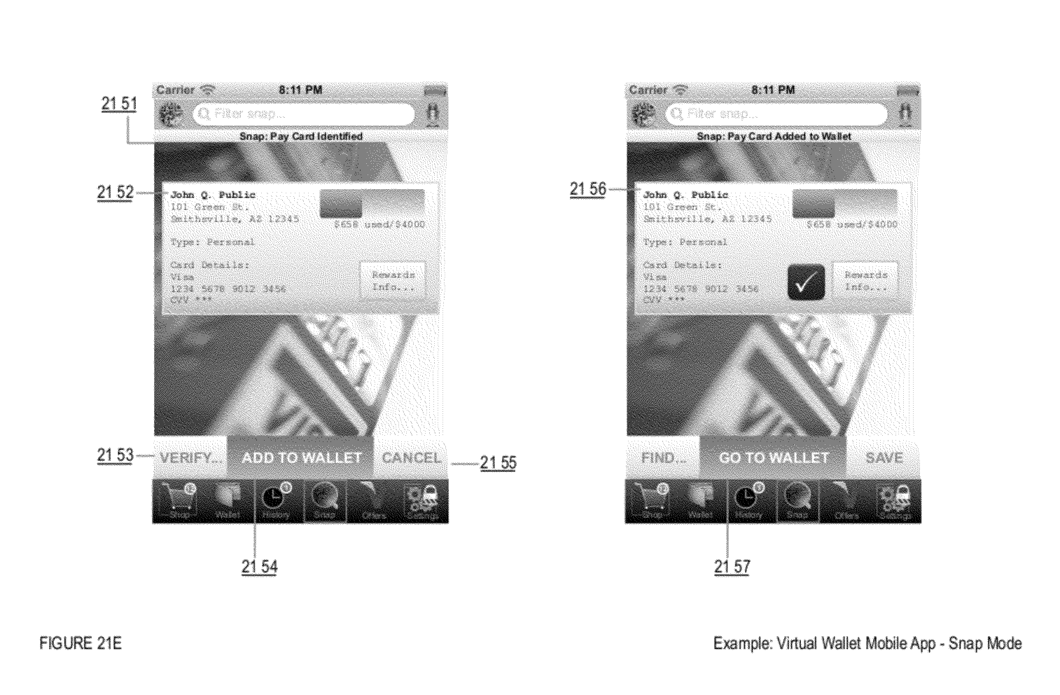

FIGS. 21A-E show user interface diagrams illustrating example features of virtual wallet applications in a snap mode, in some embodiments of the SocialPay. With reference to FIG. 21A, in one embodiment, a user may select the snap mode 2110 to access its snap features. The snap mode may handle any machine-readable representation of data. Examples of such data may include linear and D bar codes such as UPC code and QR codes. These codes may be found on receipts, product packaging, and/or the like. The snap mode may also process and handle pictures of receipts, products, offers, credit cards or other payment devices, and/or the like. An example user interface in snap mode is shown in FIG. 21A. A user may use his or her mobile phone to take a picture of a QR code 2115 and/or a barcode 2114. In one implementation, the bar 1213 and snap frame 2115 may assist the user in snapping codes properly. For example, the snap frame 2115, as shown, does not capture the entirety of the code 2116. As such, the code captured in this view may not be resolvable as information in the code may be incomplete. This is indicated by the message on the bar 2113 that indicates that the snap mode is still seeking the code. When the code 2116 is completely framed by the snap frame 2115, the bar message may be updated to, for example, “snap found.” Upon finding the code, in one implementation, the user may initiate code capture using the mobile device camera. In another implementation, the snap mode may automatically snap the code using the mobile device camera.

With reference to FIG. 21B, in one embodiment, the snap mode may facilitate payment reallocation post transaction. For example, a user may buy grocery and prescription items from a retailer Acme Supermarket. The user may, inadvertently or for ease of checkout for example, use his or her Visa card to pay for both grocery and prescription items. However, the user may have an FSA account that could be used to pay for prescription items, and which would provide the user tax benefits. In such a situation, the user may use the snap mode to initiate transaction reallocation.

As shown, the user may enter a search term (e.g., bills) in the search bar 2121. The user may then identify in the tab 2122 the receipt 2123 the user wants to reallocate. Alternatively, the user may directly snap a picture of a barcode on a receipt, and the snap mode may generate and display a receipt 2123 using information from the barcode. The user may now reallocate 2125. In some implementations, the user may also dispute the transaction 2124 or archive the receipt 2126.

In one implementation, when the reallocate button 2125 is selected, the wallet application may perform optical character recognition (OCR) of the receipt. Each of the items in the receipt may then be examined to identify one or more items which could be charged to which payment device or account for tax or other benefits such as cash back, reward points, etc. In this example, there is a tax benefit if the prescription medication charged to the user's Visa card is charged to the user's FSA. The wallet application may then perform the reallocation as the back end. The reallocation process may include the wallet contacting the payment processor to credit the amount of the prescription medication to the Visa card and debit the same amount to the user's FSA account. In an alternate implementation, the payment processor (e.g., Visa or MasterCard) may obtain and OCR the receipt, identify items and payment accounts for reallocation and perform the reallocation. In one implementation, the wallet application may request the user to confirm reallocation of charges for the selected items to another payment account. The receipt 2127 may be generated after the completion of the reallocation process. As discussed, the receipt shows that some charges have been moved from the Visa account to the FSA.

With reference to FIG. 21C, in one embodiment, the snap mode may facilitate payment via pay code such as barcodes or QR codes. For example, a user may snap a QR code of a transaction that is not yet complete. The QR code may be displayed at a merchant POS terminal, a web site, or a web application and may be encoded with information identifying items for purchase, merchant details and other relevant information. When the user snaps such as a QR code, the snap mode may decode the information in the QR code and may use the decoded information to generate a receipt 2132. Once the QR code is identified, the navigation bar 2131 may indicate that the pay code is identified. The user may now have an option to add to cart 2133, pay with a default payment account 2134 or pay with wallet 2135.

In one implementation, the user may decide to pay with default 2134. The wallet application may then use the user's default method of payment, in this example the wallet, to complete the purchase transaction. Upon completion of the transaction, a receipt may be automatically generated for proof of purchase. The user interface may also be updated to provide other options for handling a completed transaction. Example options include social 2137 to share purchase information with others, reallocate 2138 as discussed with regard to FIG. 21B, and archive 2139 to store the receipt.

With reference to FIG. 21D, in one embodiment, the snap mode may also facilitate offer identification, application and storage for future use. For example, in one implementation, a user may snap an offer code 2141 (e.g., a bar code, a QR code, and/or the like). The wallet application may then generate an offer text 2142 from the information encoded in the offer code. The user may perform a number of actions on the offer code. For example, the user use the find button 2143 to find all merchants who accept the offer code, merchants in the proximity who accept the offer code, products from merchants that qualify for the offer code, and/or the like. The user may also apply the offer code to items that are currently in the cart using the add to cart button 2144. Furthermore, the user may also save the offer for future use by selecting the save button 2145.

In one implementation, after the offer or coupon 2146 is applied, the user may have the option to find qualifying merchants and/or products using find, the user may go to the wallet using 2148, and the user may also save the offer or coupon 2146 for 18 later use.

With reference to FIG. 21E, in one embodiment, the snap mode may also offer facilities for adding a funding source to the wallet application. In one implementation, a pay card such as a credit card, debit card, pre-paid card, smart card and other pay accounts may have an associated code such as a bar code or QR code. Such a code may have encoded therein pay card information including, but not limited to, name, address, pay card type, pay card account details, balance amount, spending limit, rewards balance, and/or the like. In one implementation, the code may be found on a face of the physical pay card. In another implementation, the code may be obtained by accessing an associated online account or another secure location. In yet another implementation, the code may be printed on a letter accompanying the pay card. A user, in one implementation, may snap a picture of the code. The wallet application may identify the pay card 2151 and may display the textual information 2152 encoded in the pay card. The user may then perform verification of the information 2152 by selecting the verify button 2153. In one implementation, the verification may include contacting the issuer of the pay card for confirmation of the decoded information 2152 and any other relevant information. In one implementation, the user may add the pay card to the wallet by selecting the add to wallet button 2154. The instruction to add the pay card to the wallet may cause the pay card to appear as one of the forms of payment under the funds tab 1916 discussed in FIG. 19A. The user may also cancel importing of the pay card as a funding source by selecting the cancel button 2155. When the pay card has been added to the wallet, the user interface may be updated to indicate that the importing is complete via the notification display 2156. The user may then access the wallet 2157 to begin using the added pay card as a funding source.

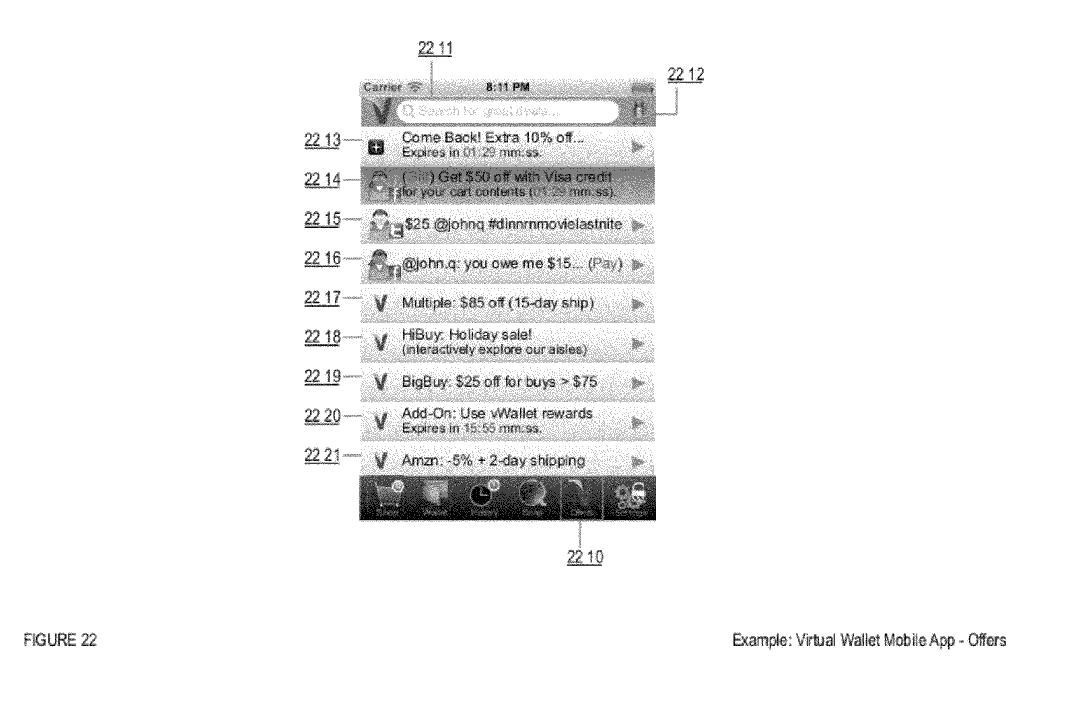

FIG. 22 shows a user interface diagram illustrating example features of virtual wallet applications, in an offers mode, in some embodiments of the SocialPay. In some implementations, the SocialPay may allow a user to search for offers for products and/or services from within the virtual wallet mobile application. For example, the user may enter text into a graphical user interface (“GUI”) element 2211, or issue voice commands by activating GUI element 2212 and speaking commands into the device. In some implementations, the SocialPay may provide offers based on the user's prior behavior, demographics, current location, current cart selection or purchase items, and/or the like. For example, if a user is in a brick-and-mortar store, or an online shopping website, and leaves the (virtual) store, then the merchant associated with the store may desire to provide a sweetener deal to entice the consumer back into the (virtual) store. The merchant may provide such an offer 2213. For example, the offer may provide a discount, and may include an expiry time. In some implementations, other users may provide gifts (e.g., 2214) to the user, which the user may redeem. In some implementations, the offers section may include alerts as to payment of funds outstanding to other users (e.g., 2215). In some implementations, the offers section may include alerts as to requesting receipt of funds from other users (e.g., 2216). For example, such a feature may identify funds receivable from other applications (e.g., mail, calendar, tasks, notes, reminder programs, alarm, etc.), or by a manual entry by the user into the virtual wallet application. In some implementations, the offers section may provide offers from participating merchants in the SocialPay, e.g., 2217-2219, 2220. These offers may sometimes be assembled using a combination of participating merchants, e.g., 2217. In some implementations, the SocialPay itself may provide offers for users contingent on the user utilizing particular payment forms from within the virtual wallet application, e.g., 2220.

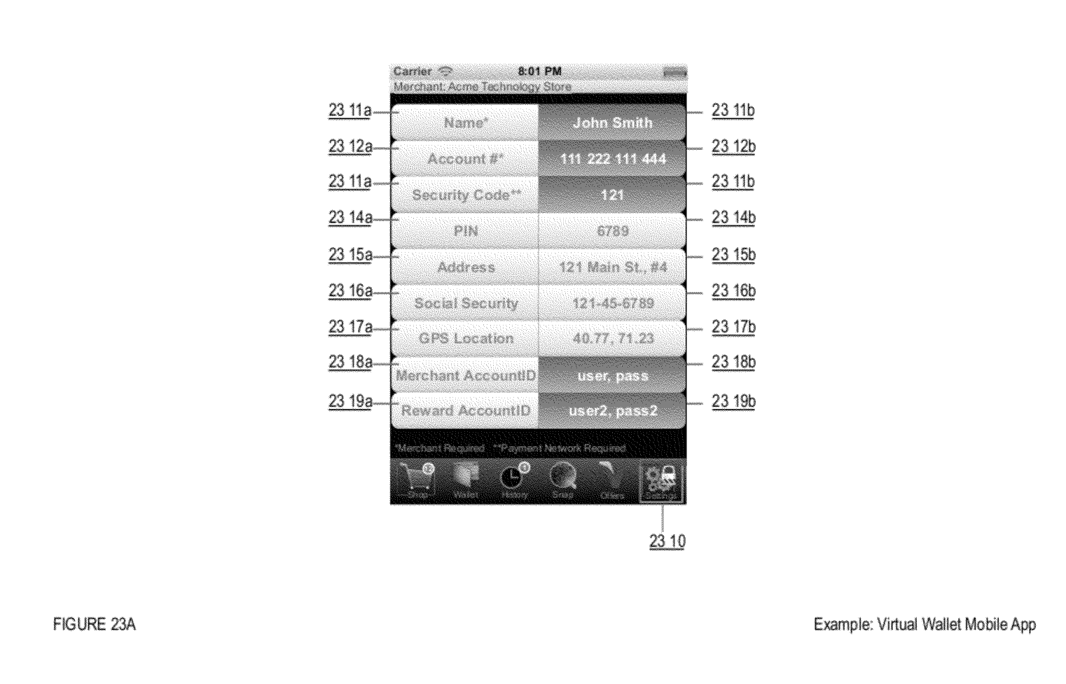

FIGS. 23A-B show user interface diagrams illustrating example features of virtual wallet applications, in a security and privacy mode, in some embodiments of the SocialPay. With reference to FIG. 23A, in some implementations, the user may be able to view and/or modify the user profile and/or settings of the user, e.g., by activating a user interface element. For example, the user may be able to view/modify a user name (e.g., 23111a-b), account number (e.g., 2312a-b), user security access code (e.g., 2313-b), user pin (e.g., 2314-b), user address (e.g., 2315-b), social security number associated with the user (e.g., 2316-b), current device GPS location (e.g., 2317-b), user account of the merchant in whose store the user currently is (e.g., 2318-b), the user's rewards accounts (e.g., 2319-b), and/or the like. In some implementations, the user may be able to select which of the data fields and their associated values should be transmitted to facilitate the purchase transaction, thus providing enhanced data security for the user. For example, in the example illustration in FIG. 23A, the user has selected the name 2311a, account number 2312a, security code 2313a, merchant account ID 2318a and rewards account ID 2319a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the SocialPay with the GPS location of the user. Based on the GPS location of the user, the SocialPay may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 23B, in some implementations, the app executing on the user's device may provide a “VerifyChat” feature for fraud prevention. For example, the SocialPay may detect an unusual and/or suspicious transaction. The SocialPay may utilize the VerifyChat feature to communicate with the user, and verify the authenticity of the originator of the purchase transaction. In various implementations, the SocialPay may send electronic mail message, text (SMS) messages, Facebook® messages, Twitter™ tweets, text chat, voice chat, video chat (e.g., Apple FaceTime), and/or the like to communicate with the user. For example, the SocialPay may initiate a video challenge for the user, e.g., 2321. For example, the user may need to present him/her-self via a video chat, e.g., 2322. In some implementations, a customer service representative, e.g., agent 2324, may manually determine the authenticity of the user using the video of the user. In some implementations, the SocialPay may utilize face, biometric and/or like recognition (e.g., using pattern classification techniques) to determine the identity of the user. In some implementations, the app may provide reference marker (e.g., cross-hairs, target box, etc.), e.g., 2323, so that the user may the video to facilitate the SocialPay's automated recognition of the user. In some implementations, the user may not have initiated the transaction, e.g., the transaction is fraudulent. In such implementations, the user may cancel the challenge. The SocialPay may then cancel the transaction, and/or initiate fraud investigation procedures on behalf of the user.

In some implementations, the SocialPay may utilize a text challenge procedure to verify the authenticity of the user, e.g., 2325. For example, the SocialPay may communicate with the user via text chat, SMS messages, electronic mail, Facebook® messages, Twitter™ tweets, and/or the like. The SocialPay may pose a challenge question, e.g., 2326, for the user. The app may provide a user input interface element(s) (e.g., virtual keyboard 2328) to answer the challenge question posed by the SocialPay. In some implementations, the challenge question may be randomly selected by the SocialPay automatically; in some implementations, a customer service representative may manually communicate with the user. In some implementations, the user may not have initiated the transaction, e.g., the transaction is fraudulent. In such implementations, the user may cancel the text challenge. The SocialPay may cancel the transaction, and/or initiate fraud investigation on behalf of the user.

### SocialPay Controller

FIG. 24 shows a block diagram illustrating embodiments of a SocialPay controller 2401. In this embodiment, the SocialPay controller 2401 may serve to aggregate, process, store, search, serve, identify, instruct, generate, match, and/or facilitate interactions with a computer through various technologies, and/or other related data.

Typically, users, e.g., 2433a, which may be people and/or other systems, may engage information technology systems (e.g., computers) to facilitate information processing. In turn, computers employ processors to process information; such processors 2403 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2429 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SocialPay controller 2401 may be connected to and/or communicate with entities such as, but not limited to: one or more users from user input devices 2411; peripheral devices 2412; an optional cryptographic processor device 2428; and/or a communications network 2413. For example, the SocialPay controller 2401 may be connected to and/or communicate with users, e.g., 2433a, operating client device(s), e.g., 2433b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SocialPay controller 2401 may be based on computer systems that may comprise, but are not limited to, components such as: a computer systemization 2402 connected to memory 2429.

### Computer Systemization

A computer systemization 2402 may comprise a clock 243o, central processing unit (“CPU(s)” and/or “processor(s)” (these terms are used interchangeable throughout the disclosure unless noted to the contrary)) 2403, a memory 2429 (e.g., a read only memory (ROM) 2406, a random access memory (RAM) 2405, etc.), and/or an interface bus 2407, and most frequently, although not necessarily, are all interconnected and/or communicating through a system bus 2404 on one or more (mother)board(s) 2402 having conductive and/or otherwise transportive circuit pathways through which instructions (e.g., binary encoded signals) may travel to effectuate communications, operations, storage, etc. The computer systemization may be connected to a power source 2486; e.g., optionally the power source may be internal. Optionally, a cryptographic processor 2426 and/or transceivers (e.g., ICs) 2474 may be connected to the system bus. In another embodiment, the cryptographic processor and/or transceivers may be connected as either internal and/or external peripheral devices 2412 via the interface bus I/O. In turn, the transceivers may be connected to antenna(s) 2475, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing SocialPay controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2429 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SocialPay controller and beyond through various interfaces. Should processing requirements dictate a greater amount speed and/or capacity, distributed processors (e.g., Distributed SocialPay), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SocialPay may be achieved by implementing a microcontroller such as CAST's R8051XC2 microcontroller; Intel's MCS 51 (i.e., 8051 microcontroller); and/or the like. Also, to implement certain features of the SocialPay, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SocialPay component collection (distributed or otherwise) and/or features may be implemented via the microprocessor and/or via embedded components; e.g., via ASIC, coprocessor, DSP, FPGA, and/or the like. Alternately, some implementations of the SocialPay may be implemented with embedded components that are configured and used to achieve a variety of features or signal processing.

Depending on the particular implementation, the embedded components may include software solutions, hardware solutions, and/or some combination of both hardware/software solutions. For example, SocialPay features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SocialPay features. A hierarchy of programmable interconnects allow logic blocks to be interconnected as needed by the SocialPay system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the SocialPay may be developed on regular FPGAs and then migrated into a fixed version that more resembles ASIC implementations. Alternate or coordinating implementations may migrate SocialPay controller features to a final ASIC instead of or in addition to FPGAs. Depending on the implementation all of the aforementioned embedded components and microprocessors may be considered the “CPU” and/or “processor” for the SocialPay.

### Power Source

The power source 2486 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2486 is connected to at least one of the interconnected subsequent components of the SocialPay thereby providing an electric current to all subsequent components. In one example, the power source 2486 is connected to the system bus component 2404. In an alternative embodiment, an outside power source 2486 is provided through a connection across the I/O 2408 interface. For example, a USB and/or IEEE 1394 connection carries both data and power across the connection and is therefore a suitable source of power.

### Interface Adapters

Interface bus(ses) 2407 may accept, connect, and/or communicate to a number of interface adapters, conventionally although not necessarily in the form of adapter cards, such as but not limited to: input output interfaces (I/O) 2408, storage interfaces 2409, network interfaces 2410, and/or the like. Optionally, cryptographic processor interfaces 2427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2409 may accept, communicate, and/or connect to a number of storage devices such as, but not limited to: storage devices 2414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2410 may accept, communicate, and/or connect to a communications network 2413. Through a communications network 2413, the SocialPay controller is accessible through remote clients 2433b (e.g., computers with web browsers) by users 2433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed SocialPay), architectures may similarly be employed to pool, load balance, and/or otherwise increase the communicative bandwidth required by the SocialPay controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2410 may be used to engage with various communications network types 2413. For example, multiple network interfaces may be employed to allow for the communication over broadcast, multicast, and/or unicast networks.

Input Output interfaces (I/O) 2408 may accept, communicate, and/or connect to user input devices 2411, peripheral devices 2412, cryptographic processor devices 2428, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2411 often are a type of peripheral device 2412 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2412 may be connected and/or communicate to I/O and/or other facilities of the like such as network interfaces, storage interfaces, directly to the interface bus, system bus, the CPU, and/or the like. Peripheral devices may be external, internal and/or part of the SocialPay controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 2428), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the SocialPay controller may be embodied as an embedded, dedicated, and/or monitor-less (i.e., headless) device, wherein access would be provided over a network interface connection.

Cryptographic units such as, but not limited to, microcontrollers, processors 2426, interfaces 2427, and/or devices 2428 may be attached, and/or communicate with the SocialPay controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2429. However, memory is a fungible technology and resource, thus, any number of memory embodiments may be employed in lieu of or in concert with one another. It is to be understood that the SocialPay controller and/or a computer systemization may employ various forms of memory 2429. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 2429 will include ROM 2406, RAM 2405, and a storage device 2414. A storage device 2414 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2429 may contain a collection of program and/or database components and/or data such as, but not limited to: operating system component(s) 2415 (operating system); information server component(s) 2416 (information server); user interface component(s) 2417 (user interface); Web browser component(s) 2418 (Web browser); database(s) 2419; mail server component(s) 2421; mail client component(s) 2422; cryptographic server component(s) 242o (cryptographic server); the SocialPay component(s) 2435; and/or the like (i.e., collectively a component collection). These components may be stored and accessed from the storage devices and/or from storage devices accessible through an interface bus. Although non-conventional program components such as those in the component collection, typically, are stored in a local storage device 2414, they may also be loaded and/or stored in memory such as: peripheral devices, RAM, remote storage facilities through a communications network, ROM, various forms of memory, and/or the like.

### Operating System

The operating system component 2415 is an executable program component facilitating the operation of the SocialPay controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SocialPay controller to communicate with other entities through a communications network 2413. Various communication protocols may be used by the SocialPay controller as a subcarrier transport mechanism for interaction, such as, but not limited to: multicast, TCP/IP, UDP, unicast, and/or the like.

### Information Server

An information server component 2416 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SocialPay controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SocialPay database 2419, operating systems, other program components, user interfaces, Web browsers, and/or the like.

Access to the SocialPay database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SocialPay. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SocialPay as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2417 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2418 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the SocialPay enabled nodes. The combined application may be nugatory on systems employing standard Web browsers.

### Mail Server

A mail server component 2421 is a stored program component that is executed by a CPU 2403. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SocialPay.

Access to the SocialPay mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2422 is a stored program component that is executed by a CPU 2403. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2420 is a stored program component that is executed by a CPU 2403, cryptographic processor 2426, cryptographic processor interface 2427, cryptographic processor device 2428, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SocialPay may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the SocialPay component to engage in secure transactions if so desired. The cryptographic component facilitates the secure accessing of resources on the SocialPay and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SocialPay Database

The SocialPay database component 2419 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SocialPay database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the SocialPay database is implemented as a data-structure, the use of the SocialPay database 2419 may be integrated into another component such as the SocialPay component 2435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2419 includes several tables 2419a-r. A Users table 2419a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a SocialPay. A Devices table 2419b may include fields such as, but not limited to: device_ID, device_name, device_IP, device_MAC, device_type, device_model, device_version, device_OS, device_apps_list, device_securekey, wallet_app_installed_flag, and/or the like. An Apps table 2419c may include fields such as, but not limited to: app_ID, app_name, app_type, app dependencies, and/or the like. An Accounts table 2419d may include fields such as, but not limited to: account_number, account security code, account_name, issuer acquirer_flag, issuer_name, acquirer_name, account_address, routing_number, access_API_call, linked_wallets_list, and/or the like. A Merchants table 2419e may include fields such as, but not limited to: merchant_id, merchant_name, merchant address, ip_address, mac_address, auth_key, port_num, security_settings_list, and/or the like. An Issuers table 2419f may include fields such as, but not limited to: issuer_id, issuer_name, issuer address, ip_address, mac_address, auth_key, port_num, security_settings_list, and/or the like. An Acquirers table 2419g may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Pay Gateways table 2419h may include fields such as, but not limited to: gateway_id, gateway_ip, gateway_mac, gateway secure_key, gateway services_list, gateway applications_list, and/or the like. A Transactions table 2419i may include fields such as, but not limited to: order_id, user_id, timestamp, transaction cost, purchase details_list, num_products, products_list, product_type, product_params_list, product_title, product summary, quantity, user_id, client_id, client_ip, client_type, client_model, operating_system, os_version, app_installed_flag, user_id, account_firstname, account_lastname, account_type, account_num, account_priority account_ratio, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 2419j may include fields such as, but not limited to: batch_id, transaction_id_list, timestamp_list, cleared_flag_list, clearance_trigger settings, and/or the like. A Ledgers table 2419k may include fields such as, but not limited to: request_id, timestamp, deposit_amount, batch_id, transaction_id, clear_flag, deposit_account, transaction_summary, payor_name, payor_account, and/or the like. A Products table 2419l may include fields such as, but not limited to: product_ID, product_title, product attributes_list, product_price, tax_info_list, related_products_list, offers_list, discounts_list, rewards_list, merchants_list, merchant availability_list, and/or the like. An Offers table 2419m may include fields such as, but not limited to: offer_ID, offer_title, offer attributes_list, offer_price, offer_expiry, related_products_list, discounts_list, rewards_list, merchants_list, merchant_availability_list, and/or the like. A Behavior Data table 2419n may include fields such as, but not limited to: user_id, activity_timestamp, activity_type, activity_cost, activity_location, activity_duration, activity_genre, and/or the like. An Analytics table 24190 may include fields such as, but not limited to: rule_id, rule_type, rule_inputs, rule_process-Steps_list, rule_outputs, and/or the like. A Social Graph table 2419p may include fields such as, but not limited to: user_id, socialnetwork_id, friend_id_list, friend_type, friend_weight, and/or the like. A Social Pay Rules table 2419q may include fields such as, but not limited to: user_id, rule_id, rule_type, rule_inputs, rule_processes, rule_outputs, rule_priority, and/or the like. A Social Offer Rules table 2419r may include fields such as, but not limited to: offer_id, offer_rule_id, offer_rule_type, offer_rule_inputs, offer_rule_processes, offer_rule_outputs, offer_rule_priority, and/or the like.

In one embodiment, the SocialPay database may interact with other database systems. For example, employing a distributed database system, queries and data access by search SocialPay component may treat the combination of the SocialPay database, an integrated data security layer database as a single database entity.

In one embodiment, user programs may contain various user interface primitives, which may serve to update the SocialPay. Also, various accounts may require custom database tables depending upon the environments and the types of clients the SocialPay may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2419a-r. The SocialPay may be configured to keep track of various settings, inputs, and parameters via database controllers.

The SocialPay database may communicate to and/or with other components in a component collection, including itself, and/or facilities of the like. Most frequently, the SocialPay database communicates with the SocialPay component, other program components, and/or the like. The database may contain, retain, and provide information regarding other nodes and data.

### The SocialPays

The SocialPay component 2435 is a stored program component that is executed by a CPU. In one embodiment, the SocialPay component incorporates any and/or all combinations of the aspects of the SocialPay discussed in the previous FIGUREs. As such, the SocialPay affects accessing, obtaining and the provision of information, services, transactions, and/or the like across various communications networks.

The SocialPay component may transform message posts to social networks via SocialPay components into payment transaction receipts social merchant-consumer bridging offers, and/or the like and use of the SocialPay. In one embodiment, the SocialPay component 2435 takes inputs (see in the FIGURES, e.g., 211, 218, 214, 411, 414, 421, 423, 430, 435, 711, 714, 1111, 1115, 1311, 1314, 1318, 1322, 1325, 1328, 1512, 1516, 1524, 1525, and/or the like) etc., and transforms the inputs via various SocialPay components (e.g., UPC 2441, PTA 2442, PTC 2443, SPE 2444, SPT 2445, WSS 2446, SMCB 2447, TDA 2448, TBOG 2449, and/or the like), into outputs (see in the FIGURES, e.g., 221, 412, 416, 428, 438-440, 717, 1113, 1117, 1316, 1319, 1323, 1332, 1334, 1335, 1514, 1518, 1520, 1533, and/or the like).

The SocialPay component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SocialPay server employs a cryptographic server to encrypt and decrypt communications. The SocialPay component may communicate to and/or with other components in a component collection, including itself, and/or facilities of the like. Most frequently, the SocialPay component communicates with the SocialPay database, operating systems, other program components, and/or the like. The SocialPay may contain, communicate, generate, obtain, and/or provide program component, system, user, and/or data communications, requests, and/or responses.

### Distributed SocialPays

The structure and/or operation of any of the SocialPay node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SocialPay controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the SocialPay controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end
of message
do {
    $input = “”;
    $input = socket_read($client, 1024);
    $data .= $input;
} while($input != “”);
// parse data to extract variables
$obj = json_decode($data, true);
// store input data in a database
mysql_connect(“201.408.185.132”,$DBserver,$password);
// access database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/
index.jsp?topic=/com.ibm.IBMDI.doc/referenceguide295.htm

and other parser implementations:

http://publib.boulder.ibm.com/infocenter/tivihelp/v2r1/index.jsp?topic=
/com.ibm.IBMDI.doc/referenceguide259.htm

all of which are hereby expressly incorporated by reference herein.

In order to address various issues and advance the art, the entirety of this application for SOCIAL MEDIA PAYMENT PLATFORM APPARATUSES, METHODS AND SYSTEMS (including the Cover Page, Title, Headings, Field, Background, Summary, Brief Description of the Drawings, Detailed Description, Claims, Abstract, FIGUREs, Appendices and/or otherwise) shows by way of illustration various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the FIGUREs and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SocialPay individual and/or enterprise user, database configuration and/or relational model, data type, data transmission and/or network framework, syntax structure, and/or the like, various embodiments of the SocialPay may be implemented that enable a great deal of flexibility and customization. For example, aspects of the SocialPay may be adapted for communication platforms, resource allocation systems, and/or the like. While various embodiments and discussions of the SocialPay have been directed to e-commerce, however, it is to be understood that the embodiments described herein may be readily configured and/or customized for a wide variety of other applications and/or implementations.

What is claimed is:

1. A social pay processor-implemented method, comprising:
obtaining a user social pay initiation trigger;
obtaining user social data from a social networking site;
identifying, via a processor, a social pay command within the user social data; and
initiating a funds payment transaction based on the identified social pay command.

2. The method of claim 1, wherein identifying the social pay command within the user social data includes:
parsing the user social data;
extracting a social pay command string within the user social data; and
determining a payor identifier, a payee identifier, and a payment amount using the social pay command string.

3. The method of claim 2, further comprising:
querying a database for an identifier of a funds account using the payee identifier;
determining, based on querying the database, that a payee associated with the payee identifier should be enrolled in social pay services; and
providing a request to enroll in social pay services.

4. The method of claim 1, further comprising:
analyzing the social pay command to determine whether the funds payment transaction should be initiated;
determining that payment verification is required from a payee of the funds payment transaction; and
generating a payment verification request using the social pay command; and
providing the payment verification request.

5. The method of claim 1, further comprising:
analyzing the social pay command to determine whether the funds payment transaction should be initiated;
determining that the social pay command is a fraudulent transaction attempt; and
providing a notification to terminate the funds payment transaction.

6. The method of claim 1, further comprising:
determining that the social pay command is a request for payment; and
providing an indication of the request for payment for display within a virtual wallet application.

7. The method of claim 6, further comprising:
obtaining permission to initiate the funds payment transaction, in response to the provided indication of the request for payment for display within the virtual wallet application; and
wherein the funds payment transaction is initiated in response to obtaining the permission to initiate it.

8. A social pay processor-implemented system, comprising:
a processor; and
a memory disposed in communication with the processor and storing processor-executable instructions to:
obtain a user social pay initiation trigger;
obtain user social data from a social networking site;
identify, via the processor, a social pay command within the user social data; and
initiate a funds payment transaction based on the identified social pay command.

9. The system of claim 8, wherein identifying the social pay command within the user social data includes:
parsing the user social data;
extracting a social pay command string within the user social data; and
determining a payor identifier, a payee identifier, and a payment amount using the social pay command string.

10. The system of claim 9, the memory further storing instructions to:
query a database for an identifier of a funds account using the payee identifier;
determine, based on querying the database, that a payee associated with the payee identifier should be enrolled in social pay services; and
provide a request to enroll in social pay services.

11. The system of claim 8, the memory further storing instructions to:
analyze the social pay command to determine whether the funds payment transaction should be initiated;
determine that payment verification is required from a payee of the funds payment transaction; and
generate a payment verification request using the social pay command; and
provide the payment verification request.

12. The system of claim 8, the memory further storing instructions to:
analyze the social pay command to determine whether the funds payment transaction should be initiated;
determine that the social pay command is a fraudulent transaction attempt; and
provide a notification to terminate the funds payment transaction.

13. The system of claim 8, the memory further storing instructions to:
determine that the social pay command is a request for payment; and
provide an indication of the request for payment for display within a virtual wallet application.

14. The system of claim 13, the memory further storing instructions to:
obtain permission to initiate the funds payment transaction, in response to the provided indication of the request for payment for display within the virtual wallet application; and
wherein the funds payment transaction is initiated in response to obtaining the permission to initiate it.

15. A computer-readable tangible medium storing processor-executable social pay instructions to:
obtain a user social pay initiation trigger;
obtain user social data from a social networking site;
identify, via the processor, a social pay command within the user social data; and
initiate a funds payment transaction based on the identified social pay command.

16. The medium of claim 15, wherein identifying the social pay command within the user social data includes:
parsing the user social data;
extracting a social pay command string within the user social data; and
determining a payor identifier, a payee identifier, and a payment amount using the social pay command string.

17. The medium of claim 16, further storing instructions to:
query a database for an identifier of a funds account using the payee identifier;
determine, based on querying the database, that a payee associated with the payee identifier should be enrolled in social pay services; and
provide a request to enroll in social pay services.

18. The medium of claim 15, further storing instructions to:
analyze the social pay command to determine whether the funds payment transaction should be initiated;
determine that payment verification is required from a payee of the funds payment transaction; and
generate a payment verification request using the social pay command; and
provide the payment verification request.

19. The medium of claim 15, further storing instructions to:
analyze the social pay command to determine whether the funds payment transaction should be initiated;
determine that the social pay command is a fraudulent transaction attempt; and
provide a notification to terminate the funds payment transaction.

20. The medium of claim 15, further storing instructions to:
determine that the social pay command is a request for payment; and
provide an indication of the request for payment for display within a virtual wallet application.

21. The medium of claim 20, further storing instructions to:
obtain permission to initiate the funds payment transaction, in response to the provided indication of the request for payment for display within the virtual wallet application; and
wherein the funds payment transaction is initiated in response to obtaining the permission to initiate it.

22. A social pay processor-implemented method, comprising:
obtaining a users social graph system login credentials;
logging into the users social graph system;
obtaining social user messages sent by the user and to the user;
determining if any of the social user messages include social payment message;
determining if the social payment message is from the user sending payment to a second entity;
determining a source payment account from the user for payment;
determining a target payment account of the second entity;
transferring a payment specified in the social payment message from the user's source payment account to the second entity's target payment account.
obtaining user social data from a social networking site;
identifying, via a processor, a social pay command within the user social data; and
initiating a funds payment transaction based on the identified social pay command.

23. The method of claim 22, wherein the second entity is another user.

24. The method of claim 22, wherein the second entity is a payment system.

25. The method of claim 22, wherein the second entity is a system.

26. The method of claim 22, wherein the second entity is an organization.

27. The method of claim 22, wherein the obtaining of social messages is continually intercepted in real time while the user engages in messaging on another messaging client.

28. The method of claim 22, wherein the obtaining of social messages occurs as if a messaging client is logged into the user's social graph account by an additional client.

29. The method of claim 28, wherein the additional client is logged in in such a manner that the user may simultaneously be logged into their social graph account without either client interfering with another.

30. The method of claim 22, further, comprising:
appending an assistive payment message to obtained social user messages that have been determined to have social payment messages.

31. The method of claim 28, wherein the assistive payment message is appended when a user or entity receiving payment directed from the social payment message does not have a payment account.

32. The method of claim 31, wherein the assistive payment message is appended by sending a second message from the additional client that appears to have originated from the user's social messaging client.

33. The method of claim 32, wherein the assistive payment message is includes a link to sign up for a payment account which may receive the payment from the social payment message.

34. The method of claim 28, wherein the funds payment transaction affects purchase of an item purchased from a merchant and wherein the item purchased is specified in the social pay command and includes an identifier of the item from the merchant and account information to affect purchase of the item and shipping information to send the item to a destination.

35. A social pay system, comprising:
means to obtain a users social graph system login credentials;
means to log into the users social graph system;
means to obtain social user messages sent by the user and to the user;
means to determine if any of the social user messages include social payment message;
means to determine if the social payment message is from the user sending payment to a second entity;
means to determine a source payment account from the user for payment;
means to determine a target payment account of the second entity;
means to transfer a payment specified in the social payment message from the user's source payment account to the second entity's target payment account.
means to obtain user social data from a social networking site;
means to identify a social pay command within the user social data; and
means to initiate a funds payment transaction based on the identified social pay command.

36. A processor-readable medium storing processor-issuable instructions to:
obtain a users social graph system login credentials;
log into the users social graph system;
obtain social user messages sent by the user and to the user;
determine if any of the social user messages include social payment message;
determine if the social payment message is from the user sending payment to a second entity;
determine a source payment account from the user for payment;
determine a target payment account of the second entity;
transfer a payment specified in the social payment message from the user's source payment account to the second entity's target payment account.
obtain user social data from a social networking site;
identify a social pay command within the user social data; and
initiate a funds payment transaction based on the identified social pay command.

37. A social pay apparatus, comprising:
a memory;
a processor disposed in communication with said memory, and configured to issue a plurality of processing instructions stored in the memory, wherein the processor issues instructions to:
obtain a users social graph system login credentials;
log into the users social graph system;
obtain social user messages sent by the user and to the user;
determine if any of the social user messages include social payment message;
determine if the social payment message is from the user sending payment to a second entity;
determine a source payment account from the user for payment;
determine a target payment account of the second entity;
transfer a payment specified in the social payment message from the user's source payment account to the second entity's target payment account.
obtain user social data from a social networking site;
identify a social pay command within the user social data; and
initiate a funds payment transaction based on the identified social pay command.

38. A social pay processor-implemented method, comprising:
obtaining a users social graph system login credentials;
logging into the users social graph system;
obtaining social user messages sent by the user and to the user;
determining if any of the social user messages include social payment message;
determining if the social payment message is from a second entity sending payment to the user;
determining a source payment account from the second entity for payment;
determining a target payment account of the user;
transferring a payment specified in the social payment message from the second entity's source payment account to the user's target payment account.
obtaining user social data from a social networking site;
identifying, via a processor, a social pay command within the user social data; and
initiating a funds payment transaction based on the identified social pay command.

39. The method of claim 38, wherein the second entity is another user.

40. The method of claim 38, wherein the second entity is a payment system.

41. The method of claim 38, wherein the second entity is a system.

42. The method of claim 38, wherein the second entity is an organization.

43. The method of claim 38, wherein the obtaining of social messages is continually intercepted in real time while the user engages in messaging on another messaging client.

44. The method of claim 38, wherein the obtaining of social messages occurs as if a messaging client is logged into the user's social graph account by an additional client.

45. The method of claim 44, wherein the additional client is logged in in such a manner that the user may simultaneously be logged into their social graph account without either client interfering with another.

46. The method of claim 38, further, comprising:
appending an assistive payment message to obtained social user messages that have been determined to have social payment messages.

47. The method of claim 44, wherein the assistive payment message is appended when a user or entity receiving payment directed from the social payment message does not have a payment account.

48. The method of claim 47, wherein the assistive payment message is appended by sending a second message from the additional client that appears to have originated from the user's social messaging client.

49. The method of claim 48, wherein the assistive payment message includes a link to sign up for a payment account which may receive the payment from the social payment message.

50. The method of claim 38, wherein the funds payment transaction affects purchase of an item purchased from a merchant and wherein the item purchased is specified in the social pay command and includes an identifier of the item from the merchant and account information to affect purchase of the item and shipping information to send the item to a destination.

51. A social pay system, comprising:
means to obtain a users social graph system login credentials;
means to log into the users social graph system;
means to obtain social user messages sent by the user and to the user;
means to determine if any of the social user messages include social payment message;
means to determine if the social payment message is from a second entity sending payment to the user;
means to determine a source payment account from the second entity for payment;
means to determine a target payment account of the user;
means to transfer a payment specified in the social payment message from the second entity's source payment account to the user's target payment account.
means to obtain user social data from a social networking site;
means to identify a social pay command within the user social data; and
means to initiate a funds payment transaction based on the identified social pay command.

52. A processor-readable medium storing processor-issuable instructions to:
obtain a users social graph system login credentials;
log into the users social graph system;
obtain social user messages sent by the user and to the user;
determine if any of the social user messages include social payment message;
determine if the social payment message is from a second entity sending payment to the user;
determine a source payment account from the second entity for payment;
determine a target payment account of the user;
transfer a payment specified in the social payment message from the second entity's source payment account to the user's target payment account.
obtain user social data from a social networking site;
identify a social pay command within the user social data; and
initiate a funds payment transaction based on the identified social pay command.

53. A social pay apparatus, comprising:
a memory;
a processor disposed in communication with said memory, and configured to issue a plurality of processing instructions stored in the memory, wherein the processor issues instructions to:
obtain a users social graph system login credentials;
log into the users social graph system;
obtain social user messages sent by the user and to the user;
determine if any of the social user messages include social payment message;
determine if the social payment message is from a second entity sending payment to the user;
determine a source payment account from the second entity for payment;
determine a target payment account of the user;
transfer a payment specified in the social payment message from the second entity's source payment account to the user's target payment account.
obtain user social data from a social networking site;
identify a social pay command within the user social data; and
initiate a funds payment transaction based on the identified social pay command.
